(19) United States
(12) Patent Application Publication
(10) Pub. No.: US 2009/0228300 A1
(43) Pub. Date: Sep. 10, 2009

(54) MOBILE DEVICE-ENHANCED VERIFICATION OF MEDICAL TRANSPORTATION SERVICES

(75) Inventors: Jay A. Hamel, Troy, NY (US); Joseph Michael Werner, West Springfield, MA (US)

Correspondence Address: SCHMEISER, OLSEN & WATTS, 22 CENTURY HILL DRIVE, SUITE 302, LATHAM, NY, 12110, US

(73) Assignee: Medical Management Technology Group, Inc., Troy, NY (US)

(21) Appl. No.: 12/468,399

(22) Filed: May 19, 2009

Related U.S. Application Data
(63) Continuation-in-part of application No. 12/119,879, filed on May 13, 2008.
(60) Provisional application No. 60/938,322, filed on May 16, 2007.

(51) Int. Cl. G06Q 10/00; G06Q 50/00; G06F 17/30; G06F 17/40

(52) U.S. Cl. 705/2; 705/9; 707/104.1; 707/E17.018; 707/E17.044

(57) ABSTRACT

A method and system for verifying a medical transportation service (MTS). Information about routed trips to provide MTSs is sent to a mobile device. During a routed trip providing a MTS, metadata is collected that specifies a pickup and a drop-off of a client on a date. A client signature is received via a display of the mobile device. The metadata and signature are received from the mobile device and stored with an identifier (trip ID) of the routed trip. A reference signature is retrieved based on stored associations among the reference signature, a client ID, and the trip ID. A match between the signature and the reference signature is identified and verifies a transportation of the client on the date according to the routed trip. A report is generated that verifies that a payment for the MTS is authorized.

The present application is a continuation-in-part of, and claims priority to, U.S. patent application Ser. No. 12/119,879, filed on May 13, 2008, which is hereby incorporated herein by reference in its entirety. U.S. patent application Ser. No. 12/119,879 claimed the benefit of Provisional Application No. 60/938,322, filed May 16, 2007, which is hereby incorporated herein by reference in its entirety.

### FIELD OF THE INVENTION

The present invention relates generally to a data processing method and system for managing health care transactions, and more particularly to an image analysis technique that processes digitized signatures provided on mobile devices to verify health care claims.

### BACKGROUND OF THE INVENTION

The United States spends more than $2 trillion on health care every year. Of that amount, the National Health Care Anti-Fraud Association estimates that more than $60 billion each year is lost to health care fraud. Health care fraud is any misrepresentation of a material fact submitted on, or in support of a claim for payment of a health care insurance claim. A claim for payment based on the aforementioned misrepresentation is referred to herein as a fraudulent health care claim. Fraudulent health care claims include, for example, a claim for a health care service or product that is never delivered (i.e., phantom billing), a claim that uses a billing code for a higher level of service when a lower level of service was actually rendered (i.e., upcoding), and a claim based on authorization deficiencies (e.g., a claim for an unauthorized service or a service that was authorized for a different location and/or a different date). Conventional methods and systems for preventing health care fraud include a verification that a person was at a particular location at a particular time (e.g., a patient was at a doctor's office on a specified date), which fails to identify fraudulent health care claims based on the aforementioned authorization deficiencies. Thus, there exists a need to detect and prevent fraudulent health care claims and to overcome at least one of the preceding deficiencies and limitations of the related art.

### SUMMARY OF THE INVENTION

In first embodiments, the present invention provides a computer-implemented method for detecting and preventing fraudulent health care claims. A health care claim verification computing unit (first computing unit) generates an encrypted bar code that includes a set of bar code data that identifies a health care transaction. The bar code data includes a service date and a provider ID that identifies a health care service provider that provides a health care service to a client on the service date. Subsequent to generating the bar code, the first computing unit receives a digital image file that includes the bar code, a set of transaction data that describes the transaction, and a signature that is initially handwritten by the client. Subsequent to receiving the digital image file, (1) the first computing unit extracts the set of transaction data and the signature from the digital image file and (2) the first computing unit extracts the provider ID and the service date from the bar code included in the digital image file. Subsequent to extracting the set of transaction data and the signature, the first computing unit determines that the extracted signature matches a reference signature that is stored in a database that associates the reference signature with the client. A group of extracted data is determined to be not included in any transaction record in the database. The transaction records are stored in the database prior to generating the bar code. The group of extracted data includes the extracted service date, the extracted provider ID, and an identifier of the client. The identifier of the client is included in the extracted set of transaction data. In response to determining that the group of extracted data is not included in any transaction record, the first computing unit generates a report that identifies a fraudulent health care claim that indicates a billing for the service that is provided by the provider to the client on the service date, but that is not authorized by a payer entity via a transaction record being included in the database.

A system and computer program product corresponding to the above-summarized method are also described and claimed herein.

In second embodiments, the present invention provides a computer-implemented method of detecting a fraudulent health care claim for a payment for a health care service. A first computing unit controlled by a health care claim verification entity (CVE) generates an encrypted bar code that includes a set of bar code data that identifies a set of health care transactions. The bar code data includes a service date and a provider ID that identifies a health care service provider that is requested to provide a set of health care services to a set of clients on the service date. The set of transactions includes a transaction that indicates that the provider is requested to provide, on the service date, a health care service included in the set of health care services to a client included in the set of clients. Subsequent to generating the bar code, the first computing unit stores the bar code in a computer data file. Subsequent to storing the bar code, the first computing unit posts the computer data file to a website controlled by the CVE and accessible by a second computing unit controlled by the provider. The computer data file is sent to the second computing unit via an access of the website by the second computing unit. Subsequent to sending the computer data file, the second computing unit prints a transaction document that includes the bar code and a set of data entry areas for receiving a set of transaction data that describes the transaction. Subsequent to the printing step, the first computing unit receives a digital image file that includes the bar code data, the set of transaction data received in the set of data entry areas and a signature that indicates the client. Subsequent to receiving the digital image file, the first computing unit extracts the bar code data, the signature, and the set of transaction data from the digital image file. Subsequent to the extracting step, a signature verification engine executing on the first computing unit determines a score that indicates whether the extracted signature matches a reference signature that is stored in a database residing in a computer data storage unit. The database associates the reference signature with the client. If the score does not satisfy a set of predefined criteria for matching the extracted signature to the reference signature, the first computing unit generates a first report that includes a first type of fraudulent health care claim. The first type indicates a billing for the service by the provider, but the service is not provided to the client by the provider. Subsequent to the extracting step, the first computing unit searches the database for a match between a group of extracted data and a transaction record of a set of transaction records stored in the database prior to the step of generating the bar code. The group of extracted data includes the extracted set of transaction data and the extracted bar code data. The match includes an identifier of the client included in the extracted set of transaction data matching a client identifier in the transaction record, the extracted service date included in the extracted bar code data matching a date in the transaction record, and the extracted provider ID included in the extracted bar code data matching a provider identifier in the transaction record. In response to the searching step, the match is identified as being absent. In response to identifying the match as being absent, the first computing unit generates a second report that includes a second type of fraudulent health care claim. The second type indicates a billing for the service, but the service provided by the provider to the client on the service date is not authorized by any transaction record of the set of transaction records.

In third embodiments, the present invention provides a computer-implemented method of verifying a claim for a payment for a health care service. A first computing unit controlled by a health care claim verification entity generates an encrypted bar code that includes a set of bar code data that identifies a health care transaction. The set of bar code data includes a service date and a provider ID that identifies a health care service provider that provides a health care service to a client on the service date. Subsequent to generating the bar code, the first computing unit receives a digital image file that includes the bar code, a set of transaction data that describes the transaction, and a signature that is initially handwritten by the client. Subsequent to receiving the digital image file, the first computing unit extracts the set of transaction data and the signature from the digital image file. Subsequent to receiving the digital image file, the first computing unit extracts the provider ID and the service date from the bar code included in the digital image file. Subsequent to extracting the set of transaction data and the signature, the first computing unit determines that the extracted signature matches a reference signature that is stored in a database that associates the reference signature with the client. A group of extracted data is determined to be included in a transaction record of a set of transaction records stored in the database prior to generating the bar code. The group of extracted data includes the extracted service date, the extracted provider ID, and an identifier of the client. The identifier of the client is included in the extracted set of transaction data. In response to determining that the group of extracted data is included in the transaction record and determining that the extracted signature matches the reference signature, the first computing unit generates a report that verifies a claim for a payment of the service.

In fourth embodiments, the present invention provides a method of verifying a medical transportation service (MTS). Trip information and client names are received. The trip information specifies routed trips that are requested to provide medical transportation services (MTSs) to clients. A computing unit sends routed trip identifiers (IDs), the client names, and the trip information to a mobile device via a wireless computer network. In response to sending the routed trip IDs, client names and trip information, the client names and trip information is displayed on a display of the mobile device. Metadata collected during a routed trip is received. The routed trip is requested to provide a MTS to a client. The MTS specifies a transportation of the client from a first location to a second location on a date. The routed trip is identified by a trip ID. The collected metadata specifies a pickup at the first location, a drop-off at the second location, and the date. A signature is received via an input component operatively coupled to the mobile device. The metadata, the signature, and the trip ID are received from the mobile device. A first association among the trip ID, the metadata, and the signature is stored in a data storage device that stores a second association between the trip ID and an identifier (client ID) of the client, and a third association between the client ID and a set of one or more reference signatures. A match between the signature and a reference signature of the set of one or more reference signatures is identified. Identifying the match includes retrieving the reference signature based on the second association and the third association. In response to identifying the match, an occurrence of the transportation of the client from the first location to the second location on the date is verified. After identifying the match, a report is generated that verifies that a payment for the MTS is authorized.

In fifth embodiments, the present invention provides a method of detecting a fraudulent health care claim for a payment for a medical transportation service (MTS). Trip information and client names are received. The trip information specifies routed trips that are requested to provide medical transportation services (MTSs) to clients. A computing unit sends identifiers (trip IDs) of the routed trips, the client names, and the trip information to a mobile device via a wireless computer network. In response to sending the trip IDs, client names and trip information, the client names and trip information are displayed on a display of the mobile device. Metadata collected during a routed trip is received. The routed trip is requested to provide a MTS to a client. The MTS specifies a transportation of the client from a first location to a second location on a date. The routed trip is identified by a trip ID. The metadata specifies a pickup at the first location, a drop-off at the second location, and the date. A signature is received via an input component operatively coupled to the mobile device. The metadata, the signature, and the trip ID are received from the mobile device. A first association among the trip ID, metadata, and signature are stored in a data storage device that stores a second association between the trip ID and an identifier (client ID) of the client, and a third association between the client ID and a set of one or more reference signatures. A mismatch between the signature and each reference signature of the set of one or more reference signatures is determined. Determining the mismatch includes retrieving each reference signature of the set of one or more reference signatures based on the second association and the third association. After determining the mismatch, a report is generated that identifies a health care claim that is fraudulent based on a billing being submitted for the MTS and based on the MTS not being provided to the client on the date.

In sixth embodiments, the present invention provides a method of verifying a medical transportation service (MTS). A computing system receives a request for the MTS that includes transporting a client in a trip from a first location to a second location on a date. The computing system includes a processor and a memory. The computing system receives a form from a mobile device. Receiving the form includes receiving a biometric signature previously provided on the form via an input component operatively coupled to the mobile device. The computing system receives trip information that specifies the trip. The computing system receives client identification information that identifies the client. An association among the client identification information, the trip information, and the biometric signature is stored in a computer data storage device. The computing system identifies a match between the biometric signature and a reference signature included in a database. Identifying the match includes retrieving the reference signature from the database based on the client identification information. In response to identifying the match, the computing system provides a verification that the MTS is provided and that the MTS includes transporting the client from the first location to the second location on the date. The verification is based on the association among the client identification information, the trip information, and the biometric signature.

Systems and computer program products corresponding to the above-summarized methods are also described herein.

Advantageously, the present invention provides a technique for detecting and preventing fraudulent health care claims for any type of health care transaction that uses a bar code having health care transaction data to facilitate matching transaction data extracted from the bar code to stored transaction data and that further uses signature verification as proof of a service or product being provided (e.g., claims relative to non-emergency medical transportation, home health care, a physician's office visit, filling a prescription at a pharmacy, etc.).

### BRIEF DESCRIPTION OF THE DRAWINGS

FIG. 1 is a block diagram of a system for detecting and preventing fraudulent health care claims, in accordance with embodiments of the present invention.

FIG. 2 is a block diagram of a signature verification and encrypted bar code system that includes the signature verification engine of the system of FIG. 1, in accordance with embodiments of the present invention.

FIGS. 3A-3C depict a flow diagram of a computer-implemented process for detecting and preventing fraudulent health care claims in the system of FIG. 1, in accordance with embodiments of the present invention.

FIG. 3D is a flow diagram of a computer-implemented process for verifying a signature in the system of FIG. 2, in accordance with embodiments of the present invention.

FIGS. 4A-4C depict a flow diagram of a computer-implemented process for detecting a fraudulent health care claim associated with non-emergency medical transportation, in accordance with embodiments of the present invention.

FIGS. 5A-5C depict a flow diagram of a computer-implemented process for detecting a fraudulent health care claim associated with filling a prescription at a pharmacy, in accordance with embodiments of the present invention.

FIGS. 6A-6C depict a flow diagram of a computer-implemented process for detecting a fraudulent health care claim associated with a visit to a physician's office, in accordance with embodiments of the present invention.

FIG. 7 is a block diagram of a computing system that implements the process of FIGS. 3A-3C, in accordance with embodiments of the present invention.

FIG. 8 is a block diagram of another system for detecting and preventing fraudulent health care claims, in accordance with embodiments of the present invention.

FIG. 9 is a block diagram of a signature verification and encrypted barcode system included in the system of FIG. 8, in accordance with embodiments of the present invention.

FIGS. 10A-10B depict a flow diagram of a computer-implemented process for detecting and preventing fraudulent health care claims in the system of FIG. 8, in accordance with embodiments of the present invention.

FIGS. 11A-11C depict a flow diagram of another computer-implemented process for detecting a fraudulent health care claim associated with non-emergency medical transportation, in accordance with embodiments of the present invention.

FIGS. 12A-12C depict a flow diagram of another computer-implemented process for detecting a fraudulent health care claim associated with filling a prescription at a pharmacy, in accordance with embodiments of the present invention.

FIGS. 13A-13C depict a flow diagram of another computer-implemented process for detecting a fraudulent health care claim associated with a visit to a physician's office, in accordance with embodiments of the present invention.

FIG. 14 is a block diagram of another computing system that implements the process of FIGS. 10A-10B, in accordance with embodiments of the present invention.

FIG. 15 is a block diagram of a mobile device-enhanced system for verifying claims for medical transportation, in accordance with embodiments of the present invention.

FIGS. 16A-16C depict a flow diagram of a process implemented by the mobile device-enhanced system of FIG. 15, in accordance with embodiments of the present invention.

FIG. 17 is a block diagram of a computing system that implements the process of FIGS. 16A-16C, in accordance with embodiments of the present invention.

### DETAILED DESCRIPTION OF THE INVENTION

### Overview

The present invention provides a system, method and computer program product that generates encrypted health care transaction information in a bar code format, captures a client's signature specifically correlated to and inseparable from the bar code, and integrates a signature verification method with an exception reporting software module, thereby facilitating the detection and prevention of fraudulent claims for health care services and products. The technique disclosed herein combines the bar code and a verified client signature to associate the client with a particular place, date and time and to associate the presence of the client with a particular health care transaction being performed on that date (e.g., the provision of non-emergency medical transportation). Thus, the system and method disclosed herein use the bar code and verified signature to relate the health care transaction time and location to a particular claim.

In one embodiment, a client's signature on a form (e.g., a paper form) is correlated with transaction data displayed on the form, thereby signifying the acceptance and agreement of the client, and further the client's signature is correlated with the transaction information included in the encrypted bar code in a manner compliant with privacy regulations relevant to health information (e.g., Health Insurance Portability and Accountability Act (HIPAA) of 1996), which prevents anyone from duplicating the use of the signature.

In another embodiment, a health care provider (a.k.a. health care service provider) (e.g., a pharmacy) notifies a claims verification service provider (CVSP) (a.k.a. claim verification entity or CVE) of a request for a health care service (e.g., a request to have a prescription filled). The CVSP generates the encrypted bar code in the form of a label or form which is electronically transmitted to the health care provider via a website that complies with health information privacy regulations (e.g., HIPAA regulations). The health care provider prints the label or form which is presented to the client (e.g., presented to the client together with the filled prescription). The bar code is scanned with a bar code scanner and the client provides a signature on a digitizer pad. The information from the scan of the bar code and the digital signature provided via the digitizer pad are correlated in the same data file and are associated throughout the fraud detection process described herein.

As used herein, “scan” and its variants (e.g., “scanned”) is defined as the process of analyzing and digitally encoding (i.e., digitizing) text, graphics and/or bar code patterns included on a physical object (e.g., a printed document, printed form or analog image) to create a digital image (e.g., bitmapped image) represented as binary data for storage in a computer file format and/or for processing by a computing device.

As used herein, “health care transaction” or “transaction” is defined as an act of providing or selling a health care service or product to a client.

### Fraud Detection and Prevention System

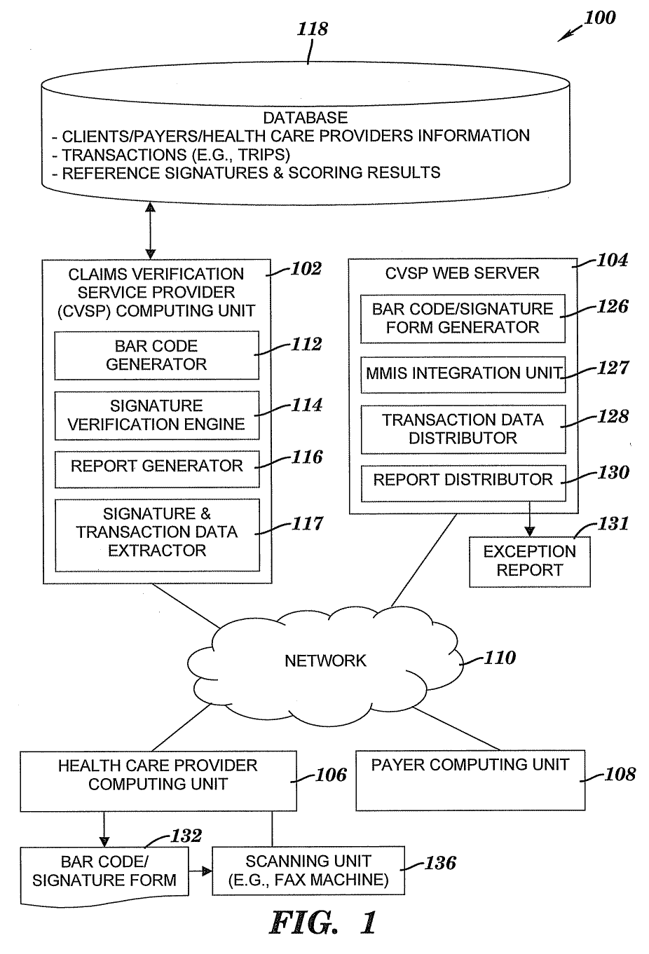

FIG. 1 is a block diagram of a system for detecting and preventing fraudulent health care claims, in accordance with embodiments of the present invention. System 100 includes a claims verification service provider (CVSP) computing unit 102, a CVSP web server 104, a health care provider computing unit 106 and a payer computing unit 108. The descriptive name of each of computing units 102, 106 and 108 indicates the entity that utilizes and controls (i.e., manages) the computing unit. For example, CVSP computing unit 102 is utilized and controlled by a claims verification service provider (a.k.a. claim verification entity or CVE), health care provider computing unit 106 is utilized and controlled by a health care provider, and payer computing unit 108 is utilized and controlled by a payer entity (e.g., an insurer). Similarly, CVSP web server 104 is a web server utilized and controlled by the claims verification service provider. The claims verification service provider, health care provider and payer entity are separate and different entities.

In another embodiment, CVSP web server 104 is a web server that is utilized by the claims verification service provider and managed by a third party (not shown in FIG. 1) that is different from the claims verification service provider, the health care provider and the payer entity. Computing units 102, 106 and 108 access a website (also referred to herein as the CVSP website) provided by CVSP web server 104 via a network 110 (e.g., the Internet).

CVSP computing unit 102 includes a bar code generator 112, a signature verification engine (SVE) 114, a report generator 116, and a signature & transaction data extractor 117. CVSP computing unit 102 is coupled to one or more storage units that include a claims verification database 118. Database 118 includes, for example, relational database tables that store information about clients, health care service providers (e.g., non-emergency medical transportation providers), payers (e.g., insurers), transactions (e.g., non-emergency medical transportation trips), reference signatures and results of scoring signatures. Data that determines whether a client is eligible to receive a payment from a payer for a health care service is also stored in database 118.

Bar code generator 112 generates encrypted bar codes that include transaction data (i.e., data related to a health care transaction). Transaction data includes the following information: date and time of the health care transaction, a name of a client who is receiving a health care product or service, the client's identification code (e.g., Medicaid Client Identification Number (CIN)), and details of the health care product or service being provided.

SVE 114 receives digital signatures (e.g., handwritten signatures on paper-based forms that have been faxed or scanned, or signatures provided on an electronic touch pad) and associated bar codes that include transaction data, decodes the bar codes, stores the transaction data decoded from the bar codes in database 118, and compares received signatures to one or more reference signatures stored in database 118 to detect fraudulent health care claims.

Report generator 116 generates one or more exception reports that identify health care claims as fraudulent and/or potentially fraudulent based on predefined criteria.

Signature & transaction data extractor 117 extracts transaction data, bar code data and signatures from a transaction document that is described below.

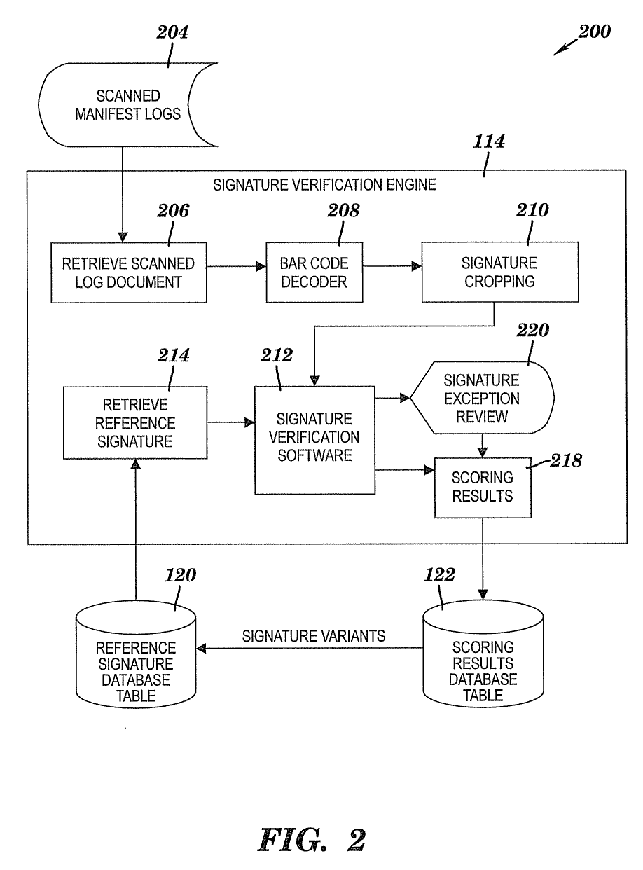

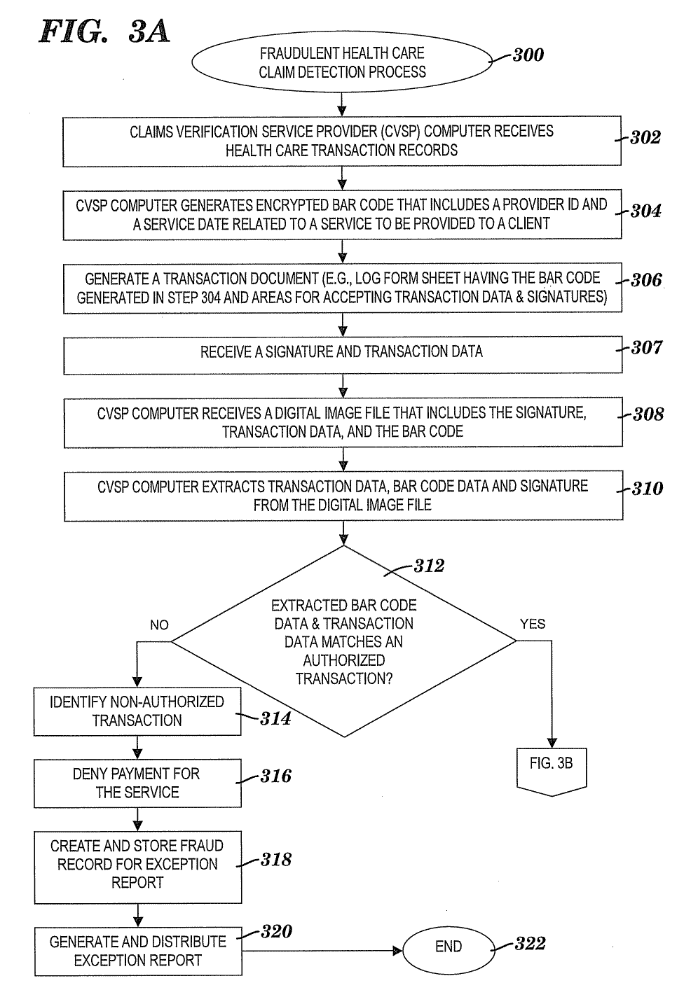

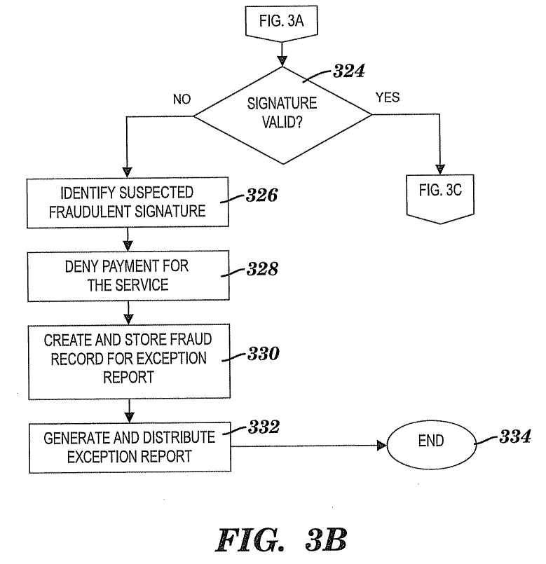

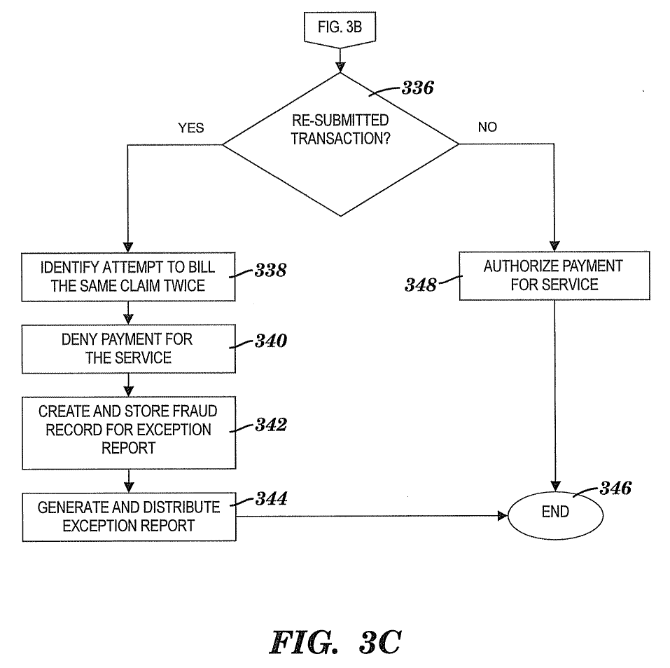

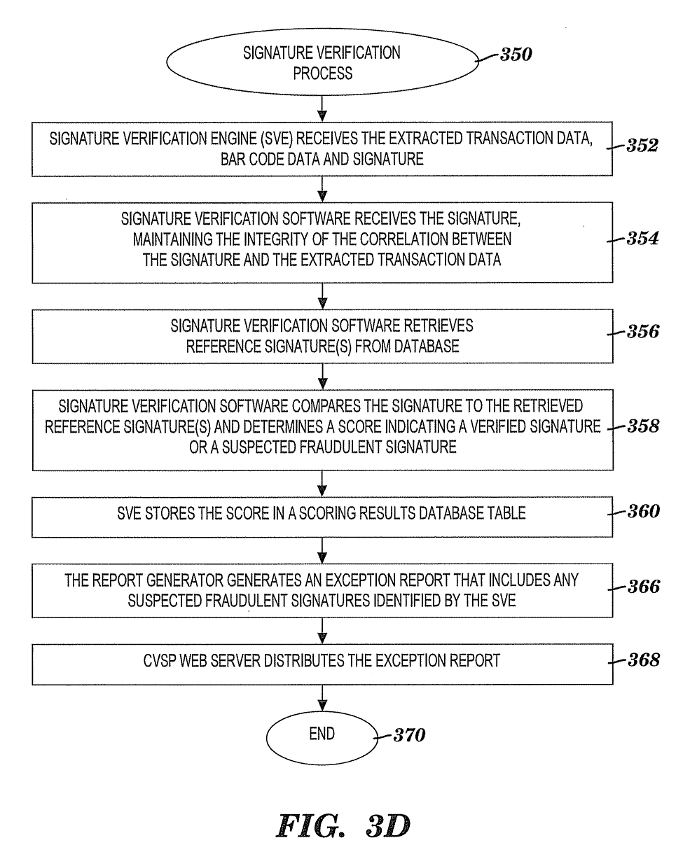

Components of system 100 that are included in or coupled to CVSP computing unit 102 are described in detail in the claims verification process presented below relative to FIGS. 3A-3C. Subcomponents of SVE 114 are described below relative to FIG. 2.

CVSP web server 104 includes a bar code/signature form generator 126 that allows a computing unit (e.g., health care provider computing unit 106) that accesses the CVSP website to generate (e.g., print) a physical form (e.g., non-emergency medical transportation log sheet or pharmacy prescription label) that includes bar code(s) generated by bar code generator 112 and optionally also includes area(s) for accepting one or more handwritten signatures from one or more clients who are receiving the health care product or service.

In one embodiment, CVSP web server 104 includes a software-based Medicaid Management Information System (MMIS) integration unit 127 that generates either prior authorization/approval requests or payment requests based on approved transactions.

CVSP web server 104 also includes a transaction data distributor 128 and a report distributor 130. Transaction data distributor 128 distributes transaction data to health care provider computing unit 106. Report distributor distributes an exception report 131 that indicates fraudulent and/or potentially fraudulent health care claims. Exception report 131 is distributed to payer computing unit 108 and/or health care provider computing unit 106. Exception report 131 may also be accessed for internal use by CVSP computing unit 102.

The functionality of the components of CVSP web server are described in more detail relative to the claims verification process presented below relative to FIGS. 3A-3C.

Health care provider computing unit 106 produces (e.g., prints) a form 132 (a.k.a., transaction document or bar code/signature form) that includes (1) bar code(s) without any signature areas, (2) a bar code associated with one or more signature areas or (3) bar code(s) and area(s) for signature(s), where each area for a signature is associated with one or more bar codes. Form 132 is, for example, a paper-based form, such as a log form printed on a sheet of paper. Form 132 includes one or more data entry areas for accepting transaction data. In one embodiment, the one or more data entry areas include a designated area for receiving a handwritten entry of a client's name or a portion of the client's name. In another embodiment, the one or more data entry areas include optical mark recognition (OMR) areas for receiving handwritten marks (e.g. penciled tick marks), to indicate an identification of a client, such as a portion (e.g., last four digits) of the client's home phone number. In still another embodiment, data entry areas of form 132 receive an identification of a client (e.g., the client's name) receiving non-emergency medical transportation, a pickup time, a drop-off time, an identification of a driver of a vehicle providing the client's transportation and an identification of the vehicle, and the information in these data entry areas is recognized by an optical character recognition (OCR) tool. For example, the data entry areas may be “OCR fields” designed to look like liquid crystal display (LCD) digits

In one embodiment, each form is one sheet of paper and each sheet includes exactly one bar code that is unique to the sheet that includes the bar code. In another embodiment, each form includes multiple bar codes, where each bar code on a form is associated with a corresponding transaction area, and each transaction area on the form includes areas for receiving a client's signature and transaction data (e.g., information about a non-emergency medical transportation trip).

After the signature and data entry areas on form 132 are completed, a representative of the health care provider scans form 132 using a scanning unit 136. In one embodiment, scanning unit 136 is a fax machine that faxes a paper-based form 132 to CVSP computing unit 102, where extractor 117 extracts bar code data, transaction data, and signature(s) from the bar code, data entry area(s), and signature area(s), respectively, that are included in form 132.

The functionality of signature & transaction data extractor 117 and scanning unit 136 is described in more detail in the claims verification process presented below relative to FIGS. 3A-3C.

FIG. 2 is a block diagram of a signature verification and encrypted bar code system 200 that includes the signature verification engine of the system of FIG. 1, in accordance with embodiments of the present invention. System 200 includes one embodiment of SVE 114, a reference signature database table 120 and a scoring results database table 122. Input to SVE 114 includes scanned manifest logs 204 (e.g., non-emergency medical transportation log sheets each having bar codes and signatures, where the signatures are associated with the bar codes in a one-to-one correspondence). In step 206, SVE 114 retrieves a scanned log document from scanned manifest logs 204. SVE 114 includes bar code decoder 208 that decodes one or more bar codes included in the retrieved scanned log document. The decoding provided by bar code decoder 208 extracts transaction data and/or other data associated with a particular bar code. The extracted data facilitates a matching of the extracted data with a transaction already stored in database 118 (see FIG. 1). Furthermore, the extracted data is stored in database 118 (see FIG. 1). Signature cropping module 210 identifies each area (a.k.a. signature area) of the retrieved scanned log document that includes a signature and a signature verification software application 212 accesses each signature in the identified area(s). In step 214, for each accessed signature, one or more reference signatures are retrieved from reference signature database table 120. Signature verification software 212 compares each accessed signature to the accessed signature's one or more retrieved reference signatures and determines a scoring result 218 that indicates whether or not the accessed signature matches any of the one or more retrieved reference signatures. If the accessed signature fails to match any retrieved reference signature, the accessed signature is invalid (i.e., not approved). For example, the accessed signature is invalid if the scoring result 218 is less than a predefined minimum acceptable score. If the accessed signature matches any retrieved reference signature, the accessed signature is valid (i.e., approved). For example, the accessed signature is valid if the scoring result 218 is greater than or equal to a predefined minimum acceptable score. If the accessed signature is invalid, signature verification software 212 provides (e.g., displays) a signature exception report 220 for review by the claims verification service provider or another fraud-detecting entity to determine if the invalid signature indicates a fraudulent health care claim. In one embodiment, the review of the exception report 220 modifies the signature's invalid status. For example, an operator reviewing exception report 220 utilizes a source external to signature verification engine 114 to determine that the accessed signature is valid even though the initial scoring result 218 indicates that the signature is invalid. In this example, the signature's status is changed from invalid to valid to reflect the operator's determination that the signature is valid. Scoring results 218 are stored in scoring results database table 122 in, for example, an Extensible Markup Language (XML) format. Signature variants indicated by the scoring results stored in database table 122 are used to update reference signature database table 120. In one embodiment, database tables 120 and 122 are relational database tables included in database 118 (see FIG. 1). In one embodiment, database table 122 includes other transaction data in addition to the scoring results.

Signature verification software 212 is, for example, SignWare® offered by Softpro GmbH located in Boeblingen, Germany.

### Detecting and Preventing Fraudulent Health Care Claims

FIGS. 3A-3C depict a flow diagram of a computer-implemented process for detecting and preventing fraudulent health care claims in the system of FIG. 1, in accordance with embodiments of the present invention. The fraudulent health care claim detection and prevention process begins at step 300 of FIG. 3A. In step 302, CVSP computing unit 102 (see FIG. 1) receives a set of health care transaction records (a.k.a. set of transaction records) that include information regarding health care services that are requested to be provided by multiple health care providers to multiple clients, and may further include information regarding health care products that are to be sold by multiple health care providers to multiple clients. Step 302 includes the CVSP computing unit 102 (see FIG. 1) receiving a transaction record that describes a requested health care transaction in which a client is to be provided a health care service or sold a health care product by a health care provider. Hereinafter, the health care transaction described by the transaction record received in step 302 is also referred to simply as “the transaction.”

In step 304, bar code generator 112 (see FIG. 1) generates an encrypted bar code (e.g., a 2-D PDF417 bar code) that includes information (a.k.a. bar code data) relevant to the health care service or product being provided or sold to the client. The bar code data includes, for example, the date of the transaction, the time of the transaction, and one or more details of the service or product to be provided or sold. In an embodiment in which the transaction is filling a prescription, the details of the service include prescription number, drug name and quantity. In another embodiment in which the transaction is providing non-emergency medical transportation, the details of the service include, for example, a date that the transportation service is to be provided and an identification of the transportation provider. In still another embodiment in which the transaction is providing non-emergency medical transportation and CVSP computing unit 102 (see FIG. 1) has received and stored the health care provider's routes, form 132 (see FIG. 1) is a pre-filled form that includes a bar code. Each client name is pre-printed on the pre-filled form in an area associated with (e.g., next to) an area that receives the corresponding client's signature. The bar code included on the pre-filled form stores trip identifiers, where each signature on the form corresponds to one of the stored trip identifiers.

In the case of the transaction providing non-emergency medical transportation, the bar code may also include an identification of the service to be provided (e.g., take trip or a return trip). In still another embodiment in which the transaction is providing home health care, the details of the service include, for example, an indication of whether the client needs assistance with medication.

In one embodiment, the encrypted bar code contains a representation of a unique identifier of a log form sheet that displays the bar code. The unique code is used to detect a re-submission of a claim for a payment for a health care service (e.g., a re-submission of a single log form sheet by faxing the same sheet twice). The unique code is described in more detail below relative to the discussion of step 336.

In one embodiment, the encrypted bar code generated in step 304 protects the privacy of the client's health information according to governmental regulations. For example, the client's health information is encrypted in the bar code in a HIPAA-compliant manner. In another embodiment, the encrypted bar code prevents disclosure of the client's Medicaid CIN or other client identification information. In still another embodiment, embedded in the encrypted bar code are the transaction date, an identification of the transaction and client-specific information that can be accessed only via looking up data in database 118 (see FIG. 1), thereby preventing the reuse of the bar code for more than one transaction or for a substitute transaction.

In step 306, CVSP computing unit 102 (see FIG. 1) transmits the encrypted bar code to health care provider computing unit 106 (see FIG. 1) via network 110 (see FIG. 1) (e.g., via a website provided by CVSP web server 104 of FIG. 1), along with other information needed to generate a paper-based transaction document that includes the bar code and data entry areas for receiving handwritten transaction data. Also in step 306, health care provider computing unit 106 (see FIG. 1) generates a paper-based transaction document (i.e., bar code/signature form 132 of FIG. 1) that includes the bar code and data entry areas for receiving handwritten transaction data.

In one embodiment, the transaction document includes multiple sets of data entry areas for receiving handwritten transaction data, multiple signature areas (one signature area for each set of data entry areas) for accepting signatures handwritten by multiple clients, and a single encrypted bar code. The encrypted bar code includes an identification of the health care provider that is requested to provide a service to the client and the date (i.e., service date) the health care service is to be provided to the client by the health care provider. In one example, the transaction document is a log form sheet that includes areas for receiving client signatures and for recording transaction data (e.g., type of trip, pickup time, drop-off time, etc.) related to non-emergency medical transportation.

In another embodiment, the transaction document includes multiple sets of data entry areas, multiple signature areas and multiple bar codes, where the bar codes, signature areas and sets of data entry areas are associated in a one-to-one-to-one correspondence.

In still another embodiment, the transaction document is a form or label having an encrypted bar code corresponding to a biometric signature provided by the client.

In step 307, the client's handwritten signature is received. In one embodiment, the client writes her/his signature in a signature area on a log form sheet that is generated as the transaction document in step 306. In another embodiment, the client writes her/his signature on a digital pen pad device (a.k.a. graphics tablet, digitizer tablet or pen tablet). Although subsequent steps of the fraudulent health care claim detection process describe verification actions taken on a single signature, the present invention contemplates receiving multiple signatures from multiple clients in step 307 and applying the verification process to each of the multiple signatures. Also in step 307, transaction data is received on the transaction document generated in step 306. In one embodiment, data related to the transaction is handwritten in the data entry areas included in the transaction document generated in step 306. For example, a driver providing non-emergency medical transportation writes the client's name (or a portion of the client's name), the type of transportation (e.g., return trip), the pick-up time and the drop-off time in designated data entry areas on the transaction document generated in step 306.

Following step 307, the health care provider or a designated delegate of the health care provider sends the transaction document (e.g., log form sheet) to CVSP computing unit 102 (see FIG. 1), where the transaction document is received as a digital image file that includes the signature received in step 307, the transaction data received in step 307 and the bar code generated in step 304. In one embodiment, the health care provider or designated delegate thereof uses fax machine 136 (see FIG. 1) to fax the completed transaction document to an automatic fax system coupled to CVSP computing unit 102 (see FIG. 1). The automatic fax system receives the fax and generates a digital image file of the faxed transaction document. The digital image file is in a computer file format. In one embodiment, the computer file format of the digital image file is Portable Document Format (PDF).

In another embodiment, the health care provider or designated delegate thereof uses scanning unit 136 (see FIG. 1) to scan the completed transaction document to a digital image file (e.g., a TIFF file) that is identified with a date/time stamp. The health care provider computing unit 106 (see FIG. 1) stores the digital image file in a computer file system.

In step 308, CVSP computing unit 102 (see FIG. 1) receives the digital image file that includes the signature received in step 307, the transaction data received in step 307 and the bar code generated in step 304. Following step 308, CVSP computing unit 102 (see FIG. 1) stores the received digital image file in a computer file system (e.g., database 118 of FIG. 1).

In step 310, signature & transaction data extractor 117 (see FIG. 1) extracts the transaction data, the bar code data and the signature from the digital image file. In one embodiment, portions of the digital image file are stored as separate records in database 118 (see FIG. 1). For example, if the digital image file is a PDF file, a first portion of the PDF file corresponding to one side of the log sheet that includes the transaction data is stored in a first record of database 118 (see FIG. 1) and a second portion of the PDF file corresponding to the other side of the log sheet that includes signature data is stored in a second record of database 118 (see FIG. 1).

In one embodiment, if the transaction data is extracted by CVSP computing unit 102 (see FIG. 1), then computing unit 102 (see FIG. 1) stores and correlates the extracted transaction data, the extracted signature, the provider ID extracted from the bar code data, and the service date extracted from the bar code data in database 118 (see FIG. 1). In one embodiment, computing unit 102 (see FIG. 1) also uploads the extracted transaction data, extracted signature, extracted provider ID, and extracted service date to the CVSP website provided by CVSP web server 104 (see FIG. 1). In another embodiment, if the transaction data, signature and bar code data is extracted by health care provider computing unit 106 (see FIG. 1), then computing unit 106 (see FIG. 1) uploads the extracted transaction data, signature and bar code data to the CVSP website provided by CVSP web server 104 (see FIG. 1).

As one example, consider a request for non-emergency medical transportation from a Mary Smith in a case where there are several hundred Mary Smiths who receive Medicaid in New York State. Scanning and reading the encrypted bar code and maintaining the correlation with a particular signature provides assurance that the Mary Smith who provided the signature in step 307 is the Mary Smith who is authorized to receive the requested non-emergency medical transportation to a particular place on a particular date, and from a particular health care provider.

Inquiry step 312 determines whether the extracted bar code data and the extracted transaction data match an authorized transaction (i.e., match a transaction record of the set of transaction records received in step 302. In a first embodiment, step 312 is automatically performed by the SVE 114 (see FIG. 1) in CVSP computing unit 102 (see FIG. 1). In the first embodiment described in this paragraph, the extracted transaction data includes an identification of the client, such as the client's name, a portion of the client's name, the client's home phone number or a portion (e.g., the last four digits) of the client's home phone number. As a first example, the last four digits of the client's home phone number were previously encoded in OMR areas that are included in data entry areas of the transaction document generated in step 306. As a second example, transaction data is extracted from OCR fields that are included in the transaction document generated in step 306. The OCR fields may be designed to look like LCD digits. For instance, a driver providing the non-emergency medical transportation fills in the OCR fields with a client's identification (e.g., first initial, middle initial and first four letters of the client's last name), a pickup time, and a drop-off time. SVE 114 (see FIG. 1) uses client records in database 118 (see FIG. 1) to identify the client associated with the extracted identification of the client. For instance, SVE 114 (see FIG. 1) uses database 118 (see FIG. 1) to identify the client associated with the extracted last four digits of the client's home phone number. The SVE 114 (see FIG. 1) then locates any transaction records in database 118 (see FIG. 1) that are associated with the identified client and that also include other extracted bar code data and/or extracted transaction data (e.g., service date and type of trip).

In a second embodiment, CVSP computing unit 102 (see FIG. 1) displays a list of transaction records (a.k.a. filtered list) that filters out any transaction record received in step 302 that includes: (1) an identifier of a client that does not match the identifier of the client in the transaction data extracted in step 310; (2) an identifier of a health care provider that does not match the provider ID included in the bar code data extracted in step 310; and (3) a date to provide a health care service that does not match the service date in the bar code data extracted in step 310. In the second embodiment of this paragraph, a user of CVSP computing unit 102 (see FIG. 1) checks the filtered list of transaction records in step 312 and determines whether the extracted bar code data and extracted transaction data matches any of the transaction records in the filtered list.

If step 312 determines that the extracted bar code data and the extracted transaction data are not included in any transaction record of the set of transaction records received in step 302 (i.e., the extracted bar code data and extracted transaction data do not match analogous data in an authorized transaction), then in step 314, verification software executing in CVSP computing unit 102 (see FIG. 1) identifies the transaction as a non-authorized transaction (i.e., a fraud or potential fraud of the provider billing for a non-authorized transaction is identified by the verification software). For example, identifying the transaction as a non-authorized transaction includes finding that no transaction record in the set of transaction records received in step 302 includes the provider ID and service date in the extracted bar code data, and the client identifier in the transaction data. Continuing the same example, even if a transaction record in the set of transaction records includes a client identifier that matches the client identifier in the extracted transaction data and a provider identifier that matches the provider ID in the extracted bar code data, but also includes a date of providing a health care service that does not match the service date in the extracted bar code data, then the No branch of step 312 is still taken. Still continuing the same example, if a transaction record in the set of transaction records includes a client identifier that matches the client identifier in the extracted transaction data and a date of providing a health care service that matches the service date in the extracted bar code data, but also includes a provider identifier that does not match the provider ID in the extracted bar code data, then the No branch of step 312 is still taken.

If the SVE 114 (see FIG. 1) automatically performs step 312, then SVE 114 (see FIG. 1) also automatically performs step 314. If a user is checking a filtered list of transaction records in step 312, then the user identifies the non-authorized transaction in step 314.

In step 316, payment to the provider for providing the service is denied. In one embodiment, a payer entity denies the payment in step 316 (e.g., payer computing unit 108 of FIG. 1 automatically denies the payment). In another embodiment, the payer entity has previously given the CVSP permission to authorize or not authorize a payment for the service, and in step 316, the CVSP computing unit 102 (see FIG. 1) automatically denies payment for the service. In still another embodiment, a user manually reviews the transaction and decides whether to approve or deny payment. The user may contact the client (e.g., by telephone) as needed to determine whether to approve or deny payment.

In step 318, CVSP computing unit 102 (see FIG. 1) creates and stores a record in database 118 (see FIG. 1). The record stored in step 318 indicates the suspected fraud of attempting to bill for the non-authorized transaction identified in step 314. The stored record is to be included in an exception report that identifies fraudulent and/or suspected fraudulent health care claims.

In step 320, report generator 116 (see FIG. 1) generates the exception report 131 (see FIG. 1). In one embodiment, exception report 131 (see FIG. 1) is generated dynamically in real-time in response to a user's action in step 320 (e.g., the user clicks on a graphical user interface element to display the exception report). The user is, for example, a user of CVSP computing unit 102 (see FIG. 1), health care provider computing unit 106 (see FIG. 1) or payer computing unit 108 (see FIG. 1). The dynamically generated exception report includes up-to-the-minute data. In another embodiment, report generator 116 (see FIG. 1) uploads the exception report to the website provided by CVSP web server 104 (see FIG. 1) for distribution to users of the CVSP website. In step 322, the fraudulent health care claim detection process ends.

Returning to step 312, if the extracted bar code data and the extracted transaction data matches a transaction in the set of transactions received in step 302, then in one embodiment in which the bar code includes a code that uniquely identifies the sheet of paper on which the transaction document is printed in step 306, the process of detecting fraudulent health care claims continues with step 324 of FIG. 3B.

In step 324 of FIG. 3B, a signature verification engine 114 (see FIG. 1) determines whether the extracted signature is valid (i.e., determines whether the extracted signature matches a reference signature included in database 118 (see FIG. 1)). The process employed by the signature verification engine is described below relative to FIG. 3D.

In an embodiment in which the health care provider is providing non-emergency medical transportation, if step 324 determines that a driver filled in details for a trip on form 132 (see FIG. 1) (i.e., the transaction document generated in step 306 of FIG. 3A) but the signature area on form 132 (see FIG. 1) is empty, then CVSP computing unit 102 (see FIG. 1) stores the trip in database 118 (see FIG. 1) and associates the trip with a no-show/cancel indicator. Further, if the health care provider never submits a signature for a trip stored in database 118 (see FIG. 1), a no-show/cancel indicator is associated with the trip. Such trips that are associated with the no-show/cancel indicator and that are also included in the trips that the health care provider bills are included in a report of fraudulent billing claims that are not signature-related fraud.

If step 324 determines that the signature extracted in step 310 is invalid, then in step 326, signature verification engine 114 (see FIG. 1) identifies the signature as being a suspected fraudulent signature. For example, the suspected fraudulent signature identified in step 310 indicates that the provider is billing for the service, but the service was not provided to the client. In step 328, payment to the provider for providing the service is denied. In one embodiment, a payer entity denies the payment in step 328. In another embodiment, the payer entity has previously given the CVSP permission to authorize or not authorize a payment for the service, and in step 328, the CVSP computing unit 102 (see FIG. 1) automatically denies payment for the service. In still another embodiment, a user manually reviews the transaction and decides whether to approve or deny payment. The user may contact the client (e.g., by telephone) as needed to determine whether to approve or deny payment.

In step 330, CVSP computing unit 102 (see FIG. 1) creates and stores a record of the suspected fraudulent signature and its related transaction in database 118 (see FIG. 1). The stored record is to be included in an exception report that identifies fraudulent and/or suspected fraudulent health care claims.

In step 332, report generator 116 (see FIG. 1) generates the exception report 131 (see FIG. 1). In one embodiment, exception report 131 (see FIG. 1) is generated dynamically in real-time in response to a user's action in step 332 (e.g., the user clicks on a graphical user interface element to display the exception report). The user is, for example, a user of CVSP computing unit 102 (see FIG. 1), health care provider computing unit 106 (see FIG. 1) or payer computing unit 108 (see FIG. 1). The dynamically generated exception report includes up-to-the-minute data. In another embodiment, report generator 116 (see FIG. 1) uploads the exception report to the website provided by CVSP web server 104 (see FIG. 1) for distribution to users of the CVSP website. In step 334, the fraudulent health care claim detection process ends.

Returning to step 324, if the signature verification engine determines that the extracted signature is valid, then the fraudulent health care claim detection process continues with step 336 of FIG. 3C.

In inquiry step 336 of FIG. 3C, verification software running on computing unit 102 (see FIG. 1) determines whether the transaction is a re-submitted transaction (i.e., whether a claim for payment for the service is being submitted a second time). If step 336 determines that a claim for payment for the service is being re-submitted, then in step 338 verification software executing on CVSP computing unit 102 (see FIG. 1) identifies a suspected fraudulent attempt to bill the same claim for payment of the service twice.

In one embodiment, the health care provider is required to use the CVSP website to print out multiple bar code/signature forms 132 (see FIG. 1) in step 306 so that each form 132 includes a bar code that includes a code (a.k.a. unique code) that is unique to that form (i.e., in accordance with a previous agreement between the health care provider and the CVSP, the health care provider does not make photocopies of or otherwise copy a form 132 of FIG. 1 to create multiple forms). An indication that the health care provider agreed to not copy form 132 (see FIG. 1) is stored, for example, in database 118 (see FIG. 1). In the embodiment described in this paragraph, in step 310 (see FIG. 3A) the extractor 117 (see FIG. 1) extracts the unique code from the bar code data. A unique code field is included in database 118 (see FIG. 1), which associates any unique code stored in the unique code field with the transaction record matched in step 324 (see FIG. 3B) (also referred to in this paragraph as the matched transaction record). If the unique code field associated with the matched transaction record is empty at the Yes branch of step 324 (see FIG. 3B), then an additional step (not shown) that proceeds from the Yes branch of step 324 (see FIG. 3B) stores the extracted unique code in the unique code field, and the process continues with step 336. Furthermore, in the embodiment described in this paragraph, the Yes branch of step 336 is taken if the unique code extracted in step 310 (see FIG. 3A) matches a unique code stored in the unique code field that is associated with the matched transaction record in database 118 (see FIG. 1).

As one example of using the unique code in step 336, a transportation provider accesses the CVSP website to print out 10 log form sheets (i.e., Sheets 1 through 10), so that each sheet has a bar code that includes a unique code that uniquely identifies the sheet. For instance unique code C10 identifies Sheet 10. Bob Smith is a client who signs for a non-emergency medical transportation return trip on Sheet 10. The 10 log form sheets are completed with signatures and transaction data and the transportation provider faxes the 10 completed log form sheets to the CVSP, but Sheet 10 is faxed twice—once by the tenth faxed sheet and once by the eleventh faxed sheet. Thus, extracted signature and extracted transaction data for the return trip for Bob Smith is received twice by the CVSP computing unit 102 (see FIG. 1), thereby creating a re-submission of a claim for payment of the return trip for Bob Smith (i.e., a duplicate claim for Bob Smith's return trip is submitted). Following step 324 (see FIG. 3B) in the processing of the tenth faxed sheet, the aforementioned additional step stores the unique code C10 in the unique code field associated with a transaction record R123 corresponding to Bob Smith's return trip. In the processing of the eleventh faxed sheet, verification software in step 336 determines that the unique code C10 extracted from the bar code on the eleventh faxed sheet matches the unique code C10 was previously stored in the unique code field associated with transaction record R123. Because of the unique code match determined in step 336, the process of FIGS. 3A-3C follows the Yes branch of step 336. Thus, the attempt to bill twice for the claim associated with Bob Smith's return trip is identified in step 338, payment for the duplicate claim for Bob Smith's return trip is denied in step 340, the CVSP computing unit 102 (see FIG. 1) creates a record of the fraud associated with the duplicate claim, and the CVSP computing unit stores the record of the duplicate claim fraud in database 118 (see FIG. 1). An exception report that includes the record of the duplicate claim fraud is generated by CVSP computing unit 102 (see FIG. 1) in step 344.

In step 340, payment to the provider for providing the service is denied. In one embodiment, a payer entity denies the payment in step 340. In another embodiment, the payer entity has previously given the CVSP permission to authorize or not authorize a payment for the service, and in step 340, the CVSP computing unit 102 (see FIG. 1) automatically denies payment for the service. In still another embodiment, a user manually reviews the transaction and decides whether to approve or deny payment. The user may contact the client (e.g., by telephone) as needed to determine whether to approve or deny payment.

In step 342, CVSP computing unit 102 (see FIG. 1) creates and stores a record in database 118 (see FIG. 1). The record stored in step 342 indicates the suspected fraud of attempting to bill the same claim twice. The stored record is to be included in an exception report that identifies fraudulent and/or suspected fraudulent health care claims.

In step 344, report generator 116 (see FIG. 1) generates the exception report 131 (see FIG. 1). In one embodiment, exception report 131 (see FIG. 1) is generated dynamically in real-time in response to a user's action in step 344 (e.g., the user clicks on a graphical user interface element to display the exception report). The user is, for example, a user of CVSP computing unit 102 (see FIG. 1) or payer computing unit 108 (see FIG. 1). In another embodiment, report generator 116 (see FIG. 1) uploads the exception report to the website provided by CVSP web server 104 (see FIG. 1). In step 346, the fraudulent health care claim detection process ends.

Returning to step 336, if the transaction is not a re-submitted transaction, then in step 348 payment to the provider for providing the service is authorized. In one embodiment, a payer entity authorizes the payment in step 348. In another embodiment, the payer entity has previously given the CVSP permission to authorize or not authorize a payment for the service, and in step 348, the CVSP computing unit 102 (see FIG. 1) authorizes payment for the service via a payment request generated by MMIS integration unit 127 (see FIG. 1). In one embodiment, step 348 includes the CVSP computing unit revealing the entire Medicaid prior authorization number to the provider to indicate that payment is authorized.

In an alternate embodiment (not shown) in which the bar code does not include the code that uniquely identifies the sheet of paper on which the transaction document is printed, the Yes branch of step 324 proceeds to step 348 of FIG. 3C and then the process ends at step 346 of FIG. 3C. In the embodiment described in this paragraph, database 118 (see FIG. 1) includes a match field that is associated with each transaction record received in step 302 (see FIG. 3A). The match field includes, for example, a value of 0 to indicate that the associated transaction record has not been previously matched by extracted bar code data and extracted transaction data in step 324, or a value of 1 to indicate that the associated transaction record has been matched in step 324. In the embodiment described in this paragraph, an additional condition for proceeding along the Yes branch of step 324 is that the match field indicates that the transaction record has not been matched in a previous execution of step 324 (e.g., the match field includes a value of 0). Furthermore in the embodiment described in this paragraph, the Yes branch of step 324 proceeds to an additional step (not shown), in which the value in the match field is updated to the value (e.g., updated from 0 to 1) that indicates that step 324 matched the transaction record to the extracted bar code data and extracted transaction data.

FIG. 3D depicts a flow diagram of a process for verifying the signature extracted in step 310 (see FIG. 3A). The signature verification process begins at step 350. In step 352, SVE 114 (see FIG. 1) receives the transaction data, bar code data and signature extracted in step 310 of FIG. 3A (i.e., receives the extracted transaction data, the extracted bar code data and the extracted signature). In step 354, signature verification software 212 (see FIG. 2) receives the extracted signature while maintaining the integrity of the correlation between the signature and the extracted transaction data and extracted bar code data. In step 356, signature verification software 212 (see FIG. 2) retrieves one or more reference signatures from a reference signature table in database 118 (see FIG. 1).

In step 358, signature verification software 212 (see FIG. 2) compares the extracted signature to the one or more reference signature(s) retrieved in step 356 and determines a score that indicates whether the extracted signature matches a reference signature retrieved in step 356 based on predefined signature matching criteria. For example, a score of 100 indicates a close resemblance between the extracted signature and one of the retrieved reference signatures, and based on the predefined signature matching criteria the score of 100 indicates a match between the extracted signature and the reference signature.

If there are multiple reference signatures retrieved in step 356, then the score determined in step 358 is the score associated with the reference signature of the multiple retrieved reference signatures that most closely resembles the extracted signature based on the predefined signature matching criteria.

The extracted signature is a verified (i.e., valid) signature if the score determined in step 358 satisfies the predefined signature matching criteria. In one embodiment, the extracted signature is verified if the score determined in step 358 exceeds a predefined threshold score level.

The extracted signature is determined to be a suspected fraudulent signature (i.e., an invalid signature) if the score determined in step 358 fails to satisfy the predefined signature matching criteria. In one embodiment, the signature is a suspected fraudulent signature if the score determined in step 358 does not exceed the predefined threshold score level. A score that does not exceed the predefined threshold score level indicates that the extracted signature does not match any of the one or more reference signatures retrieved in step 356.

In step 360, SVE 114 (see FIG. 1) stores the score determined in step 358 in a scoring results table in database 118 (see FIG. 1).

If there is no reference signature for the extracted signature being processed in step 358, then signature verification software 212 (see FIG. 2) stores the first signature processed in step 358 as a reference signature for the client.

In step 366, report generator 116 (see FIG. 1) generates an exception report 131 (see FIG. 1) that includes any suspected fraudulent signatures identified by SVE 114 (see FIG. 1). The generation of the exception report in step 366 is performed in response to a user (e.g., a user of the CVSP website) activating a graphical user interface (GUI) element (or otherwise interacting with CVSP web server 104 of FIG. 1 or CVSP computing unit 102 of FIG. 1) to dynamically generate and display an exception report in real-time. Further, the generation of the exception report in step 366 includes SVE 114 (see FIG. 1) identifying one or more signatures received in step 356 as suspected fraudulent signatures based on one or more scores being below a predetermined threshold (i.e., a minimum acceptable score), where the one or more scores are determined in step 358 for the one or more signatures. Still further, the generation of the exception report in step 356 includes report generator 116 (see FIG. 1) pulling one or more computer files that include one or more suspected fraudulent signatures. In step 368, CVSP web server 104 receives exception report 131 (see FIG. 1) and report distributor 130 (see FIG. 1) distributes the exception report. In one embodiment, the exception report is distributed to payer computing unit 108 (see FIG. 1) via the CVSP website. The exception report is available in real-time for web-based access and printing. In one example, a user of the payer computing unit 108 (see FIG. 1) receives an email notification when a new exception report is in the queue. In another embodiment, the exception report is distributed to health care provider computing unit 106 (see FIG. 1) via the CVSP website, and users of computing unit 106 (see FIG. 1) receive a notification (e.g., email notification) when a new exception report is in the secure queue. The signature verification process ends at step 370.

### Example

### Non-Emergency Medical Transportation

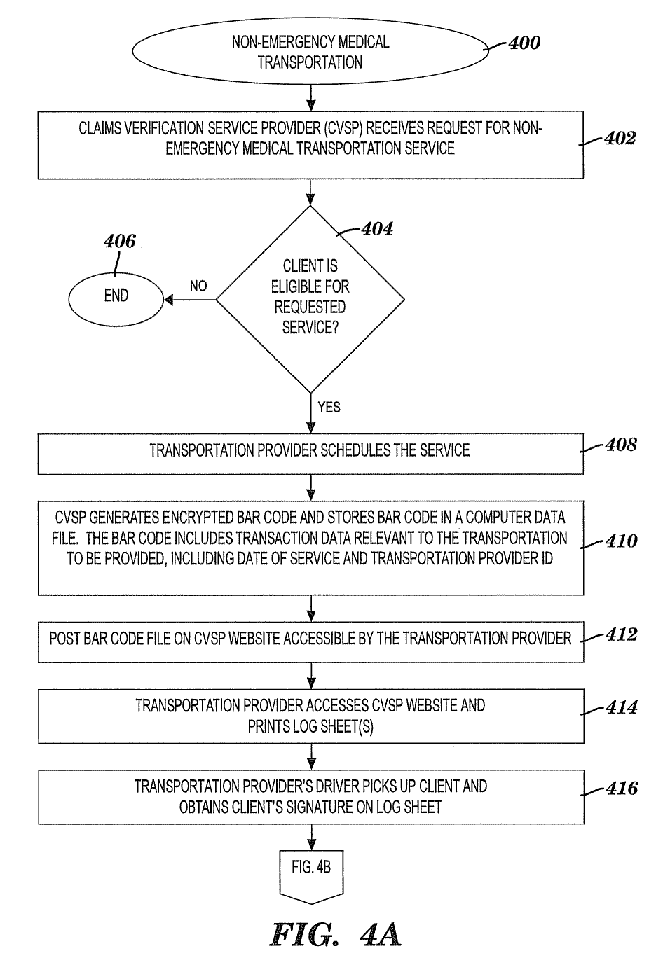

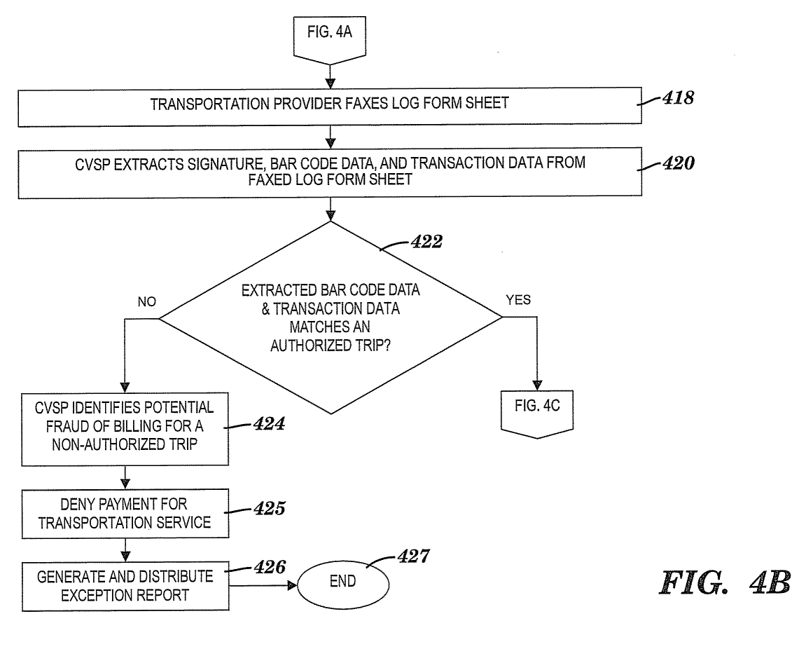

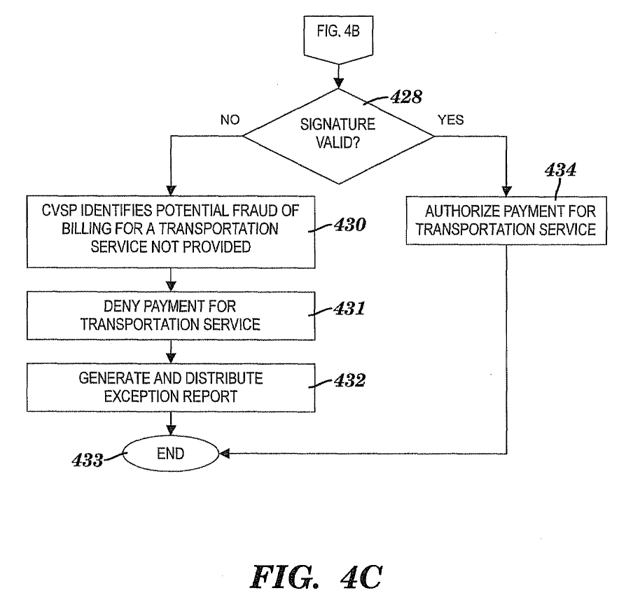

FIGS. 4A-4C depict a flow diagram of a computer-implemented process for detecting a fraudulent health care claim associated with non-emergency medical transportation, in accordance with embodiments of the present invention. The non-emergency medical transportation fraud detection process begins at step 400 of FIG. 4A. In step 402, CVSP computing unit 102 (see FIG. 1) receives a request for a non-emergency medical transportation service to be provided to a client by a transportation provider. The request for the transportation service is received from, for example, the client or a health care provider. In the scenario described in this section, computing unit 106 (see FIG. 1) is utilized by the transportation provider.

In inquiry step 404, CVSP computing unit 102 (see FIG. 1) accesses eligibility data stored in database 118 (see FIG. 1) to determine if the client is eligible to receive a payment for the requested transportation service. In one embodiment, the client is eligible for a payment from Medicaid if the date the transportation is to be provided is prior to the date the client's Medicaid eligibility ends, which is an eligibility end date that was previously received by CVSP computing unit 102 (see FIG. 1) and stored in database 118 (see FIG. 1). If step 404 determines that the client is not eligible for the requested service, the fraudulent medical transportation claim detection process ends at step 406. If step 404 determines that the client is eligible for the requested service, then in step 408, the transportation provider schedules the non-emergency medical transportation service.

In one embodiment, the CVSP computing unit 102 (see FIG. 1) receives a payment authorization number between steps 404 and 408. The authorization number permits the transportation provider to receive payment for providing the non-emergency medical transportation service to the client (e.g., a Medicaid prior authorization number). The CVSP does not show or shows only part of the authorization number to the transportation provider (e.g., via the CVSP website provided by CVSP web server 104 of FIG. 1) until payment for the transportation service is approved by the process of FIGS. 4A-4C. The authorization number is received in response to a prior authorization/approval request generated by MMIS integration unit 127 (see FIG. 1).

In step 410, bar code generator 112 (see FIG. 1) generates an encrypted bar code that is stored in a computer data file. The bar code includes transaction data relevant to the non-emergency medical transportation to be provided to the client, including the date the transportation service is provided and an identifier of the transportation provider.

In step 412, the bar code file generated in step 410 is posted on the CVSP website provided by CVSP web server 104 (see FIG. 1). In one embodiment, the CVSP website is a secure website that is HIPAA-compliant. In step 414, the transportation provider computing unit 106 (see FIG. 1) accesses the CVSP website and prints one or more log sheets generated by bar code/signature form generator 126 (see FIG. 1). In one embodiment, a log sheet is a paper-based artifact. Each log sheet is printed, for example, on a sheet of paper and includes the bar code and one or more areas to receive handwritten signatures from clients and other transaction data from the transportation provider (e.g., a driver). In one embodiment, the other transaction data is written on the log sheet by a driver and includes an indication of whether the trip is a take trip or a return trip, a pickup time, a drop-off time, and the client's name (or a portion of the client's name). In another embodiment in which CVSP computing unit 102 (see FIG. 1) has received and stored the non-emergency medical transportation provider's trips, form 132 (see FIG. 1) is a pre-filled form that includes a bar code and client names pre-printed in areas substantially close to corresponding signature receiving areas. The bar code included on the pre-filled form stores trip identifiers, where each signature on the form corresponds to one of the stored trip identifiers. As used herein, a take trip is defined as a trip by which a client is taken to an appointment location (e.g., health care facility) from a pickup location (e.g., the client's home). As used herein, a return trip is defined as a trip by which a client is returned to the client's pickup location (e.g., the client's home) from the appointment location (e.g., health care facility). In step 416, the transportation provider picks up the client at the pickup location, fills in the other transaction data on the log form sheet, and obtains the client's handwritten signature on the log form sheet. The fraudulent medical transportation claim detection process continues with step 418 of FIG. 4B.

In step 418 of FIG. 4B, the transportation provider uses fax machine 136 (see FIG. 1) to fax the log form sheet that includes the bar code, the client's handwritten signature and the transaction data filled in by the driver. In step 420, an automated fax system provided by CVSP computing unit 102 receives the fax sent in step 418 and converts the fax into an electronic document (e.g., a digital image file). Step 420 also includes CVSP computing unit 102 extracting the transportation provider ID and service date from the bar code and extracting data from each data entry area on the log form sheet. Each data entry area of the log form sheet includes a signature and the signature's associated transaction data that was handwritten by the driver. Step 420 further includes CVSP computing unit 102 (see FIG. 1) storing the log form sheet's extracted data entry areas in multiple records in database 118 (see FIG. 1) along with the data extracted from the log form sheet's bar code. In one embodiment, the data entry areas of the log form sheet are stored in the multiple records of database 118 (see FIG. 1) in a one-to-one correspondence. The storing of the aforementioned extracted data (i.e., from the data entry areas and from the bar code) in step 420 associates the non-emergency medical transportation transaction with a handwritten signature and with a transportation provider.

If SVE 114 (see FIG. 1) determines in inquiry step 422 that the extracted bar code data and extracted transaction data do not match a transaction record for an authorized trip that was previously stored in database 118 (see FIG. 1), then in step 424 SVE 114 (see FIG. 1) identifies a fraudulent or potentially fraudulent health care claim that includes billing for a non-emergency medical transportation service having an authorization issue. For example, the fraudulent health care claim identified in step 424 is a case in which (1) non-emergency medical transportation is provided to a client but the trip was not authorized by a payer, (2) non-emergency medical transportation was authorized for a date that is different from the service date in the extracted transaction data, or (3) non-emergency medical transportation was authorized for an appointment location that is different from the appointment location in the extracted transaction data.

In one embodiment, steps 422 & 424 are performed automatically by SVE 114 (see FIG. 1). In the embodiment described in this paragraph, the extracted transaction data includes an identification of the client, such as the client's name, a portion of the client's name, the client's home phone number or a portion (e.g., the last four digits) of the client's home phone number. As one example, the last four digits of the client's home phone number were previously encoded in OMR areas that are included in data entry areas of the log form sheet printed in step 414 (see FIG. 4A). As a second example, transaction data is extracted from OCR fields that are included in the log sheet printed in step 414 (see FIG. 4A). The OCR fields may be designed to look like LCD digits. For instance, a driver providing the non-emergency medical transportation fills in the OCR fields with a client's identification (e.g., first initial, middle initial and first four letters of the client's last name), a pickup time, and a drop-off time. SVE 114 (see FIG. 1) uses client records in database 118 (see FIG. 1) to identify the client associated with the extracted identification of the client. For instance, SVE 114 (see FIG. 1) uses database 118 (see FIG. 1) to identify the client associated with the extracted last four digits of the client's home phone number. The SVE 114 (see FIG. 1) then locates any transaction records in database 118 (see FIG. 1) that are associated with the identified client and that also include other extracted bar code data and extracted transaction data (e.g., service date and type of trip).

In another embodiment, SVE 114 (see FIG. 1) automatically displays to a user a list of transaction records that is filtered according to the process described above relative to step 422 (see FIG. 4B). The user checks the list and determines whether the extracted bar code data and extracted transaction data matches a transaction record for an authorized trip that was previously stored in database 118 (see FIG. 1). If the user finds a matching authorized trip in step 422, then the user selects the authorized trip in the list to identify the fraud or potential fraud in step 424, and steps 425 and 426 are automatically performed by one or more computing units in FIG. 1.

In step 425, payment to the transportation provider for the transportation service requested in step 402 (see FIG. 4A) is denied (i.e., is not authorized). In one embodiment, the payer denies the payment in step 425. In another embodiment, the CVSP computing unit 102 (see FIG. 1) automatically denies the payment in step 425 based on a prior agreement between the payer and the CVSP that allows the CVSP to authorize or deny such payments. In still another embodiment, a user manually reviews the transaction and decides whether to approve or deny payment. The user may contact the client (e.g., by telephone) as needed to determine whether to approve or deny payment. In one embodiment, step 425 includes preventing the complete authorization number (e.g., the complete Medicaid prior authorization number) from being received or viewed by the transportation provider.

In step 426, report generator 116 (see FIG. 1) generates exception report 131, which includes the fraudulent or potentially fraudulent health care claim identified in step 424. In one embodiment, exception report 131 (see FIG. 1) is generated dynamically in real-time in response to a user's action in step 426 (e.g., the user clicks on a graphical user interface element to display the exception report). The user is, for example, a user of CVSP computing unit 102 (see FIG. 1) or payer computing unit 108 (see FIG. 1). In another embodiment, report generator 116 (see FIG. 1) uploads the exception report to the CVSP website provided by CVSP web server 104 (see FIG. 1) for distribution to users of the CVSP website (e.g., transportation provider or payer). In still another embodiment, steps 366 and 368 of FIG. 3D are substituted for step 426. The fraud detection process for non-emergency medical transportation ends at step 427.

Returning to step 422, if SVE 114 (see FIG. 1) determines that the extracted bar code data and extracted transaction data matches a transaction record for an authorized trip that was previously stored in database 118 (see FIG. 1), then the fraud detection process for non-emergency medical transportation continues with steps 352-360, as described above relative to FIG. 3D, followed by step 428 of FIG. 4C.

SVE 114 (see FIG. 1) determines in step 428 of FIG. 4C that the extracted signature is valid or not valid based on whether the score determined in step 358 (see FIG. 3D) meets predetermined criteria. In one embodiment, the extracted signature is valid if the score determined in step 358 (see FIG. 3D) is greater than a predefined threshold value and is invalid if the score is less than or equal to the predefined threshold value. If the extracted signature is determined to be not valid at step 428, then in step 430 SVE 114 (see FIG. 1) identifies a fraudulent or potentially fraudulent health care claim that includes billing for a non-emergency medical transportation service that is not provided.

In step 431, payment to the transportation provider for the transportation service requested in step 402 (see FIG. 4A) is denied (i.e., is not authorized). In one embodiment, the payer denies the payment in step 431. In another embodiment, the CVSP computing unit 102 (see FIG. 1) automatically denies the payment in step 431 based on a prior agreement between the payer and the CVSP that allows the CVSP to authorize or deny such payments. In still another embodiment, a user manually reviews the transaction and decides whether to approve or deny payment. The user may contact the client (e.g., by telephone) as needed to determine whether to approve or deny payment. In one embodiment, step 431 includes preventing the complete authorization number (e.g., the complete Medicaid prior authorization number) from being received or viewed by the transportation provider.

In step 432, CVSP computing unit 102 (see FIG. 1) generates exception report 131 (see FIG. 1), which includes the fraudulent or potentially fraudulent health care claim identified in step 430. In one embodiment, exception report 131 (see FIG. 1) is generated dynamically in real-time in response to a user's action in step 432 (e.g., the user clicks on a graphical user interface element to display the exception report). The user is, for example, a user of CVSP computing unit 102 (see FIG. 1) or payer computing unit 108 (see FIG. 1). In another embodiment, report generator 116 (see FIG. 1) uploads the exception report to the CVSP website provided by CVSP web server 104 (see FIG. 1) for distribution to users of the CVSP website (e.g., transportation provider or payer). In still another embodiment, steps 366 and 368 of FIG. 3D are substituted for step 432. The fraudulent claim detection process for non-emergency medical transportation ends at step 433.

Returning to step 428, if SVE 114 (see FIG. 1) determines that the signature is valid, then in step 434 SVE 114 (see FIG. 1) verifies that the transportation provider provided the requested non-emergency medical transportation service to the client, and the trip was provided to the authorized location on the authorized date. Furthermore, step 434 includes the payer authorizing payment to the transportation provider for the non-emergency transportation service.

In another embodiment, per a prior agreement between the payer and the CVSP, the payer permits the CVSP to authorize payments to transportation providers, and step 434 includes the CVSP authorizing payment to the transportation provider for providing the non-emergency transportation service. Following step 434, the fraud detection process of FIGS. 4A-4C ends at step 433.

In an alternate embodiment (not shown), the bar code on each log sheet includes a unique code (i.e., a code that uniquely identifies the log sheet), and the transportation provider is required to use the CVSP website to print out multiple log form sheets and is not permitted to photocopy a log form sheet. In the embodiment described in this paragraph, in step 420 (see FIG. 4B) the extractor 117 (see FIG. 1) extracts the unique code from the bar code data. A unique code field is included in database 118 (see FIG. 1), which associates any unique code stored in the unique code field with the transaction record matched in step 422 (also referred to in this paragraph as the matched transaction record). If the unique code field associated with the matched transaction record is empty at the Yes branch of step 422, then an additional step (not shown) that proceeds from the Yes branch of step 422 stores the extracted unique code in the unique code field, and the non-emergency medical transportation fraud detection process continues with a logical flow that is analogous to steps 336, 338, 340, 342, 344, 346 and 348, which are described above relative to FIG. 3C.

In another embodiment, the signature collection and transmission steps described above (e.g., step 416 of FIG. 4A and step 418 of FIG. 4B) are replaced with a driver collecting signatures of clients on a smartphone or a personal digital assistant and then transmitting the signatures to the CVSP web server 104 (see FIG. 1). The CVSP computing unit receives the collected signatures and stores the signatures in database 118 (see FIG. 1).

### Example

### Filling a Prescription

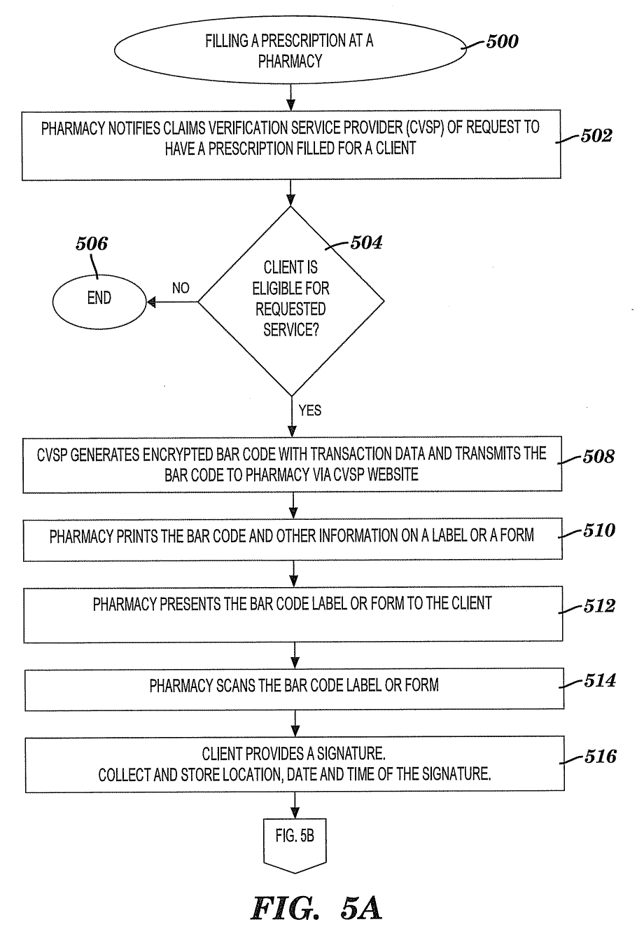

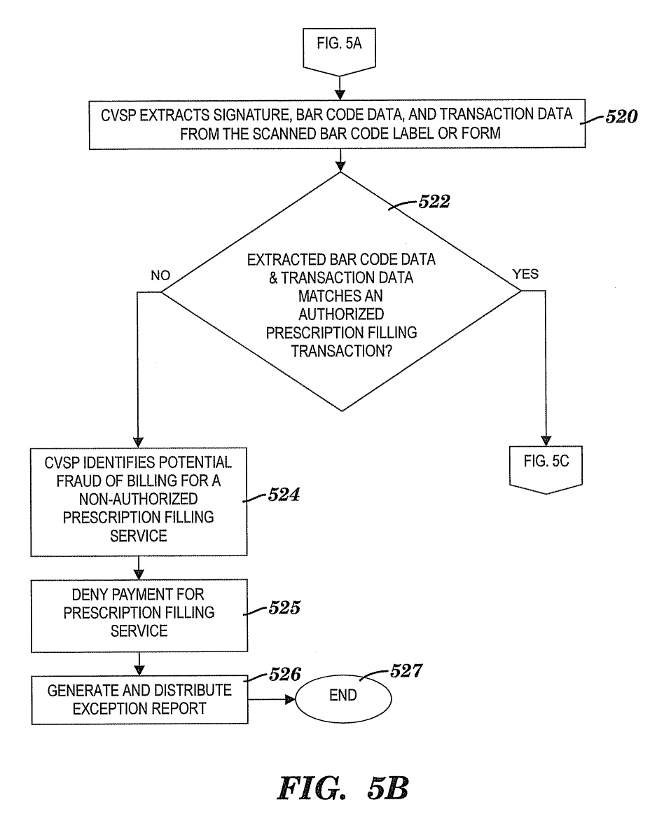

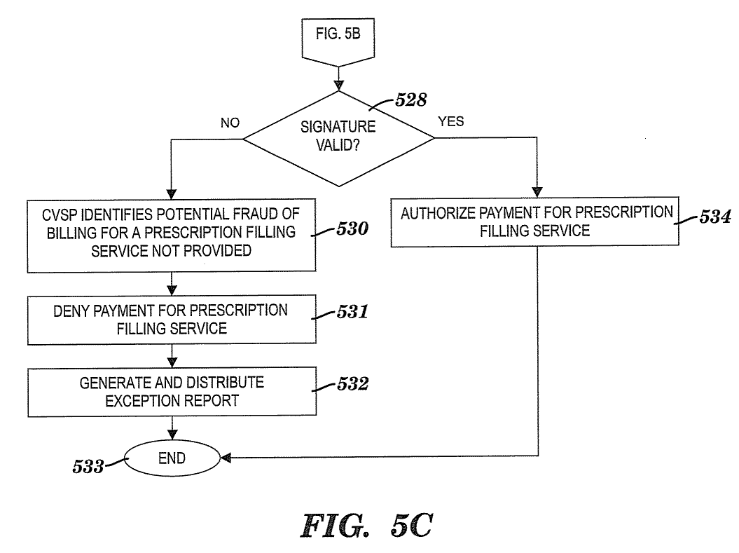

FIGS. 5A-5C depict a flow diagram of a computer-implemented process for detecting a fraudulent health care claim associated with filling a prescription at a pharmacy, in accordance with embodiments of the present invention. In the example described in this section, the pharmacy is the health care provider. Furthermore, in the example described in this section, computing unit 106 (see FIG. 1) is utilized by the pharmacy and is referred to as pharmacy computing unit 106 (see FIG. 1). The fraud detection process of FIGS. 5A-5C begins at step 500. In step 502, pharmacy computing unit 106 (see FIG. 1) sends a request to the CVSP computing unit 102 (see FIG. 1). The request sent in step 502 indicates a request to have a prescription filled for a client. In inquiry step 504, CVSP computing unit 102 (see FIG. 1) accesses eligibility data stored in database 118 (see FIG. 1) to determine if the client is eligible for the requested prescription filling service (e.g., checks the client's Medicaid eligibility). If step 504 determines that the client is not eligible for the requested prescription filling service, then the fraud detection process for prescription claims ends at step 506. If step 504 determines that the client is eligible for the requested prescription filling service, then in step 508 bar code generator 112 (see FIG. 1) generates an encrypted bar code that includes transaction data relevant to the prescription filling request and transmits the bar code to pharmacy computing unit 106 (see FIG. 1) via a HIPAA-compliant website (i.e., the CVSP website provided by CVSP web server 104 of FIG. 1).

In step 510, pharmacy computing unit 106 (see FIG. 1) prints the bar code and other information on a label or a form 132 (see FIG. 1). In step 512, the pharmacy presents to the client the label or form printed in step 510 (e.g., together with the filled prescription). In step 514, the pharmacy scans the label or form 132 (see FIG. 1) that includes the bar code generated in step 508. In step 516, the client provides a signature in response to accepting the filled prescription. In one embodiment, the client provides a biometric signature. Providing a biometric signature includes, for example, signing the client's name on a digital pen pad device (a.k.a. graphics tablet, digitizer tablet or pen tablet).

In another embodiment, the client handwrites the signature on a paper-based artifact (e.g., a log sheet printed on paper) that also includes the bar code generated in step 508. In the case of the client handwriting the signature on the paper form, the scanning of the form in step 514 may be performed after step 516 so that the signature is also scanned. Also in step 516, the signature-related data (e.g., location, time and date of the signature) is collected and stored. For example, if the client provides a biometric signature on a digital pen pad device, the digital pen pad device or a device coupled thereto stores the location and the date and time that the biometric signature was provided. The location associated with providing the biometric signature is the location of the device (e.g., digital pen pad device) when the device accepts the biometric signature and is provided by, for example, a Global Positioning System (GPS) incorporated in or coupled to the device. The date and time associated with providing the biometric signature are provided by, for example, a clock internal to or coupled to the device (e.g., digital pen pad device) that accepts the biometric signature.

In still another embodiment, the client handwrites the signature on a paper form in step 514, where the paper form also includes the bar code generated in step 508, and in step 516 a representative of the pharmacy uses fax machine 136 (see FIG. 1) to fax the paper form to an automated fax service coupled to the CVSP computing unit 102 (see FIG. 1).

In yet another embodiment, the location, date and time of the scan in step 514 may be collected and stored, instead of collecting and storing the location, date and time of providing the signature.

Following step 516, the fraud detection process for prescription filling services continues with step 520 in FIG. 5B.

In step 520 of FIG. 5B, SVE 114 (see FIG. 1) extracts the signature and the transaction data and bar code data from the scanned bar code label or form. The extracted transaction data and extracted bar code data is uploaded in step 520 to the CVSP website provided by CVSP web server 104 (see FIG. 1). The scanned handwritten signature on the paper form or biometric signature provided in step 516 (see FIG. 5A) is also uploaded to the CVSP website in step 520 and stored in database 118 (see FIG. 1). The uploading and storing in step 520 correlates the signature with the extracted transaction data and extracted bar code data and provides a record of the client signing for a specific script at a specific time and at a specific location.

If SVE 114 (see FIG. 1) determines in inquiry step 522 that the extracted bar code data and extracted transaction data does not match an authorized prescription filling transaction that was previously stored in database 118 (see FIG. 1), then in step 524 SVE 114 (see FIG. 1) identifies a fraudulent or potentially fraudulent health care claim that includes billing for a prescription filling service having an authorization issue. For example, the fraudulent health care claim identified in step 524 is a case in which a prescription filling service is provided to a client but the service was not authorized by a payer.

In step 525, payment to the pharmacy for the prescription filling service requested in step 502 (see FIG. 5A) is denied (i.e., is not authorized). In one embodiment, the payer denies the payment in step 525. In another embodiment, the CVSP computing unit 102 (see FIG. 1) automatically denies the payment in step 525 based on a prior agreement between the payer and the CVSP that allows the CVSP to authorize or deny such payments. In still another embodiment, a user manually reviews the transaction and decides whether to approve or deny payment. The user may contact the client (e.g., by telephone) as needed to determine whether to approve or deny payment.

In step 526, report generator 116 (see FIG. 1) generates exception report 131 (see FIG. 1), which includes the fraudulent or potentially fraudulent health care claim identified in step 524. In one embodiment, exception report 131 (see FIG. 1) is generated dynamically in real-time in response to a user's action in step 526 (e.g., the user clicks on a graphical user interface element to display the exception report). The user is, for example, a user of CVSP computing unit 102 (see FIG. 1), pharmacy computing unit 106 (see FIG. 1) or payer computing unit 108 (see FIG. 1). In another embodiment, report generator 116 (see FIG. 1) uploads the exception report to the CVSP website provided by CVSP web server 104 (see FIG. 1) for distribution to users of the CVSP website (e.g., pharmacy or payer). In still another embodiment, steps 366 and 368 of FIG. 3D are substituted for step 526. The fraud detection process for prescription filling services ends at step 527.

Returning to step 522, if SVE 114 (see FIG. 1) determines that the extracted bar code data and extracted transaction data matches an authorized prescription filling service that was previously stored in database 118 (see FIG. 1), then the fraud detection process for prescription filling services continues with steps 352-360, which are described above relative to FIG. 3D, followed by step 528 of FIG. 5C.

SVE 114 (see FIG. 1) determines in step 528 whether the signature provided in step 516 (see FIG. 5A) is valid or not based on the score determined in step 358 of FIG. 3D. If the signature is determined to be not valid at step 528, then in step 530 SVE 114 (see FIG. 1) identifies a fraudulent or potentially fraudulent health care claim that includes billing for a prescription filling service that is not provided.

In step 531, payment to the pharmacy for the service requested in step 502 (see FIG. 5A) is denied (i.e., is not authorized). In one embodiment, the payer denies the payment in step 531. In another embodiment, the CVSP computing unit 102 (see FIG. 1) automatically denies the payment in step 531 based on a prior agreement between the payer and the CVSP that allows the CVSP to authorize or deny such payments. In still another embodiment, a user manually reviews the transaction and decides whether to approve or deny payment. The user may contact the client (e.g., by telephone) as needed to determine whether to approve or deny payment. In one embodiment, step 531 includes preventing the complete authorization number (e.g., the complete Medicaid prior authorization number) from being received or viewed by the pharmacy.

In step 532, CVSP computing unit 102 (see FIG. 1) generates exception report 131 (see FIG. 1), which includes the fraudulent or potentially fraudulent health care claim identified in step 530. In one embodiment, exception report 131 (see FIG. 1) is generated dynamically in real-time in response to a user's action in step 532 (e.g., the user clicks on a graphical user interface element to display the exception report). The user is, for example, a user of CVSP computing unit 102 (see FIG. 1), pharmacy computing unit 106 (see FIG. 1) or payer computing unit 108 (see FIG. 1). In another embodiment, report generator 116 (see FIG. 1) uploads the exception report to the CVSP website provided by CVSP web server 104 (see FIG. 1) for distribution to users of the CVSP website (e.g., pharmacy or payer). Exception report 131 (see FIG. 1) is uploaded to CVSP web server 104 (see FIG. 1) and is distributed by report distributor 130 (see FIG. 1) to the pharmacy and/or the payer. In another embodiment, the exception report is accessed by the CVSP for internal use. In one embodiment, steps 366 and 368 of FIG. 3D are substituted for step 532. The fraudulent claim detection process for filling prescriptions at a pharmacy ends at step 533.

Returning to step 528, if SVE 114 (see FIG. 1) determines that the signature provided in step 516 (see FIG. 5A) is valid, then in step 534 SVE 114 (see FIG. 1) verifies that the pharmacy provided the requested prescription filling service to the client. Furthermore, step 534 includes the payer authorizing payment to the pharmacy for the prescription filling service. In another embodiment, per a prior agreement between the payer and the CVSP, the payer permits the CVSP to authorize payments to pharmacies, and step 534 includes the CVSP authorizing payment to the pharmacy for providing the prescription filling service. Following step 534, the fraud detection process of FIGS. 5A-5C ends at step 533.

In an alternate embodiment (not shown), the bar code on each form printed in step 510 includes a unique code (i.e., a code that uniquely identifies the form), and the pharmacy is required to use the CVSP website to print out multiple forms and is not permitted to photocopy a form. In the embodiment described in this paragraph, in step 520 (see FIG. 5B) the extractor 117 (see FIG. 1) extracts the unique code from the bar code data. A unique code field is included in database 118 (see FIG. 1), which associates any unique code stored in the unique code field with the transaction record matched in step 522 (also referred to in this paragraph as the matched transaction record). If the unique code field associated with the matched transaction record is empty at the Yes branch of step 522, then an additional step (not shown) that proceeds from the Yes branch of step 522 stores the extracted unique code in the unique code field, and the prescription filling fraud detection process continues with a logical flow that is analogous to steps 336, 338, 340, 342, 344, 346 and 348, which are described above relative to FIG. 3C. If the flow proceeds along the Yes branch of the step analogous to step 336 (see FIG. 3C), then SVE 114 (see FIG. 1) detects a re-submission of the same label or form 132 (see FIG. 1) (i.e., detects an attempt to bill twice for the same claim related to a pharmacy's filling of a prescription).

### Example

### Physician's Office Visit

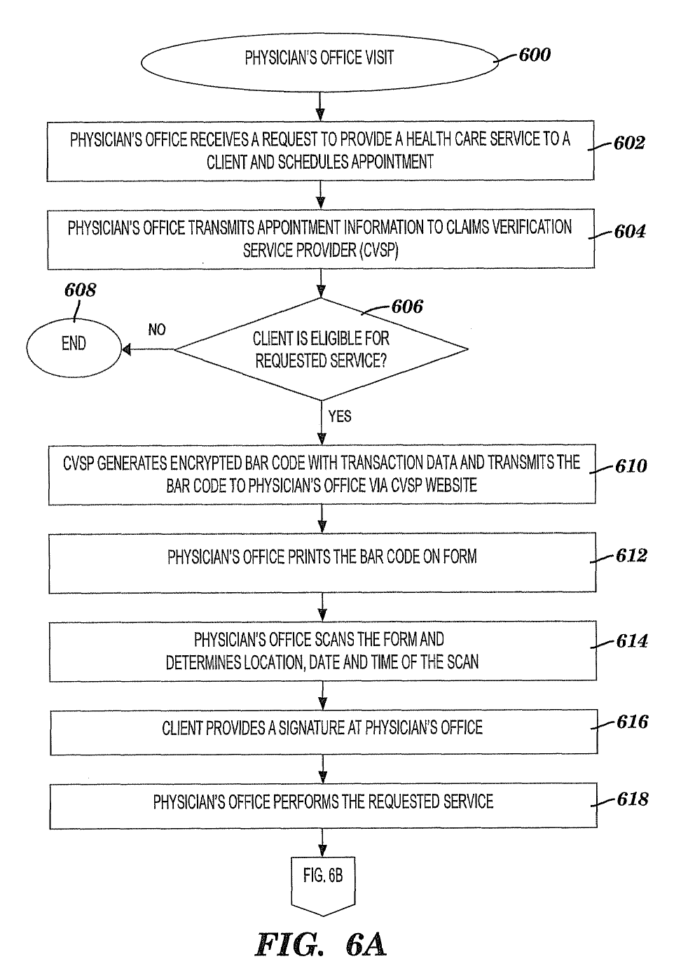

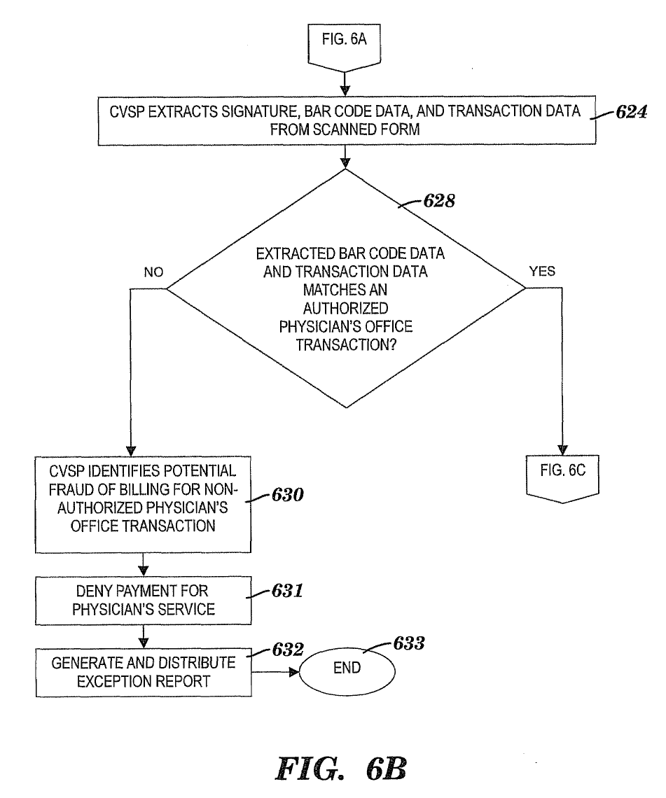

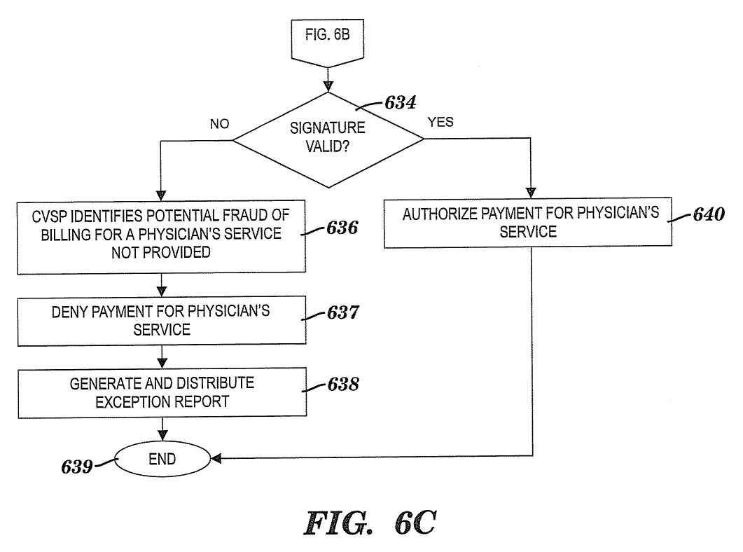

FIGS. 6A-6C depict a flow diagram of a computer-implemented process for detecting a fraudulent health care claim associated with a physician's service, in accordance with embodiments of the present invention. In the example described in this section, the physician's office is the health care provider. Furthermore, in the example described in this section, computing unit 106 (see FIG. 1) is utilized by the physician's office and is referred to as physician computing unit 106 (see FIG. 1). The fraud detection process of FIGS. 6A-6C begins at step 600. In step 602, physician computing unit 106 (see FIG. 1) receives a request to provide a health care service (a.k.a. physician's service) to a client and schedules an appointment for the client to receive the requested health care service.

In step 604, physician computing unit 106 (see FIG. 1) transmits information about the appointment to the CVSP computing unit 102 (see FIG. 1). In inquiry step 606, CVSP computing unit 102 (see FIG. 1) accesses eligibility data stored in database 118 (see FIG. 1) to determine if the client is eligible for the requested physician's service (e.g., checks the client's Medicaid eligibility). If step 606 determines that the client is not eligible for the requested physician's service, then the fraud detection process for physician's office visit claims ends at step 608. If step 606 determines that the client is eligible for the requested physician's service, then in step 610 bar code generator 112 (see FIG. 1) generates an encrypted bar code that includes transaction data relevant to the request for the physician's service and transmits the bar code to physician computing unit 106 (see FIG. 1) via a HIPAA-compliant website (i.e., the CVSP website provided by CVSP web server 104 of FIG. 1).

In step 612, physician computing unit 106 (see FIG. 1) prints the bar code and other information on a paper form 132 (see FIG. 1). In step 612, the pharmacy presents to the client the printed form. In step 614, a representative of the physician's office scans the form 132 (see FIG. 1) that includes the bar code generated in step 610. Also in step 614, scan-related data (e.g., location, time and date of the scan) is collected and stored. For example, if the representative of the physician's office uses scanning unit 136 (see FIG. 1) to scan form 132 (see FIG. 1), the scanning unit or a device coupled thereto stores the location and the date and time that the scan was performed. The location associated with scanning the form is the location of the scanning unit 136 (see FIG. 1) when the scanning unit scans the form and is provided by, for example, a Global Positioning System (GPS) incorporated in or coupled to the scanning unit. The date and time associated with the scan are provided by, for example, a clock internal to or coupled to the scanning unit 136 (see FIG. 1).

In step 616, the client provides a signature upon admittance to the physician's office. In one embodiment, the client provides a biometric signature. Providing a biometric signature includes, for example, signing the client's name on a digital pen pad device (a.k.a. graphics tablet, digitizer tablet or pen tablet).

In another embodiment, the client handwrites the signature on the paper form 132 (see FIG. 1) that also includes the bar code generated in step 610. In the case of the client handwriting the signature on the paper form, the scanning of the form in step 614 may be performed after step 616 so that the signature is also scanned.

In still another embodiment, the client handwrites the signature on a paper form in step 616, where the paper form also includes the bar code generated in step 610, and in step 616 a representative of the physician's office uses fax machine 136 (see FIG. 1) to fax the paper form 132 (see FIG. 1) to an automated fax service coupled to the CVSP computing unit 102 (see FIG. 1).

In yet another embodiment, the location, date and time of the signature provided in step 616 may be collected and stored, instead of collecting and storing the location, date and time of the scan.

In step 618, the physician's office performs the requested health care service. Following step 618, the fraud detection process for prescription filling services continues in FIG. 6B.

In step 624 of FIG. 6B, SVE 114 (see FIG. 1) extracts the signature, bar code data and associated transaction data from the scanned form 132 (see FIG. 1). In one embodiment, the extracted transaction data and extracted bar code data is uploaded in step 624 to the CVSP website provided by CVSP web server 104 (see FIG. 1). The scanned handwritten signature on the paper form or biometric signature provided in step 616 (see FIG. 6A) is also uploaded to the CVSP website in step 624 and stored in database 118 (see FIG. 1). The uploading and storing in step 624 correlates the signature with the extracted transaction data and extracted bar code data and provides a record of the client signing for admittance to the physician's office at a specific time and at a specific location.

If SVE 114 (see FIG. 1) determines in inquiry step 628 that the extracted bar code data and extracted transaction data do not match an authorized physician's office transaction that was previously stored in database 118 (see FIG. 1), then in step 630 SVE 114 (see FIG. 1) identifies a fraudulent or potentially fraudulent health care claim that includes billing for a non-authorized physician's service (i.e., the physician's service is provided to a client but the service was not authorized by a payer).

In step 631, payment to the physician's office for the physician's service requested in step 602 (see FIG. 6A) is denied (i.e., is not authorized). In one embodiment, the payer denies the payment in step 631. In another embodiment, the CVSP computing unit 102 (see FIG. 1) automatically denies the payment in step 631 based on a prior agreement between the payer and the CVSP that allows the CVSP to authorize or deny such payments. In still another embodiment, a user manually reviews the transaction and decides whether to approve or deny payment. The user may contact the client (e.g., by telephone) as needed to determine whether to approve or deny payment.

In step 632, report generator 116 (see FIG. 1) generates exception report 131 (see FIG. 1), which includes the fraudulent or potentially fraudulent health care claim identified in step 630. In one embodiment, exception report 131 (see FIG. 1) is generated dynamically in real-time in response to a user's action in step 632 (e.g., the user clicks on a graphical user interface element to display the exception report). The user is, for example, a user of CVSP computing unit 102 (see FIG. 1), physician computing unit 106 (see FIG. 1) or payer computing unit 108 (see FIG. 1). In another embodiment, report generator 116 (see FIG. 1) uploads the exception report to the CVSP website provided by CVSP web server 104 (see FIG. 1) for distribution to users of the CVSP website (e.g., physician or payer). In still another embodiment, steps 366 and 368 of FIG. 3D are substituted for step 632. The fraud detection process for a physician's office visit ends at step 633.

Returning to step 628, if SVE 114 (see FIG. 1) determines that the extracted bar code data and extracted transaction data match an authorized physician's office transaction that was previously stored in database 118 (see FIG. 1), then the fraud detection process for a physician's office visit continues with steps 352-360 of FIG. 3D followed step 634 of FIG. 6C.

SVE 114 (see FIG. 1) determines in step 634 of FIG. 6C whether the signature provided in step 616 (see FIG. 6A) is valid or not based on the score determined in step 358 of FIG. 3D. If the signature is determined to be not valid at step 634, then in step 636 SVE 114 (see FIG. 1) identifies a fraudulent or potentially fraudulent health care claim that includes billing for a physician's service that is not provided.

In step 637, payment to the physician's office for the service requested in step 602 (see FIG. 6A) is denied (i.e., is not authorized). In one embodiment, the payer denies the payment in step 637. In another embodiment, the CVSP computing unit 102 (see FIG. 1) automatically denies the payment in step 637 based on a prior agreement between the payer and the CVSP that allows the CVSP to authorize or deny such payments. In still another embodiment, a user manually reviews the transaction and decides whether to approve or deny payment. The user may contact the client (e.g., by telephone) as needed to determine whether to approve or deny payment. In one embodiment, step 637 includes preventing the complete authorization number (e.g., the complete Medicaid prior authorization number) from being received or viewed by the transportation provider.

In step 638, CVSP computing unit 102 (see FIG. 1) generates exception report 131 (see FIG. 1), which includes the fraudulent or potentially fraudulent health care claim identified in step 636. In one embodiment, exception report 131 (see FIG. 1) is generated dynamically in real-time in response to a user's action in step 638 (e.g., the user clicks on a graphical user interface element to display the exception report). The user is, for example, a user of CVSP computing unit 102 (see FIG. 1), physician computing unit 106 (see FIG. 1) or payer computing unit 108 (see FIG. 1). In another embodiment, report generator 116 (see FIG. 1) uploads the exception report to the CVSP website provided by CVSP web server 104 (see FIG. 1) for distribution to users of the CVSP website (e.g., physician or payer). In still another embodiment, steps 366 and 368 of FIG. 3D are substituted for step 638. The fraudulent claim detection process for physician's services ends at step 639.

Returning to step 634, if SVE 114 (see FIG. 1) determines that the signature provided in step 616 (see FIG. 6A) is valid, then in step 640 SVE 114 (see FIG. 1) verifies that the physician's office provided the requested physician's service to the client. Furthermore, step 640 includes the payer authorizing payment to the physician's office for the physician's service.

In another embodiment, per a prior agreement between the payer and the CVSP, the payer permits the CVSP to authorize payments to physician's offices, and step 640 includes the CVSP authorizing payment to the physician's office for providing the physician's service. Following step 640, the fraud detection process of FIGS. 6A-6C ends at step 633.

In another embodiment, steps 614 and 616 of FIG. 6A are a first scan and first provision of the client's signature, respectively. In a step 620 (not shown) following step 618 in FIG. 6A, the client provides a second signature upon signing out of the physician's office. In a step 622 (not shown), which follows the aforementioned step 620, a representative of the physician's office scans the bar code a second time using the scanning unit 136 (see FIG. 1), which also determines the location, date and time of the second scan using the same GPS and clock-based techniques described above relative to step 614 (see FIG. 6A). Following step 622, the fraud detection process for services associated with a physician's office visit continues with the steps of FIG. 6B. In this embodiment, the two scans and two signatures provide a record of the client signing in and signing out for a physician's office visit at specific times and at a specific location.

In an alternate embodiment (not shown), the bar code generated on form 132 (see FIG. 1) in step 612 (see FIG. 6A) includes a unique code (i.e., a code that uniquely identifies the form), and the physician's office is required to use the CVSP website to print out multiple forms and is not permitted to photocopy a form. In the embodiment described in this paragraph, in step 624 (see FIG. 6B) the extractor 117 (see FIG. 1) extracts the unique code from the bar code data. A unique code field is included in database 118 (see FIG. 1), which associates any unique code stored in the unique code field with the transaction record matched in step 628 (also referred to in this paragraph as the matched transaction record). If the unique code field associated with the matched transaction record is empty at the Yes branch of step 628, then an additional step (not shown) that proceeds from the Yes branch of step 628 stores the extracted unique code in the unique code field, and the fraud detection process related to a transaction at a physician's office continues with a logical flow that is analogous to steps 336, 338, 340, 342, 344, 346 and 348, which are described above relative to FIG. 3C. If the flow proceeds along the Yes branch of the step analogous to step 336 (see FIG. 3C), then SVE 114 (see FIG. 1) detects a re-submission of the same form 132 (see FIG. 1) (i.e., detects an attempt to bill twice for the same claim related to a physician's office transaction).

### Computing System

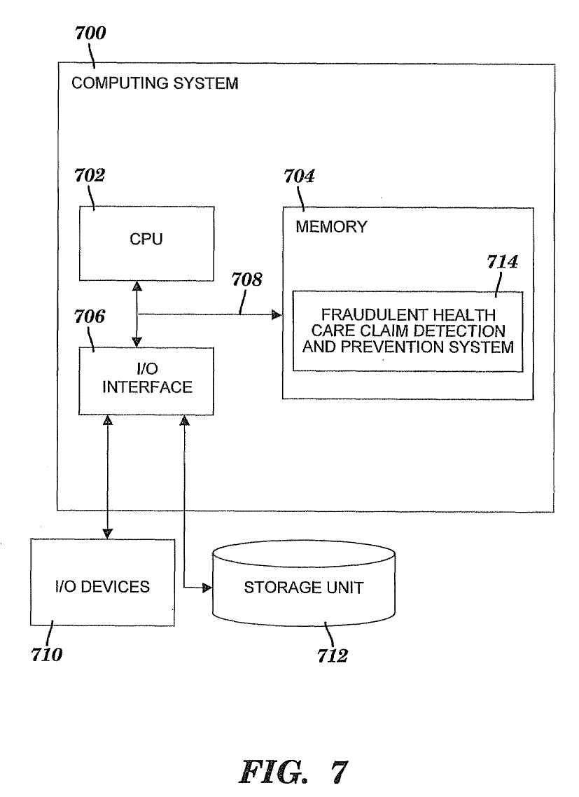

FIG. 7 is a block diagram of a computing system that implements the process of FIGS. 3A-3C, in accordance with embodiments of the present invention. Computing system 700 generally comprises a central processing unit (CPU) 702, a memory 704, an input/output (I/O) interface 706, a bus 708, I/O devices 710 and a computer data storage unit 712. Computing system 700 includes one or more of computing units 102, 104 and 106 shown in FIG. 1. CPU 702 performs computation and control functions of computing system 700. CPU 702 may comprise a single processing unit, or be distributed across one or more processing units in one or more locations (e.g., on a client and server).

Memory 704 may comprise any known type of data storage and/or transmission media, including bulk storage, magnetic media, optical media, random access memory (RAM), read-only memory (ROM), a data cache, a data object, etc. Cache memory elements of memory 704 provide temporary storage of at least some program code in order to reduce the number of times code must be retrieved from bulk storage during execution. Computer data storage unit 712 stores database 118 (see FIG. 1) and is, for example, a magnetic disk drive (i.e., hard disk drive) or an optical disk drive. Moreover, similar to CPU 702, memory 704 may reside at a single physical location, comprising one or more types of data storage, or be distributed across a plurality of physical systems in various forms. Further, memory 704 can include data distributed across, for example, a LAN, WAN or storage area network (SAN) (not shown).

I/O interface 706 comprises any system for exchanging information to or from an external source. I/O devices 710 comprise any known type of external device, including a display monitor, keyboard, mouse, printer, speakers, handheld device, facsimile, etc. Bus 708 provides a communication link between each of the components in computing system 700, and may comprise any type of transmission link, including electrical, optical, wireless, etc.

I/O interface 706 also allows computing system 700 to store and retrieve information (e.g., program instructions or data) from an auxiliary storage device (e.g., computer data storage unit 712). The auxiliary storage device may be a non-volatile storage device (e.g., a CD-ROM drive which receives a CD-ROM disk). Computing system 700 can store and retrieve information from other auxiliary storage devices (not shown), which can include a direct access storage device (DASD) (e.g., hard disk or floppy diskette), a magneto-optical disk drive, a tape drive, or a wireless communication device.

Memory 704 includes computer program code 714 that provides the logic for the health care claim fraud detection and prevention method and system disclosed herein (e.g., the processes of FIGS. 3A-3C, 3D, 4A-4C, 5A-5C and 6A-6C). Further, memory 704 may include other systems not shown in FIG. 7, such as an operating system (e.g., Linux) that runs on CPU 702 and provides control of various components within and/or connected to computing system 700.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can tale the form of a computer program product accessible from a computer-usable or computer-readable medium providing program code 714 for use by or in connection with a computing system 700 or any instruction execution system to provide and facilitate the capabilities of the present invention. For the purposes of this description, a computer-usable or computer-readable medium can be any apparatus that can contain, store, communicate, propagate, or transport the program code 714 for use by or in connection with the instruction execution system, apparatus, or device.

The computer-usable or computer-readable medium can be a semiconductor system, apparatus or device or another system, apparatus or device that utilizes electronic, magnetic, optical, electromagnetic or infrared data storage or data processing. Examples of a computer usable or computer-readable medium include a semiconductor or solid state memory, magnetic tape, a removable computer diskette, RAM, ROM, a rigid magnetic disk and an optical disk. Current examples of optical disks include compact disk-read-only memory (CD-ROM), compact disk-read/write (CD-R/W) and DVD.

The present invention relates generally to a method, system and computer program product for detecting and preventing fraudulent health care claims, and more particularly to a technique for utilizing signature capture, signature verification, transaction data included in encrypted barcodes corresponding to captured signatures, and an exception reporting system to detect and prevent fraudulent health care claims.

The invention provides a system, method and computer program product that produces encrypted transaction information in a bar code format, captures signatures specifically correlated to and inseparable from the bar code and integrates a signature verification method with an exception reporting software module, thereby facilitating the detection and prevention of fraudulent health care claims.

The present invention provides a method for detecting and preventing fraudulent health care claims. The method comprises:

receiving, by a claims verification service provider (CVSP), information regarding a health care service or product to be provided or sold to a client;

generating, by the CVSP, an encrypted bar code that includes transaction data;

transmitting, by the CVSP, the encrypted bar code and relevant transaction data to a health care provider;

generating (1) a log form sheet having signature areas for handwritten signatures and encrypted bar codes where each bar code corresponds to one of the signature areas or (2) a form or label having an encrypted bar code corresponding to a biometric signature provided by the client;

scanning, by the health care provider, the signed log form sheet, label or form into a computer file format and storing the scanned log form sheet, label or form in a computer file system;

extracting, by the health care provider, transaction data from the bar code included in the scanned log form sheet, label or form, obtaining the signature associated with the extracted transaction data, and uploading the extracted transaction data and associated signature to a CVSP web server;

receiving, by a signature verification engine (SVE), the extracted transaction data and associated signature;

receiving, by signature verification software, the signature while maintaining the integrity of the correlation between the signature and the extracted transaction data;

retrieving, by the signature verification software, one or more reference signatures from a reference signature database;

comparing, by the signature verification software, the signature to the retrieved reference signature(s) and determining a score that indicates that the signature is verified or a suspected fraudulent signature;

storing, by the SVE, the score in a scoring results database;

if the score indicates that the signature is a suspected fraudulent signature, generating, by the SVE, a computer file of a form that includes the signature;

receiving, by a report generator, the computer file of the form that includes the signature;

generating, by the report generator, an exception report that includes any suspected fraudulent signatures identified by the SVE; and

distributing, by the CVSP web server, the exception report to customers,

wherein detection and prevention of fraudulent health care claims is facilitated by using the bar code and a verified signature to associate the date, time and location of a health care transaction with a particular health care claim.

A system and computer program product corresponding to the above-summarized method are also described herein.

Advantageously, the present invention provides a technique for detecting and preventing fraudulent health care claims for any type of health care transaction that uses signature verification as proof of a service or product being provided (e.g., claims relative to non-emergency medical transportation, home health care, a physician's office visit, filling a prescription at a pharmacy, etc.).

The present invention provides a system, method and computer program product that generates encrypted health care transaction information in a bar code format, captures a client's signature specifically correlated to and inseparable from the bar code, and integrates a signature verification method with an exception reporting software module, thereby facilitating the detection and prevention of fraudulent claims for health care services and products. The technique disclosed herein combines the bar code and a verified client signature to associate the client with a particular place, date and time and to associate the presence of the client with a particular health care transaction being performed on that date (e.g., the provision of non-emergency medical transportation). Thus, the system and method disclosed herein use the bar code and verified signature to relate the transaction time and location to a particular claim.

In one embodiment, a client's signature on a form (e.g., a paper form) is correlated with transaction data displayed on the form, thereby signifying the acceptance and agreement of the client, and further the client's signature is correlated with the transaction information included in the encrypted bar code in a manner compliant with privacy regulations relevant to health information (e.g., Health Insurance Portability and Accountability Act (HIPAA) of 1996), which prevents anyone from duplicating the use of the signature.

In another embodiment, a health care provider (e.g., a pharmacy) notifies a claims verification service provider (CVSP) of a request for a health care service (e.g., a request to have a prescription filled). The CVSP generates the encrypted bar code in the form of a label or form which is electronically transmitted to the health care provider via a website that complies with health information privacy regulations (e.g., HIPAA regulations). The health care provider prints the label or form which is presented to the client (e.g., presented to the client together with the filled prescription). The bar code is scanned with a bar code scanner and the client provides a signature on a digitizer pad. The information from the scan of the bar code and the digital signature provided via the digitizer pad are correlated in the same data file and are associated throughout the fraud detection process described herein.

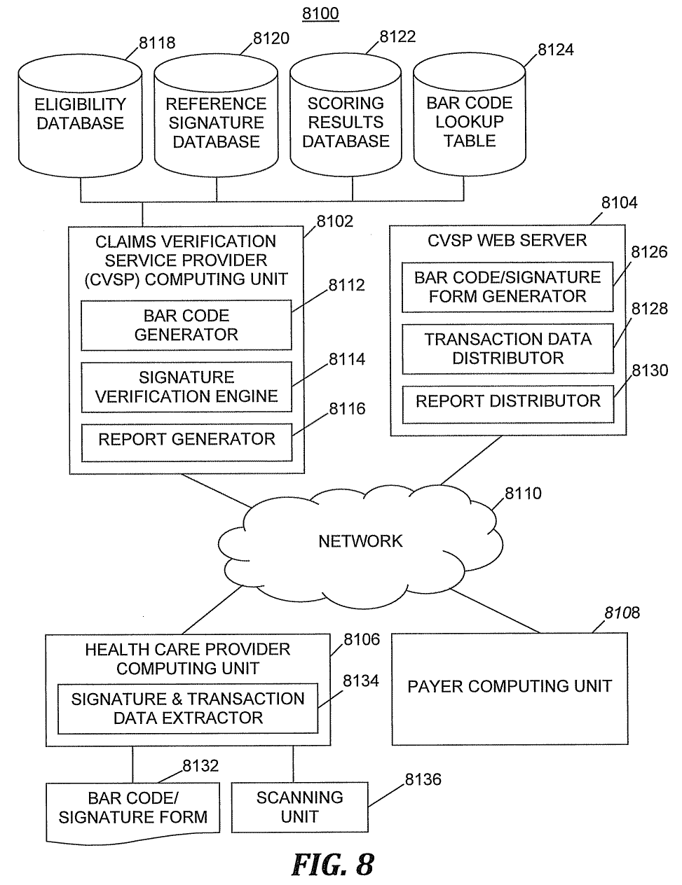

FIG. 8 is a block diagram of a system for detecting and preventing fraudulent health care claims, in accordance with embodiments of the present invention. System 8100 includes a claims verification service provider (CVSP) computing unit 8102, a CVSP web server 8104, a health care provider computing unit 8106 and a payer computing unit 8108. Computing units 8102, 8106 and 8108 access a website (a.k.a. CVSP website) provided by CVSP web server via a network 8110 (e.g., the Internet).

CVSP computing unit 8102 includes a bar code generator 8112, a signature verification engine (SVE) 8114 and a report generator 8116. CVSP computing unit 8102 is coupled to one or more storage units that include an eligibility database 8118, a reference signature database 8120, a scoring results database 8122 and a bar code lookup table 8124.

Bar code generator 8112 generates encrypted bar codes that include data (i.e., transaction data) related to a health care transaction. Transaction data includes information such as the date and time of the transaction, a name of a client who is receiving a health care product or service, the client's identification code (e.g., Medicaid Client Identification Number (CIN)), and details of the health care product or service being provided.

SVE 8114 receives digital signatures (e.g., handwritten signatures that have been scanned or signatures provided on an electronic touch pad) and associated bar codes that include transaction data, decodes bar codes via bar code lookup table 8124, and compares received signatures to one or more reference signatures from database 8120 to detect fraudulent health care claims.

Report generator 8116 generates exception reports that identify potentially fraudulent health care claims.

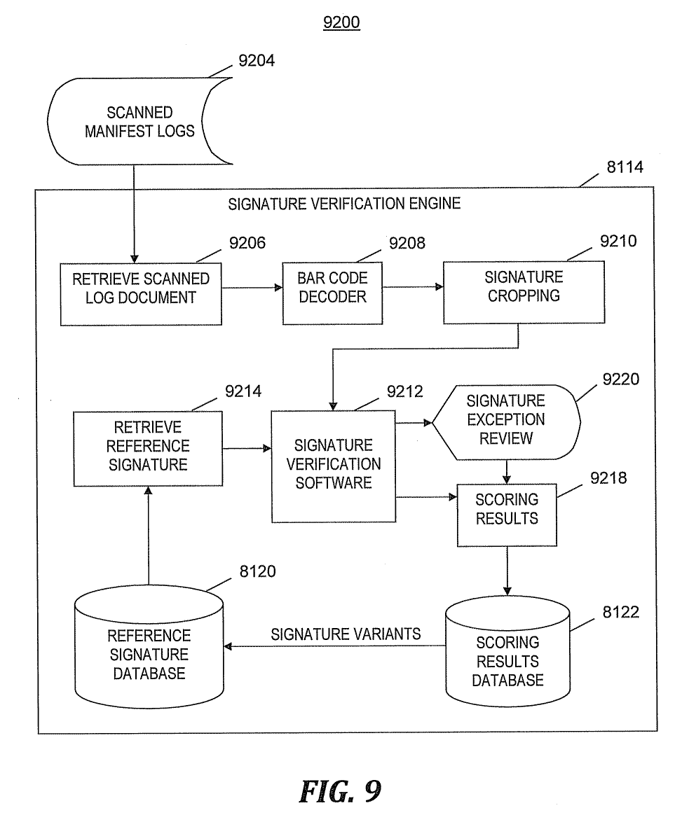

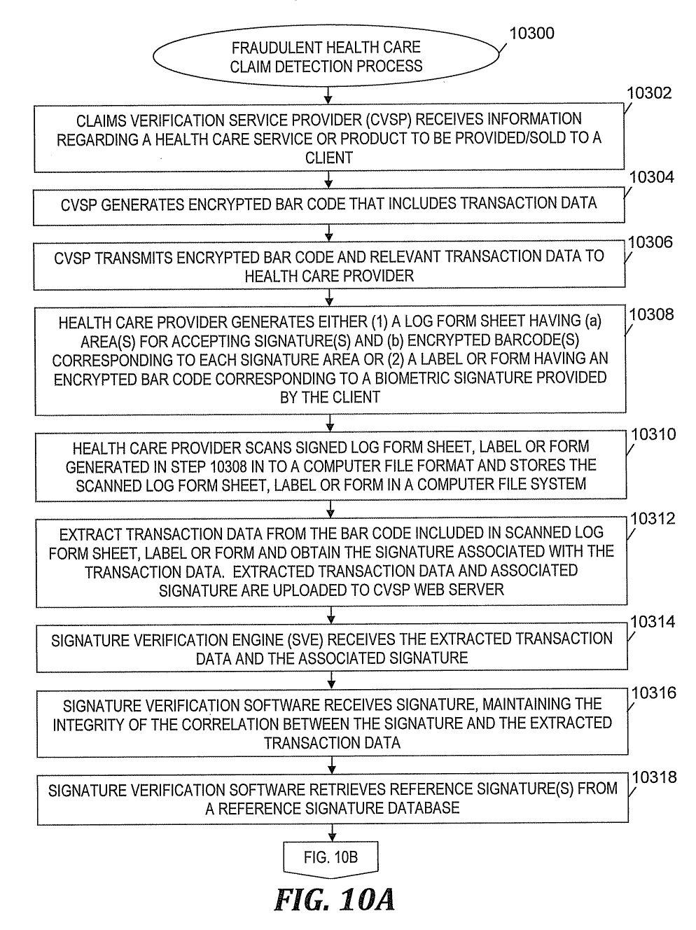

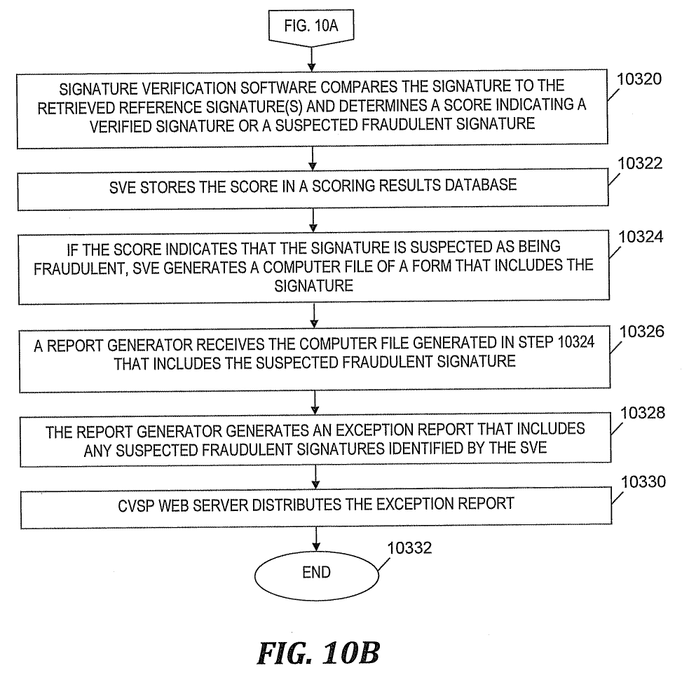

Components of system 8100 that are included in or coupled to CVSP computing unit 8102 are described in detail in the claims verification process presented below relative to FIGS. 10A-10B. Subcomponents of SVE 8114 are described below relative to FIG. 9.

CVSP web server 8104 includes a bar code/signature form generator 8126 that allows a computing unit (e.g., health care provider computing unit 8106) that accesses the CVSP website to generate (e.g., print) a physical form (e.g., non-emergency medical transportation log sheet or pharmacy prescription label) that includes bar code(s) generated by bar code generator 8112 and optionally also includes area(s) for accepting one or more handwritten signatures from one or more clients who are receiving the health care product or service.

CVSP web server 8104 also includes a transaction data distributor 8128 and a report distributor 8130. Transaction data distributor 8128 distributes transaction data to health care provider computing unit 8106. Report distributor distributes exception reports that indicate potentially fraudulent health care claims to payer computing unit 8108.

The functionality of the components of CVSP web server are described in more detail relative to the claims verification process presented below relative to FIGS. 10A-10B.

Health care provider computing unit 8106 produces (e.g., prints) a form 8132 (a.k.a. bar code/signature form) that includes bar code(s) without any signature areas or bar code(s) and area(s) for signature(s), where each area for a signature is associated with a bar code. Health care provider computing unit 8106 includes a signature & transaction data extractor 8134 that utilizes scanning unit 8136 coupled to computing unit 8106 to scan form 8132 to extract the transaction data or the transaction data together with an associated signature provided by the client. The functionality of signature & transaction data extractor 8134 and scanning unit 8136 is described in more detail in the claims verification process presented below relative to FIGS. 10A-10B.

FIG. 9 is a block diagram of a signature verification and encrypted barcode system 9200 included in the system of FIG. 8, in accordance with embodiments of the present invention. Input to SVE 8114 includes scanned manifest logs 9204 (e.g., non-emergency medical transportation log sheets). In step 9206, SVE 8114 retrieves a scanned log document from scanned manifest logs 9204. SVE 8114 includes bar code decoder 9208 that decodes one or more bar codes included in the retrieved scanned log document. The decoding provided by bar code decoder 9208 looks up transaction data associated with a particular bar code via bar code lookup table 8124 (see FIG. 8). Signature cropping module 9210 identifies each area (a.k.a. signature area) of the retrieved scanned log document that includes a signature and a signature verification software application 9212 accesses each signature in the identified area(s). For each accessed signature, one or more reference signatures are retrieved in step 9214. Signature verification software 9212 compares each accessed signature to the accessed signature's one or more retrieved reference signatures and determines a scoring result 9218 that indicates whether or not the accessed signature matches any retrieved reference signature. If the accessed signature fails to match any retrieved reference signature, the accessed signature is invalid. If the accessed signature matches any retrieved reference signature, the accessed signature is valid. If the accessed signature is invalid, signature verification software 9212 provides (e.g., displays) a signature exception report 9220 for review to determine if the invalid signature indicates a fraudulent health care claim. The review of the exception report 9220 may modify scoring results 9218. For example, an operator reviewing exception report 9220 utilizes an external source to determine that the accessed signature is valid even though the initial scoring result 9218 indicates that the signature is invalid. In this example, scoring results are modified to reflect the operator's determination that the signature is valid. Scoring results 9218 are stored in a scoring results database 8122 in, for example, an Extensible Markup Language (XML) format. Signature variants indicated by the scoring results stored in database 8122 are used to update reference signature database 8120.

Signature verification software 9212 is, for example, SignWare® offered by Softpro GmbH located in Boeblingen, Germany.

FIGS. 10A-10B depict a flow diagram of a computer-implemented process for detecting and preventing fraudulent health care claims in the system of FIG. 8, in accordance with embodiments of the present invention. The fraudulent health care claim detection and prevention process begins at step 10300 of FIG. 10A. In step 10302, CVSP computing unit 8102 (see FIG. 8) receives information regarding a health care service or product being provided or sold to a client. In step 10304, CVSP computing unit 8102 (see FIG. 8) generates an encrypted bar code (e.g., a 2-D PDF417 bar code) that includes transaction data relevant to the health care service or product being provided or sold to the client. The transaction data includes the date of the transaction, the time of the transaction, an identification of the client (e.g., CIN), and details of the service or product to be provided. For example, if the transaction is filling a prescription, the details of the service include prescription number, drug name and quantity. If the transaction is providing non-emergency medical transportation, the details of the service include, for example, trip number, and an indication of whether the client is ambulatory or whether the client needs a wheelchair. If the transaction is providing home health care, the details of the service include, for example, an indication of whether the client needs assistance with medication. In one embodiment, the encrypted bar code contains a representation of a unique identifier for a log form sheet that displays the bar code. In another embodiment, one or more transaction data items included in the bar code are also printed on a log form sheet adjacent to a signature area (e.g., a signature line for accepting the client's handwritten signature).

The encrypted bar code generated in step 10304 protects the privacy of the client's health information according to governmental regulations. In one embodiment, the encrypted bar code is HIPAA-compliant. In another embodiment, the encrypted bar code prevents disclosure of the client's Medicaid CIN or other identifying information. Further, embedded in the encrypted bar code are the transaction date, an identification of the transaction and client-specific information that can only be accessed via lookup table 8124 (see FIG. 8), thereby preventing the reuse of the barcode for more than one transaction or for a substitute transaction. In step 10306, CVSP computing unit 8102 (see FIG. 8) transmits the encrypted bar code and relevant transaction data to health care provider computing unit 8106 (see FIG. 8).

In step 10308, health care provider 8106 generates either (1) a log form sheet having (i) one or more areas (a.k.a. signature areas) for accepting one or more handwritten signatures from the client and (ii) one or more encrypted bar codes corresponding to each signature area or (2) a form or label having one or more encrypted bar codes corresponding to a biometric signature provided by the client. In one embodiment, step 10308 generates a log form sheet having multiple signature boxes associated in a one-to-one correspondence with multiple encrypted bar codes.

In step 10310, the health care provider or a designated delegate of the health care provider uses scanning unit 8136 (see FIG. 8) to scan the log form sheet, label or form generated in step 10308 to a computer file format (e.g., Tagged Image File Format (TIFF)) that is identified with a date/time stamp. In step 10310, health care provider computing unit 8106 (see FIG. 8) stores the scanned sheet, label or form in a computer file system.

In step 10312, signature & transaction data extractor 8134 (see FIG. 8) extracts the transaction data stored in the bar code included in the sheet, label or form generated in step 10308. If the sheet, label or form includes a scanned signature associated with the bar code, the signature & transaction data extractor also extracts the scanned signature. If the sheet, label or form does not include a scanned signature, then the client provides a biometric signature (e.g., signs a graphics tablet that digitizes the client's signature) that is associated with the extracted transaction data. Health care provider computing unit 8106 (see FIG. 8) uploads the extracted transaction data and the signature associated with the transaction data to the CVSP website provided by CVSP web server 8104 (see FIG. 8), wherein the extracted transaction data is correlated with the signature and with the health care provider.

As one example, consider a request for non-emergency medical transportation from a Mary Smith where there are several hundred Mary Smiths who receive Medicaid in New York State. Scanning and reading the encrypted bar code and maintaining the correlation with a particular signature provides assurance that the Mary Smith who provided the signature described relative to step 10308 is the Mary Smith who was authorized to receive the requested non-emergency medical transportation from a particular vendor to a particular place on a particular date and at a particular time.

In step 10314, SVE 8114 receives the extracted transaction data and the associated signature. In step 10316, signature verification software 9212 (see FIG. 9) receives the signature extracted or provided in step 10312 while maintaining the integrity of the correlation between the signature and the extracted transaction data. In step 10318, signature verification software 9212 (see FIG. 9) retrieves one or more reference signatures from reference signature database 8120 (see FIG. 8). The fraud detection and prevention process continues with step 10320 of FIG. 10B.

In step 10320 of FIG. 10B, signature verification software 9212 (see FIG. 9) compares the signature extracted or provided in step 10312 to the reference signature(s) retrieved in step 10318 and determines a score indicating that the signature is a verified signature or a suspected fraudulent signature. A signature is verified if the score in step 10320 indicates a match between the signature and any of the one or more retrieved reference signatures. A signature is suspected to be fraudulent if the score in step 10320 indicates no match between the signature and any of the one or more retrieved reference signatures. In step 10322, SVE 8114 (see FIG. 8) stores the score determined in step 10320 in scoring results database 8122 (see FIG. 8).

If there is no reference signature for the signature being processed in step 10320, then signature verification software 9212 (see FIG. 9) stores the first signature processed in step 10320 as the reference signature for the client.

In step 10324, SVE 8114 (see FIG. 8) determines whether or not the score determined in step 10320 indicates that the signature is fraudulent. If the score indicates the signature is a suspected fraudulent signature, SVE 8114 (see FIG. 8) generates a computer file (e.g., low resolution Portable Document Format (PDF) file) of a form that includes the suspected fraudulent signature. In step 10326, report generator 8116 (see FIG. 8) receives the computer file generated in step 10324 that includes the suspected fraudulent signature. In step 10328, report generator 8116 (see FIG. 8) generates an exception report that includes any suspected fraudulent signatures identified by SVE 8114 (see FIG. 8). In step 10330, CVSP web server 8104 receives and distributes the exception report generated in step 10328 to payer computing unit 8108 (see FIG. 8) via the CVSP website. The exception report is placed in a secure queue by date and title for web-based access and printing. Users receive email notification when a new exception report is in the queue. The fraudulent health care claim detection process ends at step 10332.

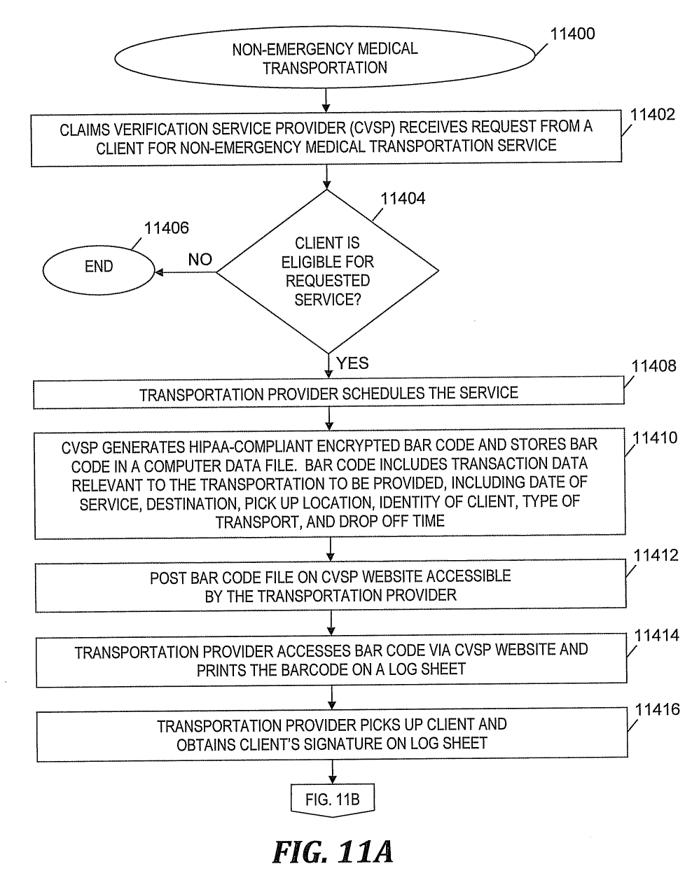

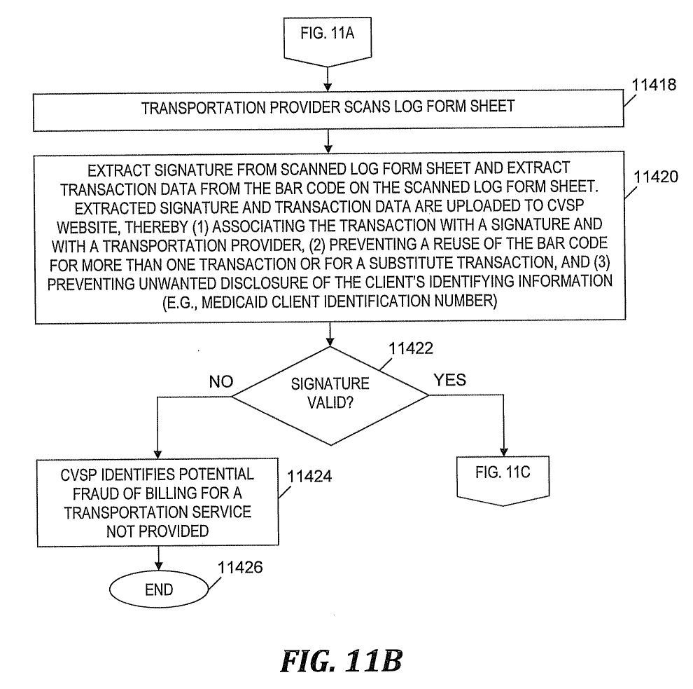

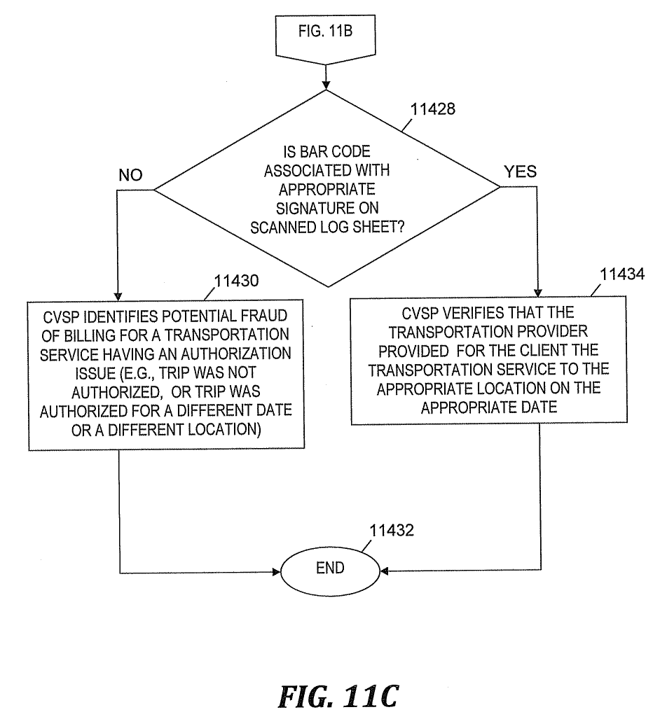

FIGS. 11A-11C depict a flow diagram of a computer-implemented process for detecting a fraudulent health care claim associated with non-emergency medical transportation, in accordance with embodiments of the present invention. The non-emergency medical transportation fraud detection process begins at step 11400 of FIG. 11A. In step 11402, CVSP computing unit 8102 (see FIG. 8) receives a request from a client for a non-emergency medical transportation service. In inquiry step 11404, CVSP computing unit 8102 (see FIG. 8) accesses eligibility database 8118 (see FIG. 8) to determine if the client is eligible for the requested transportation service (e.g., checks the client's Medicaid eligibility). If step 11404 determines that the client is not eligible for the requested service, the fraudulent medical transportation claim detection process ends at step 11406. If step 11404 determines that the client is eligible for the requested service, then in step 11408 the transportation provider schedules the non-emergency medical transportation service. In step 11410, bar code generator 8112 (see FIG. 8) generates an encrypted bar code that complies with health information privacy regulations of a governmental entity (e.g., Health Insurance Portability and Accountability Act (HIPAA) of 1996). The generated bar code is stored in a computer data file in step 11410. The bar code includes transaction data relevant to the non-emergency medical transportation to be provided to the client, including the date of service, destination, pick up location, identity of the client, type of transport, and drop off time. Types of transport include, for example, curb to curb, door to door, wheelchair, and stretcher.

In step 11412, the bar code file generated in step 11410 is posted on the CVSP website provided by CVSP web server 8104 (see FIG. 8). In one embodiment, the CVSP website is a secure website that is HIPAA-compliant. In step 11414, the transportation provider computing unit 8106 (see FIG. 8) accesses the bar code via the CVSP website. In step 11416, the transportation provider picks up the client at the pick up location and obtains the client's handwritten signature on the log form sheet. The fraudulent medical transportation claim detection process continues with the steps of FIG. 11B.

In step 11418 of FIG. 11B, the transportation provider uses scanning unit 8136 (see FIG. 8) to scan the log form sheet that includes the client's handwritten signature and the bar code associated with the client's signature. In step 11420, signature & transaction data extractor 8134 (see FIG. 8) extracts the signature from the scanned log form sheet and extracts the transaction data from the scanned bar code. Step 11420 also includes the health care provider computing unit 8106 uploading the extracted client signature and transaction data to the CVSP website provided by CVSP web server 8104 (see FIG. 8), thereby (1) associating the non-emergency medical transportation transaction with the scanned handwritten signature and with the transportation provider; (2) preventing a reuse of the bar code for more than one transaction or for a substitute transaction, and (3) preventing unwanted disclosure of the client's identifying information (e.g., Medicaid Client Identification Number).

In response to performing steps 10314-10322 of FIGS. 10A-10B subsequent to step 11420, SVE 8114 (see FIG. 8) determines in step 11422 whether the extracted signature is valid or not based on the score determined in step 10320 of FIG. 10B. If the extracted signature is determined to be not valid at step 11422, then in step 11424 SVE 8114 (see FIG. 8) identifies a potential fraud of billing for a non-emergency medical transportation service that is not provided, and the fraudulent claim detection process for non-emergency medical transportation ends at step 11426. If step 11422 determines that the signature is valid, then the fraudulent claim detection process for non-emergency medical transportation continues with the steps of FIG. 11C.

If SVE 8114 (see FIG. 8) determines in inquiry step 11428 of FIG. 11C that the bar code generated in step 11410 is not associated with the appropriate signature on the scanned log form sheet, then in step 11430 SVE 8114 (see FIG. 8) identifies a potential fraud of billing for a non-emergency medical transportation service having an authorization issue. For example, the trip being provided to the client was not authorized or the trip was authorized for a date or location that is different from the date or location in the transaction data. Following step 11430, the fraud detection process of FIGS. 11A-11C ends at step 11432.

Returning to step 11428, if SVE 8114 (see FIG. 8) determines that the bar code generated in step 11410 is associated with the appropriate signature on the scanned log form sheet, then in step 11434 SVE 8114 (see FIG. 8) verifies that the transportation provider provided for the client the non-emergency medical transportation service to the appropriate location on the appropriate date. Following step 11434, the fraud detection process of FIGS. 11A-11C ends at step 11432.

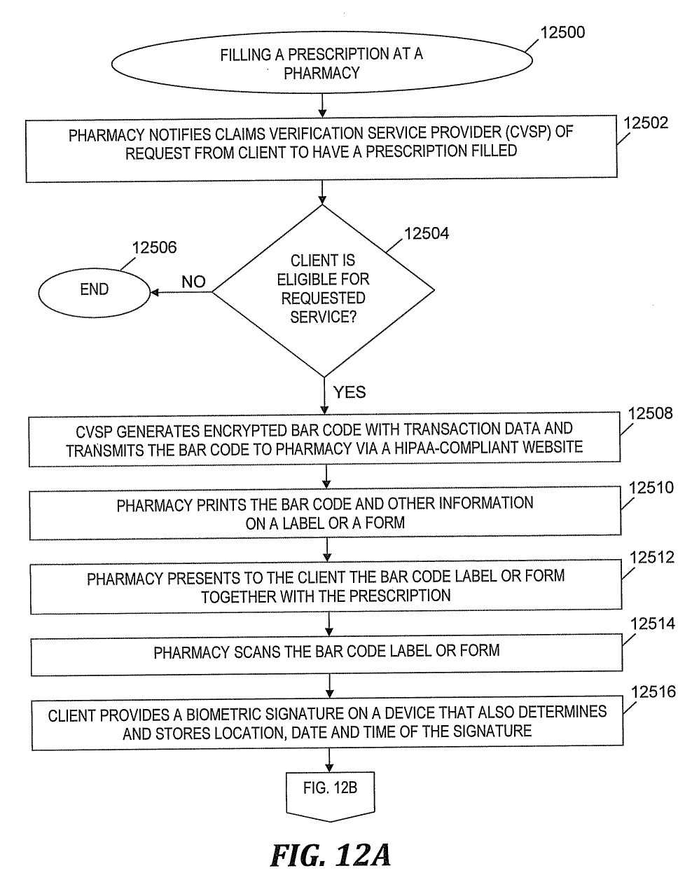

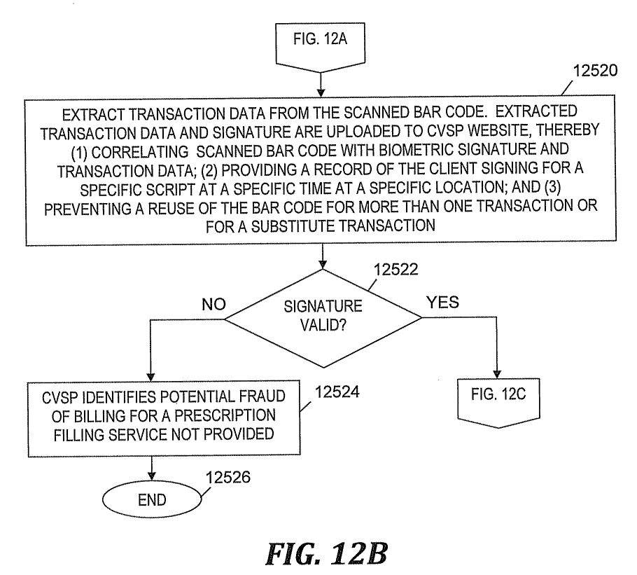

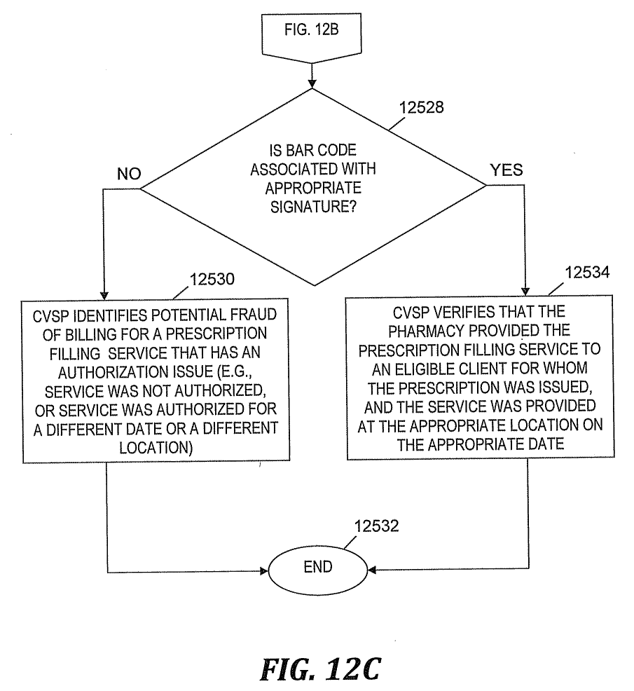

FIGS. 12A-12C depict a flow diagram of a computer-implemented process for detecting a fraudulent health care claim associated with filling a prescription at a pharmacy, in accordance with embodiments of the present invention. The fraud detection process of FIGS. 12A-12C begins at step 12500. In step 12502, the pharmacy notifies the CVSP of a request from a client to have a prescription filled. In inquiry step 12504, CVSP computing unit 8102 (see FIG. 8) accesses eligibility database 8118 (see FIG. 8) to determine if the client is eligible for the requested prescription filling service (e.g., checks the client's Medicaid eligibility). If step 12504 determines that the client is not eligible for the requested prescription filling service, then the fraud detection process for prescription claims ends at step 12506. If step 12504 determines that the client is eligible for the requested prescription filling service, then in step 12508 bar code generator 8112 (see FIG. 8) generates an encrypted bar code that includes transaction data relevant to the prescription filling request and transmits the bar code to a computing unit 8106 (see FIG. 8) of the pharmacy via a HIPAA-compliant website (i.e., the CVSP website).

In step 12510, computing unit 8106 (see FIG. 8) prints the bar code and other information on a label or a form 8132 (see FIG. 8). In step 12512, the pharmacy presents to the client the label or form printed in step 12510 together with the filled prescription. In step 12514, the pharmacy scans the label or form 8132 (see FIG. 8) that includes the bar code generated in step 12508. In step 12516, the client provides a biometric signature on a device that also determines and stores the location, date and time associated with providing the biometric signature. Providing a biometric signature includes, for example, signing the client's name on a digital pen pad device (a.k.a. graphics tablet, digitizer tablet and pen tablet). The location associated with providing the biometric signature is the location of the device when the device accepts the biometric signature and is provided by, for example, a Global Positioning System (GPS) incorporated in or coupled to the digital pen pad device. The date and time associated with providing the biometric signature are provided by, for example, a clock internal to the device that accepts the biometric signature. Following step 12516, the fraud detection process for prescription filling services continues in FIG. 12B.

In step 12520 of FIG. 12B, SVE 8114 (see FIG. 8) extracts transaction data from the scanned bar code. The extracted transaction data and the biometric signature provided in step 12516 are uploaded in step 12520 to the CVSP website provided by CVSP web server 8104 (see FIG. 8), thereby (1) correlating the scanned bar code with the biometric signature and the transaction data; (2) providing a record of the client signing for a specific script at a specific time and at a specific location; and (3) preventing a reuse of the bar code for more than one transaction or for a substitute transaction.

In response to performing steps 10314-10322 of FIGS. 10A-10B subsequent to step 12520, SVE 8114 (see FIG. 8) determines in step 12522 whether the provided biometric signature is valid or not based on the score determined in step 10320 of FIG. 10B. If the biometric signature is determined to be not valid at step 12522, then in step 12524 SVE 8114 (see FIG. 8) identifies a potential fraud of billing for a prescription filling service that is not provided, and the fraudulent claim detection process for prescription filling services ends at step 12526. If step 12522 determines that the biometric signature is valid, then the fraudulent claim detection process for prescription filling services continues with the steps of FIG. 12C.

If SVE 8114 (see FIG. 8) determines in inquiry step 12528 of FIG. 12C that the bar code generated in step 12508 is not associated with an appropriate biometric signature, then in step 12530 SVE 8114 (see FIG. 8) identifies a potential fraud of billing for a prescription filling service having an authorization issue. For example, the prescription filling service was not authorized or was authorized for a date or location that is different from the date or location included in the transaction data. Following step 12530, the fraud detection process of FIGS. 12A-12C ends at step 12532.

Returning to step 12528, if SVE 8114 (see FIG. 8) determines that the bar code generated in step 12508 is associated with an appropriate biometric signature, then in step 12534 SVE 8114 (see FIG. 8) verifies that the pharmacy provided the prescription filling service to an eligible client for whom the prescription was issued, and the prescription was filled at the appropriate location and on the appropriate date. Following step 12534, the fraud detection process of FIGS. 12A-12C ends at step 12532.

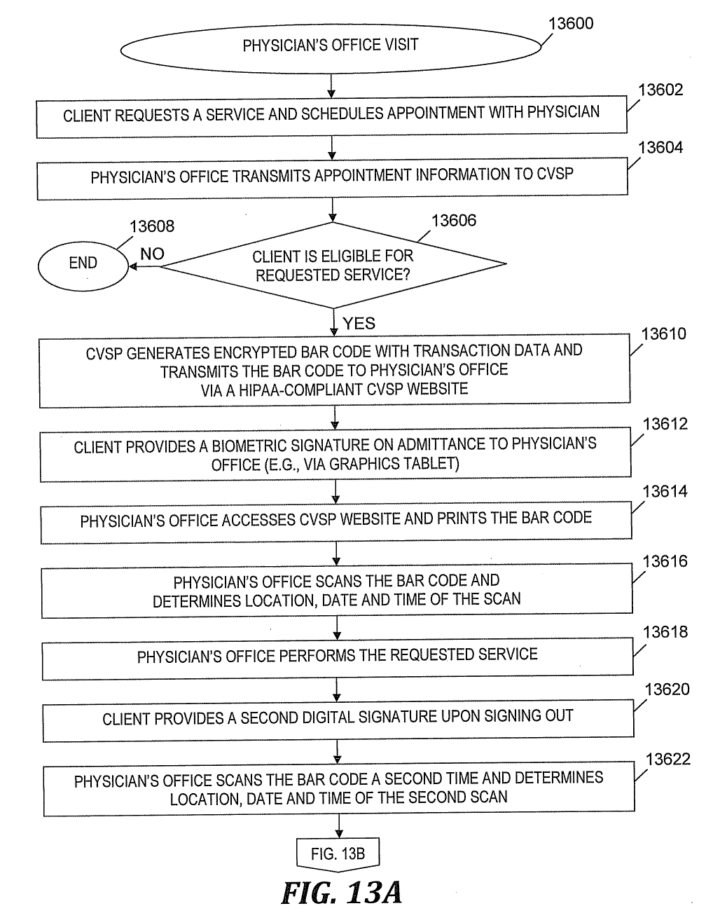

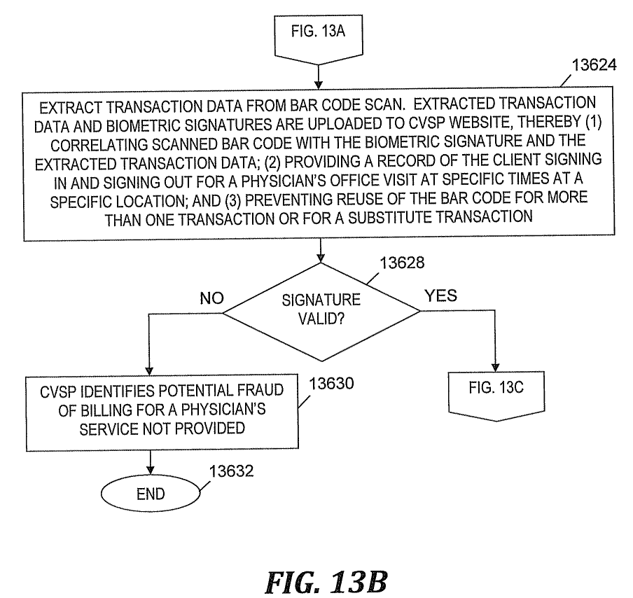

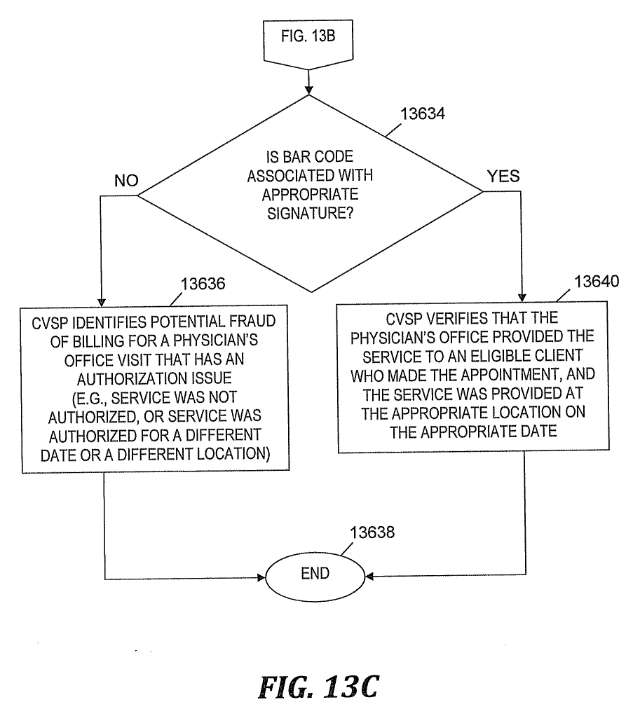

FIGS. 13A-13C depict a flow diagram of a computer-implemented process for detecting a fraudulent health care claim associated with a visit to a physician's office, in accordance with embodiments of the present invention. The fraud detection process of FIGS. 13A-13C begins at step 13600. In step 13602, a client requests a service and schedules an appointment with a physician. In step 13604, the physician's office transmits the information relative to the appointment scheduled in step 13602 to CVSP computing unit 8102 (see FIG. 8). In inquiry step 13606, CVSP computing unit 8102 (see FIG. 8) accesses eligibility database 8118 (see FIG. 8) to determine if the client is eligible for the service requested in step 13602 (e.g., checks the client's Medicaid eligibility). If step 13606 determines that the client is not eligible for the requested service, then the fraud detection process for a physician's office visit ends at step 13608. If step 13606 determines that the client is eligible for the requested service, then in step 13610 bar code generator 8112 (see FIG. 8) generates an encrypted bar code that includes transaction data relevant to the service request and transmits the bar code to a computing unit 8106 (see FIG. 8) of the physician's office via a HIPAA-compliant website (i.e., the CVSP website).

In step 13612, the client provides a first biometric signature upon admittance to the physician's office (e.g., provides a signature via a graphics tablet). In step 13614, computing unit 8106 (see FIG. 8) accesses the CVSP website and prints the bar code generated in step 13610 along with other information on a label or a form 8132 (see FIG. 8). In step 13616, a representative of the physician's office scans the label or form 8132 (see FIG. 8) with scanning unit 8136 (see FIG. 8). The scanning unit also determines and stores the location, date and time associated with the provision of the biometric signature. The location associated with providing the biometric signature is provided by, for example, a GPS device. In step 13618, the physician's office provides the service requested in step 13602. In step 13620, the client provides a second biometric signature upon signing out of the physician's office. In step 13622, a representative of the physician's office scans the bar code a second time using the scanning unit 8136 (see FIG. 8), which also determines the location, date and time of the second scan. Following step 13622, the fraud detection process for services associated with a physician's office visit continues with the steps of FIG. 6B.

In step 13624 of FIG. 6B, SVE 8114 (see FIG. 8) extracts transaction data from the either of the two bar code scans (see steps 13616 and 13622). The extracted transaction data and the biometric signatures provided in steps 13612 and 13620 are uploaded in step 13624 to the CVSP website provided by CVSP web server 8104 (see FIG. 8), thereby (1) correlating the scanned bar code with the biometric signatures and with the extracted transaction data; (2) providing a record of the client signing in and signing out for a physician's office visit at specific times and at a specific location; and (3) preventing a reuse of the bar code for more than one transaction or for a substitute transaction.

In response to performing steps 10314-10322 of FIGS. 10A-10B subsequent to step 13624, SVE 8114 (see FIG. 8) determines in step 13628 whether the provided biometric signature is valid or not based on the score determined in step 10320 of FIG. 10B. If the biometric signature is determined to be not valid at step 13628, then in step 13630 SVE 8114 (see FIG. 8) identifies a potential fraud of billing for a physician service that is not provided, and the fraudulent claim detection process for a physician's office visit ends at step 13632. If step 13628 determines that the biometric signature is valid, then the fraudulent claim detection process for a physician's office visit continues with the steps of FIG. 13C.

If SVE 8114 (see FIG. 8) determines in inquiry step 13634 of FIG. 13C that the bar code generated in step 13610 is not associated with an appropriate biometric signature, then in step 13636 SVE 8114 (see FIG. 8) identifies a potential fraud of billing for a physician's office visit that has an authorization issue. For example, the physician's office visit was not authorized or was authorized for a date or location that is different from the date or location included in the transaction data. Following step 13636, the fraud detection process of FIGS. 13A-13C ends at step 13638.

Returning to step 13634, if SVE 8114 (see FIG. 8) determines that the bar code generated in step 13610 is associated with an appropriate biometric signature, then in step 13640 SVE 8114 (see FIG. 8) verifies that the physician's office provided the service to an eligible client for whom the appointment was made, and the service was provided at the appropriate location and on the appropriate date. Following step 13640, the fraud detection process of FIGS. 13A-13C ends at step 13638.

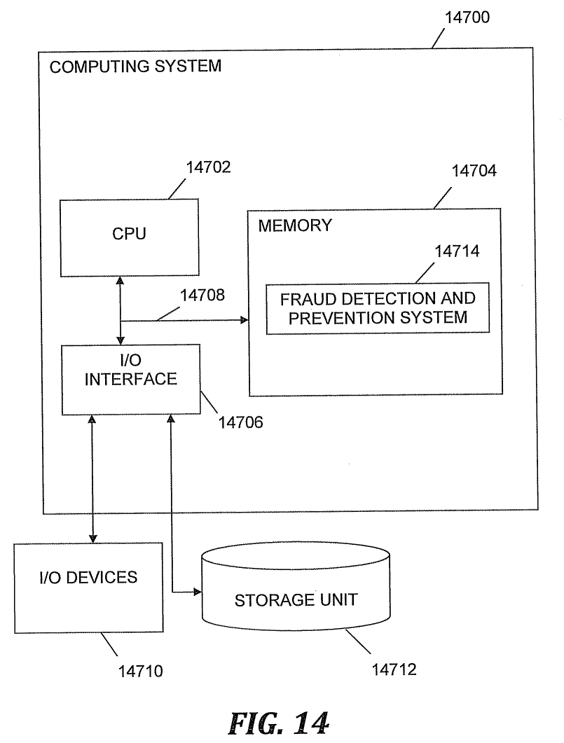

FIG. 14 is a block diagram of a computing system that implements the process of FIGS. 10A-10B, in accordance with embodiments of the present invention. Computing system 14700 generally comprises a central processing unit (CPU) 14702, a memory 14704, an input/output (I/O) interface 14706, a bus 14708, I/O devices 14710 and a storage unit 14712. Computing system 14700 includes one or more of computing units 8102, 8104 and 8106 shown in FIG. 8. CPU 14702 performs computation and control functions of computing system 14700. CPU 14702 may comprise a single processing unit, or be distributed across one or more processing units in one or more locations (e.g., on a client and server).

Memory 14704 may comprise any known type of data storage and/or transmission media, including bulk storage, magnetic media, optical media, random access memory (RAM), read-only memory (ROM), a data cache, a data object, etc. Cache memory elements of memory 14704 provide temporary storage of at least some program code in order to reduce the number of times code must be retrieved from bulk storage during execution. Storage unit 14712 is, for example, a magnetic disk drive or an optical disk drive that stores data such as one or more of the following collections of data shown in FIG. 8: eligibility database 8118, reference signature database 8120, scoring results database 8122, and bar code lookup table 8124. Moreover, similar to CPU 14702, memory 14704 may reside at a single physical location, comprising one or more types of data storage, or be distributed across a plurality of physical systems in various forms. Further, memory 14704 can include data distributed across, for example, a LAN, WAN or storage area network (SAN) (not shown).

I/O interface 14706 comprises any system for exchanging information to or from an external source. I/O devices 14710 comprise any known type of external device, including a display monitor, keyboard, mouse, printer, speakers, handheld device, printer, facsimile, etc. Bus 14708 provides a communication link between each of the components in computing system 14700, and may comprise any type of transmission link, including electrical, optical, wireless, etc.

I/O interface 14706 also allows computing system 14700 to store and retrieve information (e.g., program instructions or data) from an auxiliary storage device (e.g., storage unit 14712). The auxiliary storage device may be a non-volatile storage device (e.g., a CD-ROM drive which receives a CD-ROM disk). Computing system 14700 can store and retrieve information from other auxiliary storage devices (not shown), which can include a direct access storage device (DASD) (e.g., hard disk or floppy diskette), a magneto-optical disk drive, a tape drive, or a wireless communication device.

Memory 14704 includes computer program code 14714 that provides the logic for the health care claim fraud detection and prevention method and system disclosed herein. Further, memory 14704 may include other systems not shown in FIG. 14, such as an operating system (e.g., Linux) that runs on CPU 14702 and provides control of various components within and/or connected to computing system 14700.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code 14714 for use by or in connection with a computing system 14700 or any instruction execution system to provide and facilitate the capabilities of the present invention. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, RAM 14704, ROM, a rigid magnetic disk and an optical disk. Current examples of optical disks include compact disk-read-only memory (CD-ROM), compact disk—read/write (CD-R/W) and DVD.

The flow diagrams depicted herein are provided by way of example. There may be variations to these diagrams or the steps (or operations) described herein without departing from the spirit of the invention. For instance, in certain cases, the steps may be performed in differing order, or steps may be added, deleted or modified. All of these variations are considered a part of the present invention as recited in the appended claims.

### Mobile Device Enhancement

The present invention may provide a mobile device-based system, method and computer program product for verifying a claim for a payment for a health care service (e.g., a medical transportation service such as a non-emergency medical transportation service). Instead of consulting a paper manifest to view health care transaction information and instead of using a paper-based signature form to collect client signatures, a health care service provider may use a mobile device to view the transaction information and collect client signatures. Furthermore, the mobile device obtains, stores and transmits the transaction information and signatures to support claim verification without requiring a step of faxing or scanning paper-based forms.

As used herein, a mobile device is defined as a computing, communications, multifunction or digital electronic device that is handheld, portable or mounted in a vehicle, downloads and uploads data via a wireless computer network, and receives a digital image of a signature that is hand-drawn on a computer input device such as a touchscreen display, graphics tablet, digitizing tablet, graphics pad, drawing tablet, or graphics tablet-screen hybrid, where the computer input device is part of, or operatively coupled to, the mobile device. Examples of a mobile device include, but are not limited to, an iPod Touch® and an iPhone® offered by Apple, Inc. located in Cupertino, Calif.

The wireless computer network via which a mobile device downloads and uploads data may be a wireless telecommunications network or a mobile phone network. Examples of the aforementioned wireless computer network include networks based on: (1) an Institute of Electrical and Electronics Engineers (IEEE) standard for wireless local area network communications (a.k.a. IEEE 802.11 standard) (e.g., Wi-Fi® or Wireless LAN (WLAN)), (2) an IEEE standard for wireless metropolitan area networks (i.e., IEEE 802.16 standard) (e.g., WiMAX), (3) the Global System for Mobile Communications (GSM) standard, and (4) GSM enhanced with General Packet Radio Service (GPRS).

### Mobile Device-Enhanced Claim Verification System

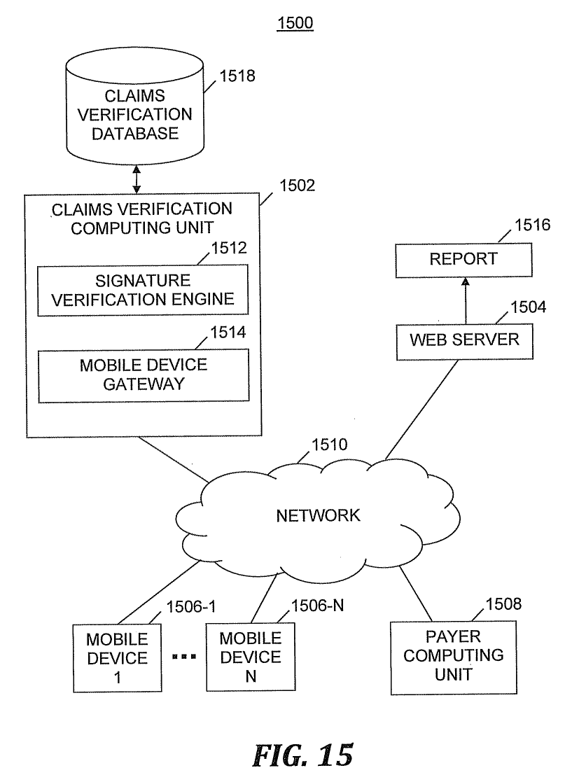

FIG. 15 is a block diagram of a mobile device-enhanced system for verifying claims for medical transportation, in accordance with embodiments of the present invention. System 1500 includes a claims verification computing unit 1502, a claims verification web server 1504, and a plurality of mobile device 1506-1, . . . , 1506-N, and may also include a payer computing unit 1508. Claims verification computing unit 1502 may be utilized and controlled by a claims verification service provider. Mobile devices 1506-1, . . . , 1506-N are utilized by non-emergency medical transportation providers (e.g., drivers of vehicles that provide non-emergency medical transportation services) or agents thereof. Mobile devices 1506-1, . . . , 1506-N are controlled by a non-emergency medical transportation provider or broker. Payer computing unit 1508 is utilized and controlled by a payer entity (e.g., an insurer) or an agent thereof. Web server 1504 is a web server utilized by the claims verification service provider, the non-emergency medical transportation provider, and/or the non-emergency medical transportation broker. Web server 1504 may be controlled by the claims verification service provider or a third party entity. Via a network 1510 (e.g., the Internet), computing units 1502 and 1508, and mobile devices 1506-1, 11506-N access a claims verification website (a.k.a. CV website) controlled by the claims verification service provider or a third party entity.

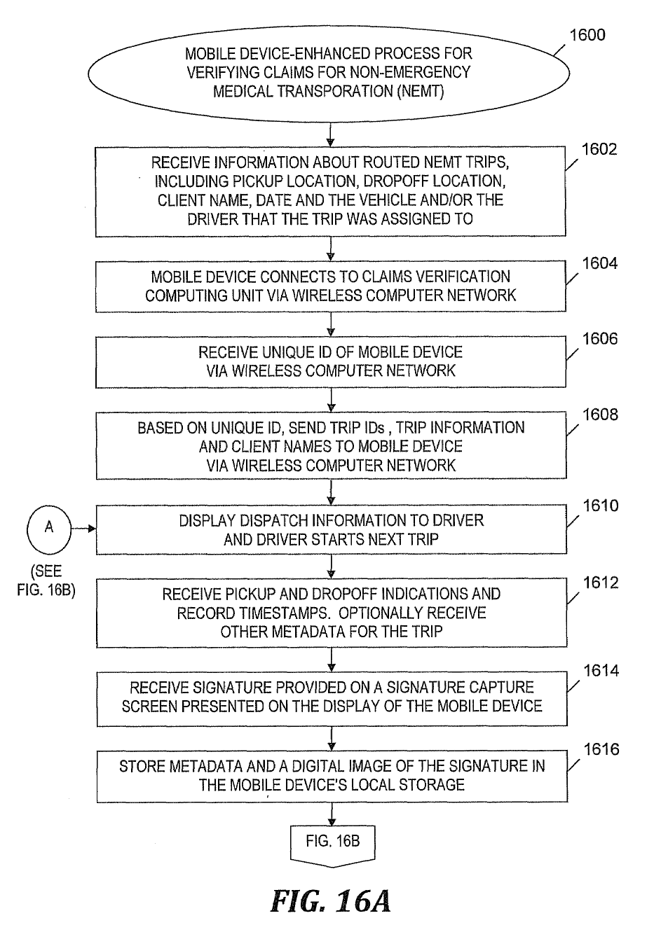

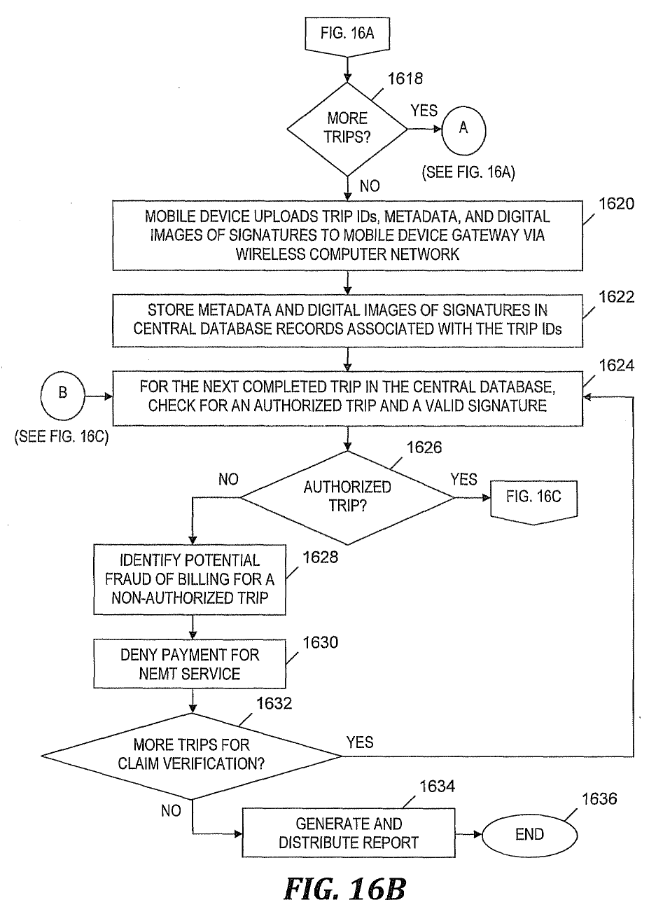

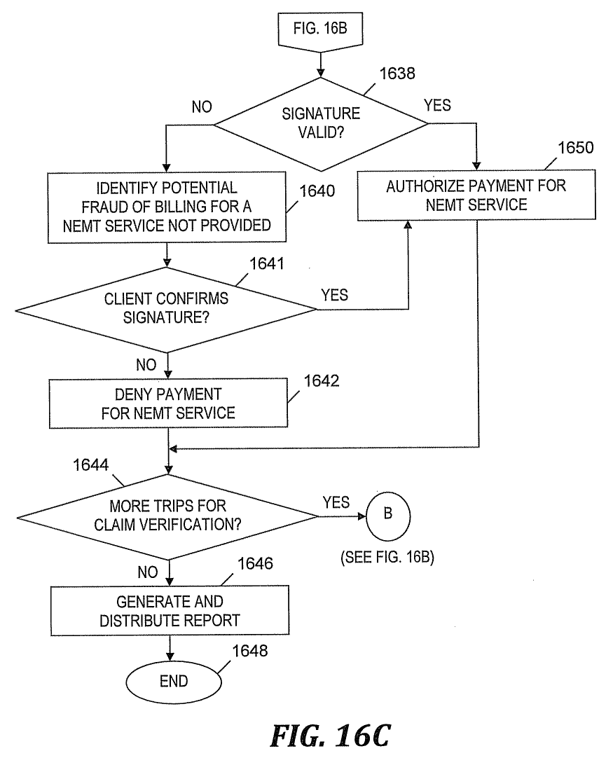

Each mobile device (e.g., mobile device 1506-1) included in system 1500 includes a display device (a.k.a. display) (not shown) and a local data storage unit (not shown), which are operatively coupled thereto. An input component that receives a biometric signature of a client is operatively coupled to each mobile device in system 1500. In one embodiment, the input component is the display device operatively coupled to the mobile device (e.g., a touchscreen of the mobile device). Each mobile device also includes a processor (not shown) and a memory (not shown) for executing instructions stored in the memory to perform uploading and downloading of data via a wireless computer network (see step 1608 in FIG. 16A and step 1620 in FIG. 16B), displaying screens including a dispatch interface and a signature capture screen (see steps 1610 and 1614 in FIG. 16A), and storing metadata and digital images that include signatures in the local data storage unit (see step 1616 in FIG. 16A).

Each mobile device (e.g., mobile device 1506-1) included in system 1500 includes software (not shown) that uploads data to and downloads data from computing unit 1502, stores data in the local data storage unit of the mobile device, and displays a interface of dispatch information on the display of the mobile device, where the interface includes information about trips scheduled to provide NEMT services.

In one embodiment, each mobile device (e.g., mobile device 1506-1) includes software that switches the display of the mobile device between the interface of dispatch information and a form that receives a biometric signature (e.g., a screen that receives a signature hand-drawn by a client using a stylus in contact with the display of the mobile device). The switch between the interface of dispatch information and the form that receives the biometric signature may be performed, for example, in response to a user activating a graphics element on the display of the mobile device.

Claims verification computing unit 1502 includes a software-based signature verification engine (SVE) 1512 and a software-based mobile device gateway 1514. Mobile device gateway 1514 is a module or service that communicates with mobile devices 1506-1, . . . , 1506-N to download data to mobile devices 1506-1, . . . , 1506-N and receive data uploaded from mobile devices 1506-1, . . . , 1506-N. In one embodiment, mobile device gateway 1514 downloads routed trips (e.g., trip identifiers (IDs), client names, pickup and drop-off locations, and scheduled pickup and drop-off times) to each mobile device (e.g., mobile device 1506-1) and receives trip information from each mobile device, where the trip information includes completed trips (e.g., trip ID and timestamps indicating the date of the non-emergency transportation service and the actual pickup and drop-off times) and digital images of the signatures of clients that were collected for the completed trips. Furthermore, mobile device gateway 1514 sends the digital images of the collected signatures to signature verification engine 1512 to be verified. The digital images of the signatures are the same type of data that the signature verification engine 114 (see FIG. 1) receives from the form 132 (see FIG. 1) via fax machine 136 (see FIG. 1).

Web server 1504 distributes a report 1516 that is generated by claims verification computing unit 1502. Report 1516 includes indications of one or more fraudulent or potentially fraudulent health care claims for payments for NEMT services and/or one or more verifications of health care claims for payments for NEMT services.

Mobile device gateway 1514 or another software component of computing unit 1502 stores the trip information received from the mobile device (e.g., mobile device 1506-1) in a claims verification database 1518. Claims verification database 1518 is included in one or more storage units (not shown) coupled to computing unit 1502. Claims verification database 1518 includes information about clients (i.e., patients for whom non-emergency medical transportation is requested), non-emergency medical transportation providers, payers (e.g., insurers), routed trips for providing non-emergency medical transportation services, reference signatures to be compared against signatures collected from clients, and results of scoring a comparison between collected signatures and reference signatures. Data that determines whether a client is eligible to receive a payment from a payer for non-emergency medical transportation is also stored in database 1518. The aforementioned information in database 1518 is stored, for example, in relational database tables. In another embodiment, one or more other databases (not shown) may store the aforementioned information about clients, client eligibility to receive payment, non-emergency medical transportation providers, routed trips, reference signatures, and scoring results.

SVE 1512 receives digital images of signatures collected from clients who receive non-emergency medical transportation services and compares each of the received digital images of signatures to one or more reference signatures stored in database 1518 to generate a score used to detect whether or not a fraudulent claim for payment for a non-emergency medical transportation service is being made.

In one embodiment, claims verification computing unit 1502 includes a report generator (not shown) that provides the functionality of report generator 116 (see FIG. 1) and web server 1504 includes a software-based MMIS integration unit, a transaction data distributor, and a report distributor that provide the functionality of MMIS integration unit 127 (see FIG. 1), transaction data distributor 128 (see FIG. 1) and report distributor 130 (see FIG. 1), respectively.

In one embodiment, claims verification computing unit 1502 is CVSP computing unit 102 (see FIG. 1), claims verification database 1518 is database 118 (see FIG. 1), web server 1504 is CVSP web server 104 (see FIG. 1), report 1516 is exception report 131 (see FIG. 1), network 1510 is network 110 (see FIG. 1), and payer computing unit 1508 is payer computing unit 108 (see FIG. 1). In the embodiment described in this paragraph, system 1500 is extended to include a health care provider computing unit, a bar code/signature form, and a scanning unit (e.g., fax machine) that have the configuration of, and provide the functionality of, the health care provider computing unit 106 (see FIG. 1), bar code/signature form 132 (see FIG. 1), and scanning unit 136 (see FIG. 1), respectively.

Although system 1500 is described above relative to the provision of non-emergency medical transportation services, the present invention contemplates variations of system 1500 that provide any type of medical transportation service.

### Mobile Device-Enhanced Claim Verification Process

FIGS. 16A-16C depict a flow diagram of a process implemented by the mobile device-enhanced system of FIG. 15, in accordance with embodiments of the present invention. The mobile device-enhanced process for verifying claims for non-emergency medical transportation begins at step 1600 of FIG. 16A. Prior to step 1602, computing unit 1502 (see FIG. 15) receives one or more requests for NEMT services. For example, a request is received that requests a NEMT service that includes transporting a client in a trip form a first location (i.e., a pickup location) to a second location (i.e., a drop-off location) on a date. Each request for a NEMT service is assigned a driver and/or a vehicle that is scheduled to provide the NEMT service prior to step 1602. In step 1602, claims verification computing unit 1502 (see FIG. 15) receives information (a.k.a. routed trip information) about routed non-emergency medical transportation (NEMT) trips. The information received about each NEMT trip includes a pickup location, scheduled pickup time, drop-off location, scheduled drop-off time, a service date, a name of a client, and an identification of a vehicle and/or an identification of a driver to which the trip is assigned. The client is the patient for whom a NEMT service is requested. The pickup location is, for example, an address where the client is to be picked up by a vehicle providing the NEMT service. The drop-off location is, for example, an address where the client is to be dropped off by a vehicle providing the NEMT service. The service date is the date for which the routed NEMT trip is scheduled. The claims verification computing unit may receive the routed trip information in step 1602 via a scheduling system that automatically pushes the routed trip information on a scheduled basis (e.g., via a web service) or from an upload of a computer file. Computing unit 1502 (see FIG. 15) or another computing unit assigns unique trip identifiers (trip IDs) to the NEMT trips whose information is received in step 1602.

After step 1602, a driver of a vehicle that provides a NEMT service picks up a mobile device. The mobile device is powered on. In step 1604, a powered-on mobile device (e.g., mobile device 1506-1 in FIG. 15) connects to claims verification computing unit 1502 (see FIG. 15) via a wireless computer network. Hereinafter, relative to the discussion of FIGS. 16A-16C, the mobile device that connects to computing unit 1502 (see FIG. 15) in step 1604 is referred to as “the mobile device.” In one embodiment, a connection “via the wireless computer network” in step 1604 may be a connection from the mobile device to the claims verification computing unit 1502 (see FIG. 15) via a series of networks (e.g., via the wireless computer network, a local network serving the claims verification computing unit, and the Internet).

In step 1606, claims verification computing unit 1502 (see FIG. 15) receives a unique identifier (ID) of the mobile device via the wireless computer network in response to the connection made in step 1604. In one embodiment, the unique ID is sent by mobile device to the claims verification computing unit via a series of networks (e.g., via the wireless computer network, a local network serving the claims verification computing unit, and the Internet).

In step 1608, based on the unique ID received in step 1606, claims verification computing unit 1502 (see FIG. 15) sends trip IDs, names of clients (a.k.a. client names), and trip information to the mobile device via the wireless computer network. In one embodiment, the trip IDs and trip information in step 1608 are sent via a series of networks (e.g., via the Internet, a local network serving the claims verification computing unit, and the wireless computer network). The trip information sent in step 1608 includes the dispatch information a driver needs to know to conduct her or his route (e.g., client names, pickup locations, scheduled pickup times, drop-off locations, scheduled drop-off times, and special information about the client (e.g., age, special needs, etc.)). Again, prior to step 1602, the mobile device is pre-assigned to a driver and/or to a vehicle that is scheduled to provide the NEMT service. In one embodiment, if the mobile device is not pre-assigned to the driver, the driver enters a user name and password before step 1608 sends the trip IDs and trip information. If the mobile device is pre-assigned to the driver, then step 1608 may be automatically initiated without requiring entry of a user name or password.

In one embodiment, the trip information sent in step 1608 includes all of the trips that a NEMT provider company was assigned for a predefined time period (e.g., a day), which includes trip information that is initially associated with one or more other mobile devices. If a trip is re-assigned to a driver or to a vehicle that has the mobile device whose unique ID was received in step 1606, then the driver may immediately use the mobile device to retrieve and view the trip information related to the re-assigned trip.

In step 1610, the mobile device displays the dispatch information to the driver of the vehicle that is scheduled to provide the NEMT services. The displayed dispatch information includes the client names and trip information that were sent in step 1608 and that were pre-assigned to the driver that is using the mobile device and/or to the vehicle that is transporting the mobile device. In one embodiment, the view of the dispatch information on the display of the mobile device is customized according to either (1) the driver to whom the mobile device is pre-assigned, or (2) the vehicle to which the mobile device is pre-assigned. The driver selects and starts a next trip that provides a NEMT service. Hereinafter, relative to the discussion of FIGS. 16A-16C, the next trip being started in step 1610 is referred to as “the trip.” The trip is uniquely identified by one of the trip IDs sent in step 1608. The trip is, for example, a first trip displayed in the dispatch information if step 1610 is being performed for the first time for the processing of the trip (i.e., prior to taking the Yes branch of step 1618 in FIG. 16B). The trip is, for instance, a subsequent trip in the displayed dispatch information (i.e., the next trip that has not yet been started by the driver) if step 1610 is being performed after the Yes branch of step 1618 in FIG. 16B.

The dispatch information, which may be displayed on one or more linked screens of information, includes an indication of whether each trip in a list of trips was completed or not, the names of the clients for whom NEMT services are requested, scheduled pickup times, the addresses of pickup locations, scheduled drop-off times, and the addresses of drop-off locations. The names of the clients, scheduled pickup times, addresses of pickup locations, scheduled drop-off times, and addresses of drop-off locations are each associated with the listed trips in a one-to-one correspondence. In one embodiment, the screen that is initially displayed includes the indications of completed and non-completed trips, the names of the clients and the scheduled pickup times, in the chronological order of pickup time.

In step 1612, the mobile device receives and records metadata during the performance of the trip. In one embodiment, the metadata includes the following information about an actual trip: an indication of an actual pickup of the client, a timestamp of the actual pickup, an indication of an actual drop-off of the client, a timestamp of the actual drop-off. The timestamps recorded in step 1612 includes the actual service date (i.e., the date on which the NEMT service was provided). In step 1612, the mobile device optionally receives other metadata related to the trip, such as the type of the trip (e.g., tale trip or return trip), whether a co-pay was collected for the trip, whether the client did not show up for the pickup (i.e., whether the client was a no-show), the number of attendants that assist the client during the trip, the number of escorts that accompany the client during the trip, or any combination thereof.

The mobile device presents a form on the display of the mobile device. The form is a screen (a.k.a. signature capture screen) that receives a biometric signature provided by a user of the mobile device (e.g., the client). The form is presented on the display of the mobile device, for example, by the driver activating a graphics element that indicates a signature will be collected). In step 1614, the mobile device receives a biometric signature on the signature capture screen. For example, the client hand-draws the client's signature with a stylus on a touchscreen display of the mobile device. As another example, a user who is not the client fraudulently provides the client's signature by hand-drawing the signature by means of a stylus on a touchscreen display of the mobile device. In one embodiment, the client indicates that she or he has finished the signature by activating a first graphics element on the signature capture screen. There may be a second graphics element on the signature capture screen that can be activated to indicate that the client wants to clear the screen and start the signature again.

In an alternate embodiment, the mobile device receives the signature in step 1614 via the client or other user of the mobile device hand-drawing the client's signature on another computer input device (e.g., a graphics tablet) operatively coupled to the mobile device.

Although the remaining discussion of FIGS. 16A-16C presented below describes the processing of a signature that is hand-drawn by the client or another user of the mobile device, the present invention contemplates the signature as being any other type of biometric signature (e.g., fingerprint, voice, iris patterns, etc.) provided by the client on any type of input component coupled to the mobile device.

In step 1616, the mobile device stores the following items in a data storage unit that is local to the mobile device: the metadata received in step 1612 and a digital image (e.g., bitmapped image) of the form that received the signature in step 1614. The data storage unit local to the mobile device associates the stored metadata and digital image of the signature with the trip ID that identifies the trip.

The claim verification process continues with step 1618 in FIG. 16B. If the mobile device displays in step 1618 at least one trip in the dispatch information that has not yet been started by the driver, then the Yes branch is taken and the process repeats starting at step 1610 in FIG. 16A. Otherwise, the No branch of step 1618 is taken (i.e., the displayed dispatch information shows no more non-started trips for the vehicle) and the next step is step 1620.

In step 1620, the mobile device uploads the following items to mobile device gateway 1514 (see FIG. 15) via the wireless computer network: trip IDs, metadata received in step 1612 (see FIG. 16A), and digital images of the forms that received signatures, where the digital images were stored in step 1616 (see FIG. 16A). For example, the driver indicates that his or her routes are completed for the day by activating a graphics element and the upload of trip IDs, metadata and digital images of signatures begins automatically. In one embodiment, the mobile device sends the trip IDs and metadata in step 1620 via a series of networks (e.g., via (1) the wireless computer network, (2) the Internet, and (3) a local network serving the claims verification computing unit). As a result of step 1620, claims verification computing unit 1502 (see FIG. 15) receives the trip IDs, metadata received in step 1612 (see FIG. 16A), and the digital images stored in step 1616 (see FIG. 16A).

In step 1622, claims verification computing unit stores the following items in records of database 1518 (see FIG. 15): the metadata and digital images of signatures that were uploaded in step 1620. The records in which the metadata and digital images of signatures are stored include, or are referenced by, the trip IDs uploaded in step 1620. Each trip ID is uniquely associated with a particular record in database 1518 (see FIG. 15). For each trip ID uploaded in step 1620, database 1518 (see FIG. 15) stores a first association among the trip ID, metadata that is received in step 1612 (see FIG. 16A), and the digital image of the form that received the signature in step 1614 (see FIG. 16A), where the metadata and signature are received in the iteration of the loop that begins at step 1610 (see FIG. 16A) that processes the trip identified by the trip ID. Hereinafter, each record in which metadata and a digital image of a signature is stored in step 1622 is also referred to as a completed trip record. Based on the information received in step 1602 (see FIG. 16A), database 1518 (see FIG. 15) also stores a second association between the trip ID and an identifier (a.k.a. client ID) of a client for whom an NEMT service is requested. Furthermore, database 1518 (see FIG. 15) stores a third association between the client ID and a set of one or more reference signatures of the client. Via the trip ID in the aforementioned first association and the second association, database 1518 (see FIG. 15) stores a fourth association among the client ID, the metadata that includes actual trip information, and the digital image that includes the signature.

In one embodiment, the digital image of the signature is initially a white signature on a black background. In this case, step 1622 includes an initial sub-step of reversing the colors of the digital image so that the signature is black and the background is white before the digital image of the signature is stored in database 1518 (see FIG. 15). The reversal of the colors in the image allows the image to be stored in the same way that an image is stored from a fax in the process of FIGS. 4A-4C.

In step 1624, the claims verification process initiates a check by SVE 1512 (see FIG. 15) for an authorized trip and a valid signature for the next completed trip record stored in the central database in step 1622. The next completed trip record is a first completed trip record of the completed trip records in step 1622 if step 1624 is being performed for the first time (i.e., prior to taking the Yes branch of step 1644 in FIG. 16C). The next completed trip record is a subsequent completed trip record of the completed trip records in step 1622 if step 1624 is being performed after the Yes branch of step 1644 in FIG. 16C.

If SVE 1512 (see FIG. 15) determines in inquiry step 1626 that metadata values in the next completed trip record and the associated trip ID match the analogous metadata values and trip ID in a transaction record for a routed trip that was previously stored in database 1518 (see FIG. 15) in step 1602 (see FIG. 16A), then the Yes branch of step 1626 is taken and the process continues with step 1638 in FIG. 16C; otherwise, the No branch of step 1626 is taken and the process continues with step 1628.

In step 1628, SVE 1512 (see FIG. 15) identifies a fraudulent or potentially fraudulent claim that includes billing for a NEMT service that has an authorization issue. Examples of authorization issues include: (1) the NEMT service is provided to a client via a trip but the trip was not authorized by a payer, (2) the NEMT service was authorized for a date that is different from the service date in the completed trip record, and (3) the NEMT was authorized for a drop-off location (e.g., the location at which the client has an health care-related appointment) that is different from the drop-off location in the completed trip record.

In step 1630, payment to the NEMT provider for the requested NEMT service is denied (i.e., is not authorized). In one embodiment, the payer denies the payment in step 1630. In another embodiment, the claims verification computing unit 1502 (see FIG. 15) automatically denies the payment in step 1630 based on a prior agreement between the payer and the claims verification service provider (CVSP) that allows the CVSP to authorize or deny such payments. In still another embodiment, a user manually reviews the transaction and decides whether to approve or deny payment. The user may contact the client (e.g., by telephone) as needed to determine whether to approve or deny payment. In one embodiment, step 1630 includes preventing the complete authorization number (e.g., the complete Medicaid prior authorization number) from being received or viewed by the NEMT provider and/or a NEMT broker.

If SVE 1512 (see FIG. 15) identifies in step 1632 another completed trip record in database 1518 (see FIG. 15) that has not yet been checked in step 1626, then the Yes branch is taken, the identified completed trip record becomes the next completed trip record, and the claims verification process repeats starting at step 1624. Otherwise, if SVE 1512 (see FIG. 15) determines in step 1632 that there is no other completed trip record in database 1518 (see FIG. 15) that has not been checked in step 1626, then the No branch is taken and the next step is step 1634.

In step 1634, a report generator module executing in computing unit 1502 (see FIG. 15) generates report 1516 (see FIG. 15). Step 1634 may also include distributing report 1516 (see FIG. 15) by a report distributor module executing in web server 1504 (see FIG. 15). In one embodiment, report 1516 (see FIG. 15) is an exception report that includes the one or more fraudulent or potentially fraudulent health care claims identified in step 1628. In another embodiment, report 1516 (see FIG. 15) includes one or more verifications, where each verification is an indication that a payment for an NEMT service provided by one of the trips started in step 1610 (see FIG. 16A) is authorized by step 1650 (see FIG. 16C). In still another embodiment, the report 1516 (see FIG. 15) may include both (1) the aforementioned one or more fraudulent or potentially fraudulent health care claims and (2) the aforementioned one or more verifications.

In one embodiment, exception report 1516 (see FIG. 15) is generated dynamically in real-time in response to a user's action in step 1634 (e.g., the user clicks on a graphical user interface element to display the exception report). The user is, for example, a user of claims verification computing unit 1502 (see FIG. 15) or payer computing unit 1508 (see FIG. 15). In another embodiment, the report generator uploads the exception report to the CVSP website provided by web server 1504 (see FIG. 15) for distribution to one or more users of the CVSP website (e.g., a NEMT provider or payer). The mobile device-enhanced claims verification process for non-emergency medical transportation ends at step 1636.

Returning to the Yes branch of step 1626, SVE 1512 (see FIG. 15) determines in step 1638 of FIG. 16C that the signature in the next completed trip record is valid or not valid based on whether a score meets predetermined criteria. The SVE 1512 (see FIG. 15) determines the score by comparing the signature in the next completed trip record to each reference signature of one or more reference signatures retrieved from database 1518 (see FIG. 15). Hereinafter, in the discussion of FIG. 16C, the signature in the next completed trip record is also referred to simply as “the signature.” Prior to the comparison of the signature, SVE 1512 (see FIG. 15) retrieves the one or more reference signatures from database 1518 (see FIG. 15) based on the aforementioned associations in database 1518 (see FIG. 15) (see the discussion above relative to step 1622) (e.g., the trip ID for the trip is associated with a client ID by the second association, and the client ID is associated with the one or more reference signatures by the third association). Furthermore, the signature is retrieved from the database 1518 (see FIG. 15) based on the aforementioned associations in database 1518 (see FIG. 15). In one embodiment, the retrieval of the signature and the reference signature(s), and the subsequent verification of a claim (see the Yes branch of step 1638) or the detection of a fraudulent claim (see the No branch of step 1638) are based on the client ID's association with the metadata and the signature (see the aforementioned fourth association) and the client ID's association with the reference signature(s) (see the aforementioned third association), where the client ID is determined based on the database 1518 (see FIG. 15) associating the client ID with the trip ID that identifies the trip (see the aforementioned second association).

Each comparison of the signature to one of the retrieved reference signatures determines a preliminary score. If only one preliminary score is determined because there is only one retrieved reference signature, then the one preliminary score is the final score that is used to determine the validity or invalidity of the signature in step 1638. If multiple preliminary scores are determined because there are multiple retrieved reference signatures, the final score is selected from the multiple preliminary scores based on predefined criteria (e.g., the score having the greatest value is selected to be the final score). Hereinafter, in the discussion of FIG. 16C, the final score is referred to simply as “the score.”

Database 1518 (see FIG. 15) associates the retrieved reference signature(s) with a client ID, and associates the client ID with the trip ID that references the next completed trip record. In one embodiment, the signature in the next completed trip record is valid if the score is greater than a predefined threshold value and is invalid if the score is less than or equal to the predefined threshold value. If the score is greater than the predefined threshold value, the signature matches a retrieved reference signature of the one or more retrieved reference signatures. If the score is less than or equal to the predefined threshold value, the signature does not match any reference signature of the one or more retrieved reference signatures (i.e., there is a mismatch between the signature and each reference signature of the one or more retrieved reference signatures). In response to determining that the signature is not valid (i.e., in response to determining there is a mismatch between the signature and each of the one or more retrieved reference signatures) at step 1638, then in step 1640 SVE 1512 (see FIG. 15) identifies a fraudulent or potentially fraudulent health care claim that includes a billing that is submitted for a NEMT service that is not provided.

In optional step 1641, the CVSP contacts the client (e.g., by telephone) to determine whether the client confirms or denies that the signature received in step 1614 (see FIG. 16A) was provided by the client. If the client denies in step 1641 that the signature received in step 1614 (see FIG. 16A) was provided by the client, then claims verification computing unit 1502 (see FIG. 15) receives an indication (a.k.a. signature fraud indication) that the signature was provided fraudulently, the claims verification computing unit stores the signature fraud indication in the claims verification database 1518 (see FIG. 15), and the No branch of step 1641 is taken and step 1642 is performed. Otherwise, if the client confirms in step 1641 that the signature received in step 1614 (see FIG. 16A) was provided by the client (and not by someone who fraudulently provided the signature), then the claims verification computing unit 1502 (see FIG. 15) receives an indication (a.k.a. valid signature indication) that the signature is valid, the claims verification computing unit stores the valid signature indication in the database 1518 (see FIG. 15), and the Yes branch of step 1641 is taken and step 1650 is performed. In an alternate embodiment that omits step 1641, step 1642 follows directly after step 1640.

In step 1642, payment to the NEMT provider for the requested NEMT service is denied (i.e., is not authorized). In one embodiment, the payer denies the payment in step 1642. In another embodiment, the claims verification computing unit 1502 (see FIG. 15) automatically denies the payment in step 1642 based on a prior agreement between the payer and the CVSP that allows the CVSP to authorize or deny such payments. In still another embodiment, a user manually reviews the transaction and decides whether to approve or deny payment. The user may contact the client (e.g., by telephone) as needed to determine whether to approve or deny payment. In one embodiment, step 1642 includes preventing the complete authorization number (e.g., the complete Medicaid prior authorization number) from being received or viewed by the NEMT provider and/or NEMT broker.

If SVE 1512 (see FIG. 15) identifies in step 1644 another completed trip record in database 1518 (see FIG. 15) that has not yet been checked in step 1626 (see FIG. 16B), then the Yes branch is taken, the identified completed trip record becomes the next completed trip record, and the claims verification process repeats starting at step 1624 (see FIG. 16B). Otherwise, if SVE 1512 (see FIG. 15) determines in step 1644 that there is no other completed trip record in database 1518 (see FIG. 15) that has not been checked in step 1626 (see FIG. 16B), then the No branch is taken and the next step is step 1646.

In step 1646, a report generator module executing in computing unit 1502 (see FIG. 15) generates report 1516 (see FIG. 15). Step 1646 may also include distributing the report 1516 (see FIG. 15) by a report distributor module executing in web server 1504 (see FIG. 15). In one embodiment, report 1516 (see FIG. 15) is an exception report that identifies the one or more fraudulent or potentially fraudulent health care claims identified in step 1640. The exception report 1516 (see FIG. 15) may also include one or more fraudulent or potentially fraudulent health care claims identified in step 1628 (see FIG. 16B). In another embodiment, report 1516 (see FIG. 15) includes one or more verifications, where each verification is an indication that a payment for an NEMT service provided by one of the trips started in step 1610 (see FIG. 16A) is authorized by step 1650. In still another embodiment, the report 1516 (see FIG. 15) may include both (1) the aforementioned one or more fraudulent or potentially fraudulent health care claims and (2) the aforementioned one or more verifications. The mobile device-enhanced claims verification process for non-emergency medical transportation ends at step 1648. In one embodiment, exception report 1516 (see FIG. 15) is generated dynamically in real-time in response to a user's action in step 1646 (e.g., the user clicks on a graphical user interface element to display the exception report). The user is, for example, a user of claims verification computing unit 1502 (see FIG. 15) or payer computing unit 1508 (see FIG. 15). In another embodiment, the report generator uploads the exception report to the CVSP website provided by web server 1504 (see FIG. 15) for distribution to one or more users of the CVSP website (e.g., a NEMT provider or a payer).

Returning to step 1638, if SVE 1512 (see FIG. 15) determines that the signature in the next competed trip record is valid (i.e., the SVE identifies a match between the signature in the next completed trip record and one of the retrieved reference signatures), then in step 1650 SVE 1512 (see FIG. 15) verifies that the NEMT provider provided the requested NEMT service to the client, and the NEMT service was provided to the authorized drop-off location on the authorized date. That is, step 1650 verifies an occurrence of a transportation of the client from a pickup location to a drop-off location on a service date, where the pickup location, drop-off location and service date are included in the dispatch information that is displayed in step 1610 (see FIG. 16A) and that is associated with the trip ID that identifies the trip. Furthermore, step 1650 includes the payer authorizing payment to the NEMT provider for the NEMT, which includes storing an indication in a data storage device (e.g., in database 1518 in FIG. 15), where the indication indicates an authorization for a payment for the NEMT service provided by the trip. Step 1650 is also performed after the Yes branch of step 1641 is taken (i.e., if the client confirms the signature in step 1641), as discussed above.

In another embodiment, per a prior agreement between the payer and the CVSP, the payer permits the CVSP to authorize payments to NEMT provider, and step 1650 includes the CVSP authorizing payment to the NEMT provider for providing the NEMT service by sending a complete authorization number from one computing unit (e.g., computing unit 1502 in FIG. 15) to another computing unit (e.g., a computing unit used by the NEMT provider), where the complete authorization number is stored in a computer data storage device and/or displayed on a display device operatively coupled to the other computing unit.

Following step 1650, the mobile device-enhanced claims verification process repeats starting at step 1644. Following step 1650, claims verification computing unit 1502 (see FIG. 15) generates a report in step 1634 (see FIG. 16B) or in step 1646. In one embodiment, the report generated after identifying the match in step 1638 verifies that a payment for the NEMT service provided by the trip is authorized.

In one embodiment, the claims verification computing unit 102 (see FIG. 1) receives a payment authorization number prior to step 1650. The authorization number permits the NEMT provider to receive payment for providing a NEMT service to a client (e.g., a Medicaid prior authorization number). The CVSP does not show or shows only part of the authorization number to the NEMT provider (e.g., via the CVSP website provided by web server 1504 of FIG. 15) until payment for the NEMT service is authorized by step 1650. The authorization number is received in response to a prior authorization/approval request generated by, for example, a MMIS integration unit included in web server 1504 (see FIG. 15). In one embodiment, in response to authorizing the payment for the NEMT service in step 1650 and receiving the authorization number via the prior authorization/approval request, the computing unit 1502 (see FIG. 15) or the web server 1504 (see FIG. 15) sends the complete authorization number to another computing unit (e.g., a computing unit used by the NEMT provider). The complete authorization number is then stored on a computer data storage device and/or displayed on a display device coupled to the other computing unit.

In one embodiment, the process of FIGS. 16A-16C verifies a claim (or detects a fraudulent claim) for a payment for a NEMT service provided by one trip whose information is received in step 1602 (see FIG. 16A) while the process of FIGS. 4A-4C or FIGS. 11A-11C verifies another claim (or detects a fraudulent claim) for a payment for a NEMT service provided by another trip whose information is received in step 1602 (see FIG. 16A). For example, the mobile device-enhanced process of FIGS. 16A-16C verifies a claim associated with a first trip provided by NEMT Provider 1, where the drivers of vehicles used by NEMT Provider 1 use mobile devices 1506-1, . . . , 1506-N (see FIG. 15), while the process of FIGS. 4A-4C verifies a claim associated with a second trip provided by NEMT Provider 2 via a paper-based form that is faxed to computing unit 1502 (see FIG. 15) (i.e., the drivers of vehicles used by NEMT Provider 2 do not use mobile devices for communicating with computing unit 1502 (see FIG. 15)).

In one embodiment, all communications between the mobile device and mobile device gateway 1514 (see FIG. 15) use 128-bit encryption and the data in the local storage of the mobile device is encrypted.

In one embodiment, if a mobile device is reported as missing or has not been used over a time period that exceeds a predefined amount of time, and the mobile device later communicates with the mobile device gateway, then the mobile device gateway immediately sends a message to the mobile device to erase all data stored on the mobile device and to disable the mobile device.

In one embodiment, a predefined number (e.g., 3) of unsuccessful logon attempts to the mobile device results in all the data stored on the mobile device being deleted.

Although the process of FIGS. 16A-16C is described relative to the provision of a NEMT service, the present invention contemplates a variation of the process of FIGS. 16A-16C that verifies a claim for a payment for any type of medical transportation service.

### Claims Verification Computing Unit

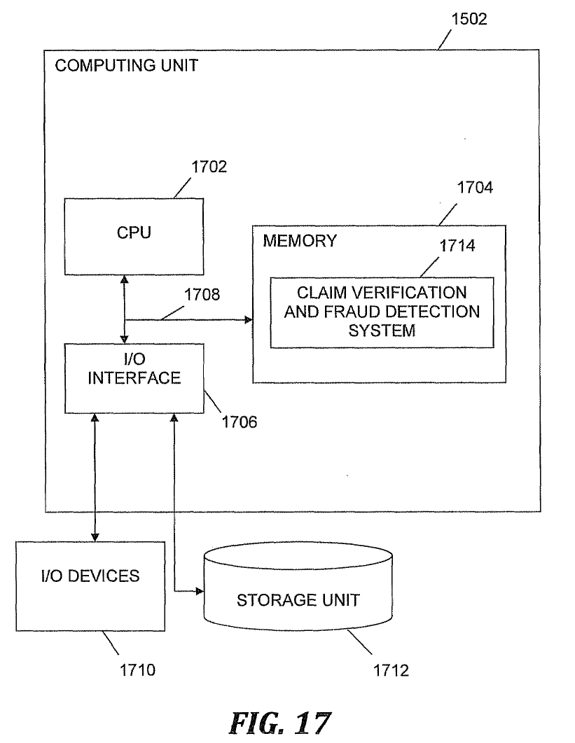

FIG. 17 is a block diagram of a computing system that implements the process of FIGS. 16A-16C or a portion thereof, in accordance with embodiments of the present invention. Computer unit 1502 generally comprises a central processing unit (CPU) 1702, a memory 1704, an input/output (I/O) interface 1706, and a bus 1708. Further, computer unit 1502 is coupled to I/O devices 1710 and a computer data storage unit 1712. CPU 1702 performs computation and control functions of computer unit 1502. CPU 1702 may comprise a single processing unit, or be distributed across one or more processing units in one or more locations (e.g., on a client and server).

Memory 1704 may comprise any known type of computer data storage and/or transmission media, including bulk storage, magnetic media, optical media, random access memory (RAM), read-only memory (ROM), a data cache, a data object, etc. In one embodiment, cache memory elements of memory 1704 provide temporary storage of at least some program code (e.g., code for system 1714) in order to reduce the number of times code must be retrieved from bulk storage during execution. Moreover, similar to CPU 1702, memory 1704 may reside at a single physical location, comprising one or more types of data storage, or be distributed across a plurality of physical systems in various forms. Further, memory 1704 can include data distributed across, for example, a local area network (LAN) or a wide area network (WAN).

I/O interface 1706 comprises any system for exchanging information to or from an external source. I/O devices 1710 comprise any known type of external device, including a display device (e.g., monitor), keyboard, mouse, printer, speakers, handheld device, facsimile, etc. Bus 1708 provides a communication link between each of the components in computer unit 1502, and may comprise any type of transmission link, including electrical, optical, wireless, etc.

I/O interface 1706 also allows computer unit 1502 to store and retrieve information (e.g., data or program instructions such as code for system 1714) from an auxiliary storage device such as computer data storage unit 1712 or another computer data storage unit (not shown). Computer data storage unit 1712 may be a non-volatile storage device, such as a magnetic disk drive (i.e., hard disk drive) or an optical disc drive (e.g., a CD-ROM drive which receives a CD-ROM disk). In one embodiment, computer data storage unit 1712 stores database 1518 (see FIG. 15).

Memory 1704 includes computer program code for system 1714 for claim verification and fraud detection (i.e., program instructions that are executed by CPU 1702 and that implement one or more steps in the process of FIGS. 16A-16C). Program 1714 may include modules, such as signature verification engine 1512 (see FIG. 15) and mobile device gateway 1514 (see FIG. 15), as well as other modules included in computing unit 102 (see FIG. 1). Further, memory 1704 may include other systems not shown in FIG. 17, such as an operating system (e.g., Linux) that runs on CPU 1702 and provides control of various components within and/or connected to computer unit 1502.

Memory 1704, storage unit 1712, and/or one or more other computer data storage units (not shown) that are operatively coupled to computer unit 1502 may store the information received in step 1602 (see FIG. 16A), the unique ID received in step 1606 (see FIG. 16A), the trip IDs, metadata, and digital images uploaded in step 1620 (see FIG. 16B), indications of whether trips are authorized in step 1626 (see FIG. 16B), and indications (a.k.a. signature validity indications) of whether signatures are determined valid or invalid in step 1638 (see FIG. 16C). The process of FIGS. 16A-16C may result in a transformation that: (1) transforms a computer data storage unit (e.g., storage unit 1712) from a store that does not include the aforementioned metadata, digital images, and signature validity indications associated with trip IDs stored thereon to a store that does include such metadata, digital images, and/or signature validity indications.

As will be appreciated by one skilled in the art, the present invention may be embodied as a system, method or computer program product. Accordingly, an embodiment of the present invention may be an entirely hardware embodiment, an entirely software embodiment (including firmware, resident software, micro-code, etc.) or an embodiment combining software and hardware aspects that may all generally be referred to herein as a “system” (e.g., system 1500 in FIG. 15 or a system that is computing unit 1502). Furthermore, an embodiment of the present invention may take the form of a computer program product embodied in any tangible medium of expression (e.g., memory 1704 or computer data storage unit 1712) having computer-usable program code (e.g., code for system 1714) embodied or stored in the medium.

Any combination of one or more computer-usable or computer-readable medium(s) (e.g., memory 1704 and/or computer data storage unit 1712) may be utilized. The computer-usable or computer-readable medium may be, for example but not limited to, an electronic, magnetic, optical, electromagnetic, infrared or semiconductor system, apparatus, device or propagation medium. A non-exhaustive list of more specific examples of the computer-readable medium includes: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program for system 1714 is printed, as the program for system 1714 can be electronically captured via, for instance, optical scanning of the paper or other medium, then compiled, interpreted, or otherwise processed in a suitable manner, if necessary, and then stored, respectively, in a computer memory 1704. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code (e.g., code for system 1714) embodied therewith, either in baseband or as part of a carrier wave. The computer-usable program code may be transmitted using any appropriate medium, including but not limited to wireless, wireline, optical fiber cable, RF, etc.

Computer program code (e.g., code of system 1714) for carrying out operations of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. Any one of the aforementioned computers or servers may be computer unit 1502. In the latter scenario, the remote computer may be connected to the user's computer through any type of network (not shown), including a LAN, a WAN, or the connection may be made to an external computer (e.g., through the Internet using an Internet Service Provider).

The present invention is described herein with reference to flowchart illustrations (e.g., FIGS. 16A-16C) and/or block diagrams of methods, apparatus (systems) (e.g., FIG. 15 and FIG. 17), and computer program products according to embodiments of the invention. It will be understood that each block of the flowchart illustrations and/or block diagrams, and combinations of blocks in the flowchart illustrations and/or block diagrams, can be implemented by computer program instructions (e.g., code of system 1714). These computer program instructions may be provided to a processor (e.g., CPU 1702) of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium (e.g., memory 1704 or computer data storage unit 1712) that can direct a computer (e.g., computer unit 1502) or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer (e.g., computer unit 1502) or other programmable data processing apparatus to cause a series of operational steps to be performed on the computer or other programmable apparatus to produce a computer-implemented process such that the instructions which execute on the computer or other programmable apparatus provide processes for implementing the functions/acts specified in the flowchart and/or block diagram block or blocks.

Any of the components of an embodiment of the present invention can be deployed, managed, serviced, etc. by a service provider that offers to deploy or integrate computing infrastructure with respect to the mobile device-enhanced process for verifying claims for NEMT. Thus, an embodiment of the present invention discloses a process for supporting computer infrastructure, comprising integrating, hosting, maintaining and deploying computer-readable code (e.g., code of program 1714) into a computer system (e.g., computer unit 1502), wherein the code in combination with the computer system is capable of performing the mobile device-enhanced process for verifying claims for NEMT.

In another embodiment, the invention provides a business method that performs the process steps of the invention on a subscription, advertising and/or fee basis. That is, a service provider, such as a Solution Integrator, can offer to create, maintain, support, etc. mobile device-enhanced processes for verifying claims for NEMT. In this case, the service provider can create, maintain, support, etc. a computer infrastructure that performs the process steps of the invention for one or more customers. In return, the service provider can receive payment from the customer(s) under a subscription and/or fee agreement, and/or the service provider can receive payment from the sale of advertising content to one or more third parties.

The flowchart in FIGS. 16A-16C and the block diagrams in FIGS. 15 and 17 illustrate the architecture, functionality, and operation of possible implementations of systems, methods, and computer program products according to various embodiments of the present invention. In this regard, each block in the flowchart or block diagrams may represent a module, segment, or portion of code (e.g., code of system 1714), which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While embodiments of the present invention have been described herein for purposes of illustration, many modifications and changes will become apparent to those skilled in the art. For example, the transaction data embedded in the bar code generated in step 304 (see FIG. 3A) or step 10304 (see FIG. 10A) may be related to the provision of home health care services. The steps of detecting fraud related to home health care services are analogous to the steps in the process of FIGS. 5A-5C, FIGS. 6A-6C, FIGS. 12A-12C or FIGS. 13A-13C.

What is claimed is:

1. A method of verifying a medical transportation service (MTS), said method comprising:
receiving trip information and a plurality of names (client names) of a plurality of clients, wherein said trip information specifies a plurality of routed trips that are requested to provide a plurality of medical transportation services (MTSs) to said plurality of clients;
sending, by a computing unit, a plurality of identifiers (trip IDs) of said plurality of routed trips, said plurality of client names, and said trip information to a mobile device via a wireless computer network, wherein said computing unit includes a processor and a memory;
responsive to said sending, displaying said plurality of client names and said trip information on a display of said mobile device;
receiving metadata collected during a routed trip of said plurality of routed trips, wherein said routed trip is requested to provide a MTS of said plurality of MTSs to a client of said plurality of clients, wherein said MTS specifies a transportation of said client from a first location to a second location on a date, wherein said routed trip is identified by a trip ID of said plurality of trip IDs, and wherein said metadata specifies a pickup at said first location, a drop-off at said second location, and said date;
receiving a signature via an input component operatively coupled to said mobile device;
receiving said metadata, said signature, and said trip ID from said mobile device;
storing a first association among said trip ID, said metadata, and said signature in a data storage device, wherein said data storage device stores a second association between said trip ID and an identifier (client ID) of said client, and wherein said data storage device stores a third association between said client ID and a set of one or more reference signatures;
identifying a match between said signature and a reference signature of said set of one or more reference signatures, wherein said identifying said match includes retrieving said reference signature based on said second association and said third association;
responsive to identifying said match, verifying an occurrence of said transportation of said client from said first location to said second location on said date; and
subsequent to said identifying said match, generating a report that verifies that a payment for said MTS is authorized.

2. The method of claim 1, wherein said receiving said trip information includes receiving said first location, said second location, said date, and a name of said client.

3. The method of claim 2, wherein said receiving said trip information further includes receiving an identifier of a vehicle to which said routed trip is assigned.

4. The method of claim 2, wherein said receiving said trip information further includes receiving an identifier of a driver to whom said routed trip is assigned.

5. The method of claim 1, further comprising:
said mobile device connecting to said computing unit via said wireless computer network; and
receiving a unique identifier of said mobile device via said wireless computer network, wherein said sending said plurality of trip IDs, said plurality of client names, and said trip information is based on said unique identifier of said mobile device.

6. The method of claim 1, wherein said receiving said signature via said input component includes receiving said signature via said display of said mobile device.

7. The method of claim 1, further comprising storing said signature and said metadata in a data storage device operatively coupled to said mobile device.

8. The method of claim 7, wherein said storing said signature includes storing a digital image of said signature.

9. The method of claim 1, wherein said MTS is a service providing a non-emergency medical transportation of said client from said first location to said second location on said date.

10. The method of claim 1, wherein said mobile device is a digital electronic device that is handheld, portable, or mounted in a vehicle that provides said MTS

11. The method of claim 1, further comprising:
generating a bar code that includes a set of bar code data that includes provider identification information that identifies a provider that provides a second MTS of said plurality of MTSs, wherein said second MTS specifies a transportation of a second client of said plurality of clients in a second routed trip of said plurality of routed trips from a pickup location to a drop-off location on a second date;
sending an initial version of a form to said provider;
receiving a digital image file that includes a completed version of said form that includes said bar code, a set of transaction data that describes a completion of said second routed trip, and a second signature previously provided on said form;
extracting said set of bar code data, said set of transaction data and said second signature from said digital image file, wherein said extracting said set of bar code data includes extracting said provider identification information from said set of bar code data included in said bar code;
receiving client identification information that identifies said second client;
receiving trip identification information that identifies said second routed trip;
determining that said extracted second signature matches a second reference signature that is stored in said data storage device that associates said second reference signature with said second client, wherein said determining that said extracted second signature matches said second reference signature includes retrieving said second reference signature from said data storage device based on said received client identification information; and
determining that said trip identification information identifies a trip that is previously authorized by a payer entity.

12. The method of claim 1, further comprising:
generating a bar code that includes a set of bar code data that includes provider identification information that identifies a provider that provides a second MTS of said plurality of MTSs, wherein said second MTS specifies a transportation of a second client of said plurality of clients in a second routed trip of said plurality of routed trips from a pickup location to a drop-off location on a second date;
sending an initial version of a form to said provider;
receiving a digital image file that includes a completed version of said form that includes said bar code, a set of transaction data that describes said second routed trip, and a second signature previously provided on said form;
extracting said set of bar code data, said set of transaction data and said second signature from said digital image file, wherein said extracting said set of bar code data includes extracting said provider identification information from said set of bar code data included in said bar code;
receiving client identification information that identifies said second client;
receiving trip identification information that identifies said second routed trip;
determining that said extracted second signature does not match any reference signature of a set of one or more reference signatures, wherein said data storage device associates said set of one or more reference signatures with said client identification information, wherein said determining that said extracted second signature does not match any reference signature includes retrieving each reference signature of said set of one or more reference signatures based on said received client identification information; and
responsive to said determining that said extracted second signature does not match any reference signature, generating a report that identifies a health care claim that is fraudulent based on a billing being submitted for said second MTS and based on said second MTS not being provided to said second client on said second date.

13. A computing system comprising a processor coupled to a computer-readable memory unit, said memory unit comprising a software application, said software application comprising instructions that when executed by said processor implement the method of claim 1.

14. A computer program product, comprising a computer-readable storage medium having a computer-readable program code stored therein, said computer-readable program code containing instructions configured to be executed by a processor of a computer system to implement the method of claim 1.

15. A method of detecting a fraudulent health care claim for a payment for a medical transportation service (MTS), said method comprising:
receiving trip information and a plurality of names (client names) of a plurality of clients, wherein said trip information specifies a plurality of routed trips that are requested to provide a plurality of medical transportation services (MTSs) to said plurality of clients;
sending, by a computing unit, a plurality of identifiers (trip IDs) of said plurality of routed trips, said plurality of client names, and said trip information to a mobile device via a wireless computer network, wherein said computing unit includes a processor and a memory;
responsive to said sending, displaying said plurality of client names and said trip information on a display of said mobile device;
receiving metadata collected during a routed trip of said plurality of routed trips, wherein said routed trip is requested to provide a MTS of said plurality of MTSs to a client of said plurality of clients, wherein said MTS specifies a transportation of said client from a first location to a second location on a date, wherein said routed trip is identified by a trip ID of said plurality of trip IDs, and wherein said metadata specifies a pickup at said first location, a drop-off at said second location, and said date;
receiving a signature via an input component operatively coupled to said mobile device;
receiving said metadata, said signature, and said trip ID from said mobile device;
storing a first association among said trip ID, said metadata, and said signature in a data storage device, wherein said data storage device stores a second association between said trip ID and an identifier (client ID) of said client, and wherein said data storage device stores a third association between said client ID and a set of one or more reference signatures;
determining a mismatch between said signature and each reference signature of said set of one or more reference signatures, wherein said determining said mismatch includes retrieving each reference signature of said set of one or more reference signatures based on said second association and said third association; and
subsequent to said determining said mismatch, generating a report that identifies a health care claim that is fraudulent based on a billing being submitted for said MTS and based on said MTS not being provided to said client on said date.

16. The method of claim 15, further comprising:
generating a bar code that includes a set of bar code data that includes provider identification information that identifies a provider that provides a second MTS of said plurality of MTSs, wherein said second MTS specifies a transportation of a second client of said plurality of clients in a second routed trip of said plurality of routed trips from a pickup location to a drop-off location on a second date;
sending an initial version of a form to said provider;
receiving a digital image file that includes a completed version of said form that includes said bar code, a set of transaction data that describes a completion of said second routed trip, and a second signature previously provided on said form;
extracting said set of bar code data, said set of transaction data and said second signature from said digital image file, wherein said extracting said set of bar code data includes extracting said provider identification information from said set of bar code data included in said bar code;
receiving client identification information that identifies said second client;
receiving trip identification information that identifies said second routed trip;
determining that said extracted second signature matches a second reference signature that is stored in said data storage device that associates said second reference signature with said second client, wherein said determining that said extracted second signature matches said second reference signature includes retrieving said second reference signature from said data storage device based on said received client identification information; and
determining that said trip identification information identifies a trip that is previously authorized by a payer entity.

17. The method of claim 15, further comprising:
generating a bar code that includes a set of bar code data that includes provider identification information that identifies a provider that provides a second MTS of said plurality of MTSs, wherein said second MTS specifies a transportation of a second client of said plurality of clients in a second routed trip of said plurality of routed trips from a pickup location to a drop-off location on a second date;
sending an initial version of a form to said provider;
receiving a digital image file that includes a completed version of said form that includes said bar code, a set of transaction data that describes said second routed trip, and a second signature previously provided on said form;
extracting said set of bar code data, said set of transaction data and said second signature from said digital image file, wherein said extracting said set of bar code data includes extracting said provider identification information from said set of bar code data included in said bar code;
receiving client identification information that identifies said second client;
receiving trip identification information that identifies said second routed trip;
determining that said extracted second signature does not match any reference signature of a set of one or more reference signatures, wherein said data storage device associates said set of one or more reference signatures with said client identification information, wherein said determining that said extracted second signature does not match any reference signature includes retrieving each reference signature of said set of one or more reference signatures based on said received client identification information; and
responsive to said determining that said extracted second signature does not match any reference signature, generating a report that identifies a health care claim that is fraudulent based on a billing being submitted for said second MTS and based on said second MTS not being provided to said second client on said second date.

18. A computing system comprising a processor coupled to a computer-readable memory unit, said memory unit comprising a software application, said software application comprising instructions that when executed by said processor implement the method of claim 15.

19. A computer program product, comprising a computer-readable storage medium having a computer-readable program code stored therein, said computer-readable program code containing instructions configured to be executed by a processor of a computer system to implement the method of claim 15.

20. A method of verifying a medical transportation service (MTS), said method comprising:
receiving, by a computing system, a request for said MTS that includes transporting a client in a trip from a first location to a second location on a date, wherein said computing system includes a processor and a memory;
receiving a form by said computing system and from a mobile device, wherein said receiving said form includes receiving a biometric signature previously provided on said form via an input component operatively coupled to said mobile device;
receiving, by said computing system, trip information that specifies said trip;
receiving, by said computing system, client identification information that identifies said client;
storing an association among said client identification information, said trip information, and said biometric signature in a computer data storage device;
identifying, by said computing system, a match between said biometric signature and a reference signature included in a database, wherein said identifying said match includes retrieving said reference signature from said database based on said client identification information; and
verifying, by said computing system and responsive to said identifying said match, that said MTS is provided and that said MTS includes transporting said client from said first location to said second location on said date, wherein said verifying is based on said association among said client identification information, said trip information, and said biometric signature.

21. A computing system comprising a processor coupled to a computer-readable memory unit, said memory unit comprising a software application, said software application comprising instructions that when executed by said processor implement the method of claim 20.

22. A computer program product, comprising a computer-readable storage medium having a computer-readable program code stored therein, said computer-readable program code containing instructions configured to be executed by a processor of a computer system to implement the method of claim 20.
